(19) United States
(12) Patent Application Publication
(10) Pub. No.: US 2007/0145041 A1
(43) Pub. Date: Jun. 28, 2007

(54) Electromagnetically-shielded air heating systems and methods

(76) Inventor: Youngtack Shim, Port Moody (CA)

Correspondence Address: Youngtack Shim, 155 Aspenwood Drive, Port Moody, BC, V3H 5A5, CA

(21) Appl. No.: 11/313,921

(22) Filed: Dec. 22, 2005

(51) Int. Cl. H05B 6/10

(52) U.S. Cl. 219/635

(57) ABSTRACT

The present invention generally relates to electromagnetically-shielded air heating systems and methods. More particularly, the present invention relates to various air heating systems and methods capable of generating heated air and then supplying such heated air directly to a target space, while disposing various sources of such waves away from the target space, thereby minimizing intensities of such waves when measured in the target space. The present invention also relates to various air heating systems and methods for supplying moisture and/or oxygen to the target space along with the heated air, thereby maintaining a humidity and/or oxygen concentration in the target space at or near a preset level, while passively or actively displacing metabolic wastes and/or stale air inside the target space. The present invention further relates to various processes for providing the above air heating systems and various modules and/or members thereof.

### CROSS-REFERENCES TO RELATED APPLICATIONS

The present application is related to various patent applications which have been filed by the same Applicant. The first is the U.S. Utility Patent Application entitled “Shunted Magnet Systems and Methods,” filed on Aug. 30, 2005, and bearing a Ser. No. 11/213,703. The second is the U.S. Utility Patent Application entitled “Magnet-Shunted Systems and Methods,” filed on Aug. 30, 2005, and bearing a Ser. No. 11/213,686. The third is the U.S. Provisional Patent Application entitled “Electromagnetic Shield Systems and Methods,” filed on Oct. 3, 2005, and bearing a Serial Number U.S. Ser. No. 60/723,274, and the Disclosure Document entitled the same, deposited in the U.S. Patent and Trademark Office (the “Office”) on Oct. 3, 2005 under the Disclosure Document Deposit Program (the “DDDP”) of the Office, and bearing a Ser. No. 587,338. The fourth is the U.S. Utility Patent Application entitled “Electromagnetically-Shielded Heat Generating Systems and Methods,” which was filed on Nov. 30, 2005 and bears a Ser. No. 11/289,693. The last of such applications is the U.S. Utility Patent Application which is entitled “Electromagnetically-Shielded Hair Drying Systems and Methods,” filed on Nov. 30, 2005 and bearing a Serial Number U.S. Ser. No. 11/289,578. All of such Applications and Documents are to be referred to as the “co-pending Applications” hereinafter, all of which are to be incorporated herein in their entirety by reference.

### FIELD OF THE INVENTION

The present invention generally relates to electromagnetically-shielded air heating systems and methods. More particularly, the present invention relates to various air heating systems and methods capable of generating heated air and then supplying such heated air directly to a target space, while disposing various sources of such waves away from the target space, thereby minimizing intensities of such waves when measured in the target space. The present invention also relates to various air heating systems and methods for supplying moisture and/or oxygen to the target space along with the heated air, thereby maintaining a humidity and/or oxygen concentration in the target space at or near a preset level, while passively or actively displacing metabolic wastes and/or stale air inside the target space. The present invention further relates to various processes for providing the above air heating systems and various modules and/or members thereof. When desirable, the air heating systems may include various electric and/or magnetic shields so as to further suppress the electromagnetic waves from propagating toward the target space. Various air heating systems of the present invention may be applied to electric blankets (or overblankets), electric mats (or underblankets), electric heating pads or other electric heating devices which are designed to provide heat through thermal conduction from their heating elements to the target space.

### BACKGROUND OF THE INVENTION

Electric blankets have been in use for several decades for providing warmth to sleepers. With the advent of various composite materials exhibiting positive and/or negative temperature coefficients, sophisticated control features have been incorporated into the blankets for the purpose of preventing their heating elements from being overheated and/or catching fire. Various control mechanisms have also been implemented to the electric blankets such that electric current may be cut off to overheated regions or that such regions may be supplied with less current.

In one group of examples, electric blankets employ various control algorithms which are based upon their heating elements of which electric resistances may decrease with increase in temperature, thus referred to as negative temperature coefficient materials or simply referred to as NTC materials. Many patents such as U.S. Pat. No. 2,565,478 to Crowley, U.S. Pat. No. 2,581,212 to Spooner et al., U.S. Pat. No. 2,745,944 to Price, U.S. Pat. No. 2,820,085 to Crowley, U.S. Pat. No. 2,846,560 to Jacoby et al., U.S. Pat. No. 3,222,497 to Gordon, Jr., U.S. Pat. No. 3,814,899 to Gordon Jr., et al., U.S. Pat. Nos. 4,251,717 and 4,278,874 to Cole, U.S. Pat. No. 4,281,237 to Berenson, U.S. Pat. Nos. 4,315,141 and 4,430,560 to Mills et al., U.S. Pat. No. 4,485,296 to Ueda et al., U.S. Pat. No. 4,491,723 to Cole, U.S. Pat. No. 4,677,281 to Mills, U.S. Pat. No. 5,403,992 to Cole, U.S. Pat. No. 6,310,332 to Gerrard, and U.S. Pat. No. 6,689,989 to Irwin, Sr. et al. all describe various control mechanisms based on general principles of such NTC materials, where these patents are incorporated herein in their entireties by reference.

In another group of examples, electric blankets may employ other control algorithms which are based on their heating elements of which electric resistances increase with increase in temperature, thus termed as positive temperature coefficient materials or as PTC materials. Various patents such as U.S. Pat. No. 3,410,984 to Sandford et al., U.S. Pat. No. 3,793,716 to Smith-Johannsen, U.S. Pat. No. 3,858,144 to Bedard et al., U.S. Pat. No. 4,055,526 to Kiyokawa et al., U.S. Pat. Nos. 4,271,350 and 4,309,597 to Crowley, U.S. Pat. No. 4,436,986 to Carlson, U.S. Pat. No. 4,684,785 to Cole, U.S. Pat. No. 5,081,341 to Rowe, U.S. Pat. No. 5,403,992 to Cole, U.S. Pat. No. 5,218,185 to Gross, U.S. Pat. No. 5,837,971 to Lee, U.S. Pat. No. 6,084,206 to Williamson et al., U.S. Pat. No. 6,355,912 to Allard, U.S. Pat. No. 6,373,028 to Williamson et al., U.S. Pat. No. 6,664,512 to Horey et al., U.S. Pat. No. 6,794,610 to Horey et al., and U.S. 2003/0047549 by Horey et al. all disclose various control mechanisms based upon general principles of such PTC materials, where these patents are to be incorporated herein in their entireties by reference.

In yet another group of example, electric blankets may utilize neither the NTC materials nor the PTC materials but may employ other conventional control schemes generally known to those skilled in the arts of electrical and control engineering. For example, U.S. Pat. No. 4,132,262 to Wibell, U.S. Pat. No. 4,220,848 to McMullan et al., U.S. Pat. Nos. 4,270,040 and 4,358,668 to McMullan et al., U.S. Pat. No. 4,585,922 to Berenson, U.S. Pat. No. 4,626,657 to Endo et al., U.S. Pat. No. 4,652,726 to Femino et al., U.S. Pat. No. 4,983,814 to Ohgushi et al., U.S. Pat. No. 5,036,177 issued to Pagliarini, Jr., U.S. Pat. No. 5,049,724 to Anderson, U.S. Pat. No. 5,073,688 to McCormack, U.S. Pat. No. 5,151,577 to Aspden, U.S. Pat. No. 5,410,127 to LaRue et al., U.S. Pat. No. 5,412,181 to Giamati, U.S. Pat. No. 5,912,811 to Mackta, U.S. Pat. No. 6,097,009 to Cole, U.S. Pat. No. 6,153,856 to Lee, U.S. Pat. No. 6,177,658 issued to White et al., U.S. Pat. No. 6,222,162 to Keane, U.S. Pat. No. 6,617,550 to Sowa et al., U.S. Pat. No. 6,713,724 to Carr et al., U.S. Pat. No. 6,770,853 to Krieger et al., U.S. Pat. No. 6,914,216 to Chen, U.S. 2003/0191514 filed by Chatham, U.S. 2003/0234247 by Stern, U.S. Pat. No. 2,004,0035854 by Cheng et al., U.S. 2004/0069761 by Carr et al., and U.S. 2004/0069769 by Carr all disclose various control mechanisms each of which is to be incorporated herein in its entirety by reference. It is appreciated that the '514 application by Chatham discloses a boat blanket capable of transferring heat by convection, while the '247 application by Stern suggests to employ air pump for inflating and providing air insulation across its blanket module.

Regardless of their detailed control algorithms, the heating elements of such electric blankets are subject to repetitive heating and cooling, become deteriorated and degraded during each heating cycle, and eventually turn brittle. In addition, frequent application of severe tensile forces during use further facilitates degradation of such heating elements, and vulnerability to the mechanical damages may also be accelerated as time elapses. Therefore, there always lies a danger of overheating and short circuit in using those conventional electric blankets, regardless of whatever control algorithms they may employ and however rigorous such algorithms may be.

It is now well established in the scientific community that electromagnetic waves of varying frequencies irradiated by various devices may be hazardous to human health. In some cases, such electromagnetic waves in mega- and giga-hertz range may be the main culprit, whereas the 60-hertz electromagnetic waves may be the main health concern in other cases. It cannot be too emphasized that it is very difficult to shield against magnetic waves of the 60-hertz electromagnetic waves which have wavelengths amounting to thousands of kilometers and that such 60-hertz magnetic waves are omnipresent in any corner of our civilization. A potential danger posed by such magnetic waves may generally be minimized by maintaining a safe distance from the source of such waves. It is, however, not a practical solution for users of conventional electric blankets, for such blankets typically includes electric heating elements which wind around an entire area of the blankets under which the users lie and sleep. Accordingly, such blankets can bathe the user with massive amounts of electromagnetic waves overnight.

Various prior arts have addressed such health hazards due to such electromagnetic waves and attempted to provide solutions thereto. In one group of such solutions, various prior arts teach to use DC power in order to avoid emission of such electromagnetic waves. For example, U.S. Pat. No. 5,036,177 to Pagliarini teaches to convert an AC current into a DC current using a rectifier circuit, and U.S. Pat. No. 5,403,932 to Cole suggests to employ an rectified DC current. U.S. Pat. No. 5,151,577 to Aspden similarly suggests to convert 60 Hz AC current into a single-phase wave using a full-wave rectifier. U.S. Pat. No. 5,218,185 to Gross also teaches to use a filtered DC current, and U.S. Pat. No. 5,403,992 suggests to use rectified power. U.S. Pat. No. 5,410,127 to LaRue also proposes to use a full-wave rectified and filtered current, whereas U.S. Pat. No. 5,912,811 to Mackta teaches to rectify and filter an AC current into a DC current. U.S. Pat. No. 6,153,856 to Lee teaches to power his blanket with a DC current, while U.S. Pat. No. 6,310,332 to Gerrard similarly suggests to use half cycles of an AC current, where all of these patents are incorporated herein in their entireties by reference.

In another group of such solutions, the prior arts suggest various configurations of the heating elements which may cancel at least portions of the electromagnetic fields, thereby reducing amounts of such waves propagating toward users. For example, U.S. Pat. Nos. 5,403,992 and 6,097,009 both issued to Cole, U.S. Pat. No. 6,153,856 to Lee, U.S. Pat. No. 6,310,332 to Gerrard, as well as U.S. Pat. No. 6,617,550 to Sowa suggest various concentric or coaxial arrangements for their heating elements which are proposed to cancel such waves by winding multiple coils in opposite directions and/or by flowing electric currents in opposite directions through multiple coils wound in the same direction. In addition, U.S. Pat. No. 5,912,811 to Mackta discloses a closely spaced bundle arrangements for such heating elements, while U.S. Pat. No. 5,837,971 to Lee teaches concentric arrangements for various heating elements and shielding mesh therefor, where all of these patents are incorporated herein in their entireties by reference.

Despite their theoretical soundness, all of such prior arts are at most only marginally effective in shielding or reducing the amounts of the electromagnetic waves propagating toward the user. First of all, current technology easily permits to convert the AC power into the DC or quasi-DC power, only at the cost of losing a significant portion of the energy of the AC power. In view of a soaring price of electrical energy, such an approach is not a viable solution. In addition, this approach further suffers from various shortcomings in reality. For example, conversion of the AC current into the DC current generally requires a complicated circuitry, accompanies further loss of energy thereof, and increases cost of the blanket as well. On the other hand, incomplete conversion of the AC current followed by conventional smoothening or filtering techniques inevitably incorporates transients of 120 Hz (or 100 Hz in most European countries) AC components in the rectified current, which will lead to emission of 120 Hz electromagnetic waves which are believed to be as fatal as the 60 Hz waves. Secondly, the field-canceling arrangements of the prior art heating elements generally require coaxial or concentric arrangements which may involve complex current flow patterns through their resistive elements, lead conductors, sensor conductors, and so on. However, the coaxial or concentric arrangements have generally been applied to only portions of the heating elements and, therefore, their effectiveness is believed to be marginal at best. In addition, the electric current flowing in such coaxial or concentric elements and conductors should have identical intensities of currents for effective cancellation of the electromagnetic waves emitted thereby. Due to the complex pattern of electric current, however, the electric current flowing in adjacent portions of the elements and/or conductors may not be maintained identical and the electromagnetic waves irradiated by one element or conductor may be stronger than such waves emitted by another element or conductor. Therefore, only a small portion of such waves may be canceled, while leaving a majority portion of the waves to propagate toward the target space.

In addition to the fire hazards and electromagnetic radiation, conventional electric blankets are also notorious for drying up a body of the user. As the user covers his or her body with the blankets for an extended period of time, an elevated temperature in the target space tends to lower the relative humidity of the target space and to dry up the skin. However, no conventional electric blankets have ever addressed this problem, not to mention any proposed solution to cure the problem.

Accordingly, there is an urgent need for electric blankets and methods which may prevent or at least substantially suppress the electromagnetic waves emitted by various members thereof from propagating toward a target space. There further is an urgent need for electric blankets and methods which may be inherently designed to prevent fatal overheating of their blanket modules and, therefore, which may eliminate any possibility of their blanket modules catching fire due to such overheating. In addition, there is a need for electric blanket system and methods which may be able to heat the target space at a higher efficiency. Similarly, there also is a need for electric blanket systems and methods which may be able to instantly or at least rapidly heat the target space during initial heating operation. There further is a need for electric blanket systems and methods which may maintain the target space more favorable to human physiological conditions.

### SUMMARY OF THE INVENTION

The present invention relates to various electric blanket systems capable of providing heat to a target space by convection and/or conduction of heated air. More particularly, the present invention relates to various electric blanket systems each of which includes a blanket module, one or multiple air paths, an actuator member, and an heating member, where the heating member generates heat and transfers such heat to air, where the actuator member transports the heated air through the air paths, where the blanket module incorporates the air paths and receives the heated air through the air paths, thereby heating the target space by thermal conduction and/or forced convection of such heated air. In general, the actuator and heating members are disposed away from the blanket module and target space, thereby reducing intensities of electromagnetic waves which are irradiated by such members and propagate toward the target space. Such electric blanket systems offer numerous advantages as will be described in greater detail below. The present invention also relates to various methods of disposing the actuator and heating members of the electric blanket systems for reducing or minimizing electromagnetic radiation toward the target space, various methods of transferring heat to the target space through conduction and/or convection of such heated air through the blanket module, various methods of preventing overheating of the blanket module, various methods of improving an efficiency of heat transfer of the blanket module and air heating system, various methods of keeping the target space in a physiologically favorable condition, and the like. The present invention further relates to various processes for providing such convective and/or conductive electric blanket systems, various processes for providing the blanket modules of such systems capable of supplying the heated air into the target space and transferring heat thereto by forced convection, various processes for providing such blanket modules capable of supplying such heated air around the target space and transferring the heat thereto by conduction, various processes for fabricating such modules detachable from the actuator and heating members, and the like.

Therefore, one objective of the present invention is to provide an electromagnetically-shielded blanket system which may deliver thermal energy to an user who is disposed under a blanket module of the system while preventing (or at least minimizing) propagation of electromagnetic waves emitted by the system toward the user. Such a blanket system may be provided by providing wave sources (e.g., a heating member and an actuator member of the system) to be detachable and to be disposed away from the blanket module of the system.

Another objective of the present invention is to provide an electric blanket system which may protect the user from the electromagnetic waves emitted by the system without employing any electric and/or magnetic shields. A related objective of the present invention is to provide an electric blanket system which may protect the user from such waves without having to converting an AC current or power into a DC or pseudo-DC current or power. Such electric blanket systems may be provided by detachably disposing the wave sources of the systems away from their blanket modules.

Another objective of the present invention is to provide a convective electric blanket system for delivering the thermal energy to the user by supplying heated air directly to the user. The system may take in ambient air by its actuator member, generate heat by its heating member, provide heated air by transferring such heat to the air, and then deliver the heated air to the user disposed under the blanket module of the system.

Another objective of the present invention is to provide an electric blanket system capable of delivering thermal energy to the user by forced convection of such heated air through air outlets and to the user and by optional conduction of such thermal energy from the heated air to the user through an air path of the system. A related objective of this invention is to provide an electric blanket system capable of delivering such thermal energy by the thermal conduction through at least a portion of the air path while optionally delivering such energy by the forced convection through the air outlets. Such a system may be provided by forming one or multiple air paths which may be open to the target space through air outlets and therefore used for the forced convection and forming one or multiple air paths which may be disposed in the blanket module in a tortuous pattern for the conduction.

Another objective of the present invention is to provide an electric blanket system which may rapidly heat the target space during an initial stage of a heating operation. To this end, such a system may be arranged to heat the air to a higher temperature during the initial stage, to increase a flow rate of the heated air during such a stage, to transfer such heat preferentially through the convection than conduction, and the like.

Another objective of the present invention is to provide an electric blanket system with a high heat transfer efficiency. Such a system may achieve the high efficiency by heating air and supplying the heated air directly to the target space. Because the heated air may not have to be wasted to heat a body of the blanket module, the heat transfer efficiency may be improved.

Another objective of the present invention is to provide an electric blanket system including a blanket module which causes neither arcing not fire when the blanket module may be folded or bent repeatedly. Such a system may be constructed by preferably including its heating member away from the blanket module. Accordingly, any severe deformation of the blanket module does not and cannot cause a short circuit, for the heating member is not disposed in the blanket module.

Another objective of the present invention is to provide an electric blanket system including a blanket module which may not and cannot be overheated. Such a system may heat the air only up to a preset temperature which is generally below a scorching temperature or an ignition temperature of any portion of the blanket module. Therefore, the blanket module of such a system may not be heated above the preset temperature regardless of flow rates of the heated air, thereby inherently preventing overheating of such a module.

Another objective of the present invention is to provide an electric blanket system capable of delivering moisture or water vapor along with the heated air through one or multiple air outlets of such a system, thereby maintaining the humidity of the target space formed between the target and blanket module of the system. The system may include a water storage along its air path and then evaporate water from such a storage into the heated air as needed or at a preset rate.

Another objective of the present invention is to provide an electric blanket system capable of delivering oxygen along with the heated air through one or multiple air outlets thereof, thereby keeping a concentration of oxygen in the target space above a minimum level. Such a system may be formed by defining at least one air inlet which is fluidly open to an atmosphere, defining at least one air outlet which is fluidly open to the target space, and fluidly coupling the air inlet with air outlet. Alternatively, such a system may include an oxygen storage along its air path and then deliver the oxygen into the heated air as needed or at a preset rate.

Another objective of the present invention is to provide an electric blanket system capable of delivering pharmaceutical, herbal, and/or other volatile agents along with the heated air through one or multiple air outlets thereof, thereby keeping the body of the user with such an agent. Such a system may be formed by incorporating a storage of the agent along its air path and deliver the agent into the heated air as needed or at a preset rate.

Another objective of the present invention is to provide an electric blanket system including a blanket module which may automatically control a flow rate of the heated air through different regions thereof. Such a blanket module may be made of and/or include flexible or deformable materials so that a deformed region of the blanket module may have a higher hydraulic resistance therethrough and that the flow of the heated air may be automatically obstructed to the deformed region. Due to the limited flow of the heated air, such a deformed region may not be overheated as well.

Another objective of the present invention is to provide an electric blanket system including a light blanket module. Such a blanket module may be easily provided by forming its air paths from light but durable plastic or ceramic materials, while not incorporating any metal heating elements and metal conductors in such a blanket module. A related objective of this invention is to form an electric blanket system including a cheap and replaceable blanket module. Such a blanket module may be provided by forming the air paths from cheap plastic or ceramic materials without incorporating any expensive and sophisticated metal heating elements and conductors and any sensor wire therein. Therefore, such a cheap blanket module may be easily replaced after wear and tear by a new module, without having to replace the actuator and heating members of the system.

Another objective of the present invention is to provide an electric blanket system including a blanket module insulated along one surface thereof. The blanket module may be provided to include at least one thermal insulator on its top surface, thereby preventing loss of heat through the top surface. Accordingly, such a blanket module may offer an improved heat transfer efficiency and, conversely, such a system may be able to expend less electrical energy to provide the same amount of heat to the target space than the one without such insulation.

Another objective of the present invention is to provide an electric blanket system including a blanket module which may be machine washable and/or dried by conventional tumble dryers. Such a blanket module may be easily fabricated by preferentially incorporating various air paths therein, while including no portion or at most a trivial portion of the actuator member, heating member, and/or control member therein. Accordingly, such a blanket module may be washed and dried without damaging the actuator and heating members and without impeding operation of such members.

Another objective of the present invention is to provide an electric blanket system including a blanket module which may in turn include at least one air path therein and which may remain operative regardless of mechanical damages inflicted on such air path. When the system transfers the heat by convection of the heated air directly into the target space, such an air path may preferably define one or multiple openings or gaps therealong. Accordingly, damages on such an air path may only amount to forming one or more additional openings or gaps, while the actuator and heating members disposed away from the blanket module remain intact and continue their normal operations.

Another objective of the present invention is to provide an electric blanket system which may be arranged to emit infrared rays, to emit far-infrared rays, to generate ions, and the like. In general, certain materials known to emit such infrared and/or far-infrared rays may be incorporated along the blanket module of the system and heated by the heated air, thereby emitting such rays. In addition, the system may include conventional ion-generating units adjacent to actuator and/or heating members or along the air path, thereby transporting the ions and/or charged articles along with the heated air.

Another objective of the present invention is to provide an electric blanket system including a blanket module which is in turn comprised of multiple sections therealong. Such a blanket module may define multiple segments which may be disposed side by side and each of which may include at least one air path therein. By fluidly coupling such air paths of different segments, the blanket module may be provided in which the heated air may flow in various network configurations. A related objective of the present invention is to construct the segments in such a way that the user may fluidly attach a desired number of segments in a desirable shape, size, and/or orientation. Another related objective of the present invention is to construct the segments in such a way that the user may change one or more segments of the blanket module, thereby changing an overall flow pattern of the heated air.

Another objective of the present invention is to provide an electric blanket system which may be capable of actively discharging stale air from the target space which is defined under one surface of its blanket module. A blanket module of such a system may define one or more discharge air paths through which the actuator member may suck in the stale air inside the target space toward a drain such as atmosphere. Such a system may also recycle at least a portion of the stale air with fresh air in order to retrieve or utilize the heat contained therein.

Yet another objective of the present invention is to provide an electric blanket system capable of supplying ambient air into the target space without necessarily heating the air. Such a system may be used to discharge stale air heated by body temperature and/or contaminated by metabolic wastes out of the target space. Therefore, such an air supplying system may be used when the user wants to take the heat from the target space while desiring to put himself or herself under or over the blanket module thereof. A related objective of the present invention is to provide an electric blanket system for supplying cold air into the target space. Such a system may be provided by incorporating at least one conventional air cooling device, cooling ambient air, and then supplying the cool air into the target space. These systems may also be arranged to achieve the foregoing objectives for such electric air heating systems.

Various air heating systems of the present invention may be incorporated into and/or applied to various heating devices. For example, the air heating systems may be fabricated as overblankets (or simply blankets) or underblankets (or mats) so that the heated air may be supplied to the target space by convection or conduction from up above or from down below. Such systems may also be formed as heating pads which may be utilized as the foregoing overblankets or underblankets but provided in smaller dimensions. Such air heating systems may be incorporated as well into various beds including conventional spring beds, foam beds, air beds, and water beds and supply the heated air in order to transfer heat by convection and/or conduction. The air heating systems may further be incorporated into sleeping bags, medical or clinical enclosing devices, and the like.

In one aspect of the present invention, an electric blanket system may be provided to minimize emission of electromagnetic waves toward a target space.

In one exemplary embodiment of this aspect of the invention, a system may include at least one air path, at least one blanket module, at least one actuator member, at least one coupling module, and at least one heating member. The blanket module may be arranged to form the target space under one surface thereof and to include only at least a portion of the air path therealong. Such a blanket module is to be referred to as the type A blanket module hereinafter. The actuator member may be arranged to move or transport air along the air path by electrical energy while emitting the waves. The coupling module may be arranged to fluidly couple the actuator member to such a portion of the air path and to define a preset length, while the heating member may be arranged to be operatively coupled to at least another portion of the air path which may be arranged to be closer to the actuator member than the blanket module, to generate heat with electrical energy while emitting the waves, and to transfer such heat to the air flowing in such another portion of the air path. Whereby, at least substantial portions of such actuator and heating members may be arranged to be disposed away from the blanket module in use by a preset distance which may then be arranged to not exceed the preset length of the coupling module, thereby suppressing intensities of such waves below a preset limit as measured in a preset distance from the surface inside the target space.

In another exemplary embodiment of this aspect of the invention, such a system may include at least one air path, at least one blanket module, at least one actuator member, and at least one heating member. The blanket module may be arranged to form the target space thereunder and to include only at least a portion of the air path therealong. The actuator member may be arranged to move air along the air path by electrical energy while emitting such waves and to be disposed away from the blanket module. The heating member may be arranged to be operatively coupled to at least another portion of the air path, to generate heat with electrical energy while emitting such waves, to transfer the heat to the air flowing through such another portion of the air path, and to be also disposed away from such a blanket module. In one example and accordingly, the system may be arranged to provide such heat to the target space by the heated air while minimizing the emission of the waves to the target space. In another example and accordingly, such a system may be arranged to flow the heated air directly into the target space while minimizing the emission of the waves to the target space.

In another exemplary embodiment of this aspect of the invention, such a system may include at least one conduit member, at least one blanket module, at least one actuator member, and at least one heating member. The conduit member may be arranged to include at least one proximal air path and at least one distal air path which may fluidly couple with the proximal air path. Such a conduit member is to be referred to as the type A conduit member hereinafter. The blanket module may be arranged to form the target space under one surface thereof and to include not the proximal air path but the distal air path which may be disposed near the surface. The actuator member may be arranged to move air from the proximal air path to the distal air path by electrical energy. Such an actuator member is to be referred to as the type A actuator member hereinafter, where the actuator member of this embodiment may further be arranged to emit such waves. The heating member may be arranged to be operatively coupled to the proximal air path, to generate heat by electrical energy while emitting the waves, and to transfer the heat to the air flowing in the proximal air path. Whereby, such a system may be arranged to provide such heat to the target space by conduction of the heat from the distal air path to the target space and to minimize the emission of the waves to the target space.

In another exemplary embodiment of this aspect of the invention, such a system may include at least one conduit member, at least one blanket module, at least one actuator member, and at least one heating member. The conduit member may be of the type A, and the blanket module may be arranged to form the target space thereunder and to have not the proximal air path but the distal air path which may be arranged to form multiple openings fluidly coupling to the target space. The actuator member may be of the type A and arranged to further move air to the distal air path and through the openings while emitting the waves. The heating member may be arranged to operatively couple to the proximal air path, to generate heat by electrical energy while emitting the waves, and to transfer the heat to the air flowing in the proximal air path. Whereby, the system may be arranged to provide such heat to the target space by convection of the heated air flowing thereinto while minimizing the emission of such waves to the target space.

In another aspect of the present invention, a convective electric blanket system may be formed for providing heated air into a target space.

In one exemplary embodiment of this aspect of the invention, a system may include at least one conduit member, at least one blanket module, at least one actuator member, and at least one heating member. The conduit member may be of the type A, and the blanket module may be arranged to form the target space thereunder and to include not the proximal air path but the distal air path which fluidly couples with the target space. The actuator member may be of the type A which may be arranged to transport air further into such a target space. The heating member may be arranged to be operatively coupled to the proximal air path, to generate heat, and to transfer the heat to the air flowing through the proximal air path with electrical energy. Such a heating member is to be referred to as the type A heating member hereinafter. Whereby, the system may be arranged to provide the heat into the target space through directly flowing the heated air flowing into the target space.

In another exemplary embodiment of this aspect of the invention, such a system may include at least one air path, at least one blanket module, at least one actuator member, and at least one heating member. The blanket module may be arranged to include therein a top layer and a bottom layer, where the top layer may be arranged to include a thermal insulator therealong, while the bottom layer may be arranged to define the target space thereunder and to include therein only at least a portion of the air path fluidly coupling with the target space. The actuator member may be arranged to move air in the air path and to the target space by electrical energy. Such an actuator member is to be referred to as the type B actuator member hereinafter, and may be arranged to be disposed away from the blanket module in this embodiment. The heating member may be arranged to be operatively coupled to at least another portion of the air path, to generate heat with electrical energy, to transfer the heat onto the air flowing in such another portion of the air path. Such a heating member is to be referred to as the type D heating member, and may also be disposed away from the blanket module in such an embodiment. Whereby, the system may be arranged to provide the heat to the target space by supplying the heated air thereinto while minimizing loss of the heat across the top layer of the blanket module.

In another exemplary embodiment of this aspect of the invention, such a system may include at least one conduit member, at least one blanket module, at least one actuator member, and at least one heating member. The conduit member may be arranged to include at least one air inlet, at least one air path, and at least one air outlet fluidly coupling with each other sequentially. Such a conduit member is to be referred to as the type B conduit member hereinafter. The blanket module may be arranged to form the target space thereunder and to include only at least a portion of the air path and the air outlet fluidly coupling with the target space. Such a blanket module is to be referred to as the type B blanket module hereinafter. The actuator member may be arranged to transport air from the air inlet to the air outlet through the air path by electrical energy. The heating member may be of the type D. Whereby, the system may be arranged to provide the heat to the target space by flowing the heated air into the target space without having to heat the blanket module beforehand or a priori.

In another exemplary embodiment of this aspect of the invention, such a system may include at least one air path, at least one blanket module, at least one actuator member, and at least one heating member. The blanket module may be arranged to define the target space thereunder and to include only at least a portion of the air path fluidly coupling with the target space. The actuator member is of the type B which may also be disposed away from such a blanket module. The heating member may be of the type D which may further be disposed away from the blanket module. Whereby, the system may be arranged to provide the heat to the target space by supplying such heated air thereinto while minimizing propagation of electromagnetic waves emitted by the actuator and heating members to the target space.

In another exemplary embodiment of this aspect of the invention, such a system may include at least one conduit member, at least one blanket module, at least one actuator member, and at least one heating member. The conduit member is of the type B, where the air outlet may further be arranged to fluidly couple with a source of moisture and/or oxygen. The blanket module may be arranged to form the target space thereunder and to have only at least a portion of the air path as well as the air outlet fluidly coupling with the target space. The actuator member may be arranged to move air having such moisture and/or oxygen from the air inlet through the air path to the air outlet and into the target space using electrical energy. The heating member may be of the type D. Whereby, such a system may be arranged to provide the heated air to the target space with such moisture and/or oxygen.

In another exemplary embodiment of this aspect of the invention, such a system may include at least one conduit member, at least one blanket module, at least one actuator member, and at least one heating member. The conduit member may be of the type B, and the blanket module may be arranged to form the target space thereunder and to have only at least a portion of the air path and the air outlet fluidly coupling to the target space. The heating member is of the type D, while the actuator member may be arranged to transport air from the air inlet to the air outlet through the air path using electrical energy while recycling at least a portion of the air flowing out of the air outlet into the air receiving the heat from the heating member, thereby improving an efficiency of generating the heated air.

In another aspect of the present invention, an electric blanket system may be provided in order to generate heated air and to transfer heat of the heated air to or into a target space through thermal conduction and convection by the heated air.

In one exemplary embodiment of this aspect of the invention, a system may include at least one conduit member, at least one blanket module, at least one actuator member, and at least one heating member. The conduit member is of the type A, and the blanket module may be arranged to define the target space thereunder and to include the distal air path at least a portion of which may be arranged to move between at least one open state and at least one closed state in order to and not to be fluidly coupled to the target space, respectively. The actuator member may be of the type A, and the heating member may be of the type A. Whereby such a system may be arranged to control the portion of the distal air path between the open and closed states in order to provide such heat to the target space by directly supplying the heated air into the target space and by transferring the heat across the distal air path by conduction, respectively.

In another exemplary embodiment of this aspect of the invention, such a system may include at least one conduit member, at least one blanket module, at least one actuator member, and at least one heating member. The conduit member may be arranged to include at least one proximal air path and multiple distal air paths fluidly coupling with the proximal air path directly or indirectly. Such a conduit member is to be referred to as the type C conduit member hereinafter. Such a blanket module may be arranged to form the target space thereunder, to include at least one first of the distal air paths which may fluidly couple with the target space, and to have at least one second of the distal air paths which may not fluidly couple with the target space. The actuator member may be arranged to move air from the proximal air path to at least one of the first and second of the distal air paths by electrical energy. Such an actuator member is to be referred to as the type C actuator member hereinafter. The heating member may be of the type A. Whereby, the system may be arranged to provide the heat to the target space by convection through the first of such distal air paths and/or conduction through the second of such distal air paths.

In another exemplary embodiment of this aspect of the invention, such a system may include at least one conduit member, at least one blanket module, at least one actuator member, and at least one heating member. The conduit member may be of the type C. The blanket module may be arranged to define the target space under one surface thereof and to have the distal air paths, where at least one first of the distal air paths may be arranged to fluidly couple with the target space and where at least one second of the distal air paths may be arranged to not be fluidly coupled to the target space. The actuator member may be of the type C, and the heating member may be of the type A. In one example and accordingly, the system may be arranged to provide the heat into the target space by flowing the heated air into the first and second of such distal air paths. In another example and accordingly, the system may be arranged to adjust amounts of such heated air supplied to the first and second of the distal air paths, thereby adjusting amounts of the heat which may be transferred to the target space by convection through the first of such distal air paths and by conduction through the second of the distal air paths. In another example and accordingly, the system may be arranged to supply the heat air directly to the target space through the first of the distal air paths during an initial heating operation and then to supply such heated air through at least one of the first and second of the distal air paths thereafter.

In another exemplary embodiment of this aspect of the invention, such a system may include at least one conduit member, at least one blanket module, at least one actuator member, and at least one heating member. The conduit member is of the type C, while the blanket module may be arranged to define the target space under one surface thereof and to have the distal air paths, where at least one first of the distal air paths may be arranged to be fluidly coupled with the target space and where at least one second of the distal air paths may be arranged to not fluidly couple with the target space. In one example, the actuator member may be arranged to move air by electric energy from the proximal air path to the first and/or second of the distal air paths in preset amounts. The heating member may be of the type A. Whereby the system may be arranged to provide such heat into the target space by supplying such heated air through the distal air paths while controlling such amounts of the heated air flowing through the first and second of the distal air paths in different values. In another example, the actuator member is of the type C, while the heating member is of the type A which may transfer such heat to the air flowing into to each of such first and second of the distal air paths in preset amounts. Whereby, this system may be arranged to provide the heat into the target space by flowing the heated air through the distal air paths while controlling temperature of the heated air flowing through the first and second of the distal air paths in different values.

In another exemplary embodiment of this aspect of the invention, such a system may include at least one conduit member, at least one blanket module, at least one actuator member, and at least one heating member. The conduit member is of the type A, while the blanket module may be arranged to define the target space under one surface thereof and to have the distal air paths, where at least one first of the distal air paths may be arranged to fluidly couple with the target space and where at least one second of such distal air paths may be arranged to not fluidly couple with the target space. The actuator member may be of the type C which may also disposed away from the blanket module. The heating member may be arranged to be operatively coupled to the proximal air path, to generate heat using electrical energy, to transfer the heat into the air flowing through the proximal air path, and to be disposed away from such a blanket module. Such a heating member is to be referred to as the type B heating member hereinafter. Whereby, the system may be arranged to provide the heat to the target space by directly supplying the heated air into the target space and/or indirectly transferring the heat across the distal air path through conduction, while minimizing propagation of electromagnetic waves which are emitted by the actuator and/or heating members toward the target space.

In another aspect of the present invention, an electric blanket system may include at least one blanket module capable of forming a target space thereunder and minimizing malfunctions thereof.

In one exemplary embodiment of this aspect of the invention, a system may include at least one conduit member, at least one actuator member, and at least one heating member. The conduit member is of the type A including its distal air path disposed in the blanket module. The actuator member is of the type A, and the heating member may be arranged to be operatively coupled to the proximal air path and to heat the air flowing in the proximal air path using electrical energy while being disposed away from the blanket module. In one example and accordingly, the blanket module may be protected from the malfunctions even if the blanket module may be be damaged. In another example and therefore, the blanket module may be protected from fire caused by overheating of the heating member and/or formation of a short circuit in the heating member.

In another exemplary embodiment of this aspect of the invention, a system may include at least one conduit member, at least one actuator member, and at least one heating member. Such a conduit member is of the type A having its distal air path which may be arranged to be disposed in the blanket module, to be at least partly deformable, and to fluidly couple with the proximal air path. The actuator member is of the type A, while the heating member may be arranged to be operatively coupled to the proximal air path, to generate heat by electrical energy, to transfer the heat to the air flowing through the proximal air path, and to not be disposed in the blanket module. Such a heating member is to be referred to as the type C heating member hereinafter. Whereby, the blanket module may be arranged to not cause overheating of the heating member and to not form a short circuit in the heating member even if at least a portion of the blanket module may be folded at any angle.

In another exemplary embodiment of this aspect of the invention, a system may include at least one conduit member, at least one actuator member, and at least one heating member. Such a conduit member may be of the type A including its distal air path disposed in the blanket module. The actuator member may be of the type A and the heating member is of the type C. At least a portion of the distal air path may be arranged to be deformable and to obstruct a flow of the heated air therethrough when such a portion is deformed beyond a preset extend, thereby preventing overheating of the deformed portion of the distal air path.

In another exemplary embodiment of this aspect of the invention, a system may have at least one conduit member, at least one actuator member, and at least one heating member. Such a conduit member may be arranged to include at least one proximal air path and at least one distal air path which may be disposed in the blanket module and arranged to fluidly couple with the proximal air path in one end thereof and with the target space in another end thereof. Such an actuator member is of the type A which may further transport air into the target space. In one example, the heating member may be arranged to operatively couple to the proximal air path, to generate heat with electrical energy, and to transfer such heat into the air flowing in the proximal air path up to a preset temperature which may be low enough to not ignite (or not scorch) any portion of the system, thereby preventing fire due to overheating of the blanket module by the heated air. In another example, the heating member is of the type A which may further be arranged to transfer the heat in such a way that a temperature around such one end of the distal air path may be low enough not to ignite (or not to scorch) any portion of the system, thereby preventing fire caused by overheating of the blanket module by the heated air.

In another aspect of the present invention, an electric blanket system may include at least one blanket module capable of forming a target space thereunder and improving physiological condition of the target space.

In one exemplary embodiment of this aspect of the invention, a system may include at least one conduit member, at least one blanket module, at least one actuator member, and at least one heating member. Such a conduit member is of the type B, the blanket module is of the type B, and the heating member is of the type D. In one example, the actuator member may be arranged to move air including moisture through the air path and the air outlet by electrical energy, where the moisture is supplied by an ambient air and/or a storage of water, thereby providing the heated air and moisture into the target space and increasing humidity of the target space. In another example, the actuator member may be arranged to move air including oxygen through the air path and air outlet with electrical energy, where the oxygen is supplied from an ambient air and/or a storage of oxygen, thereby providing such heated air and oxygen into the target space and increasing concentration of such oxygen in the target space. In another example, the actuator member may be arranged to transport air through the air path and air outlet and into the target space by electrical energy, thereby providing such heated air into the target space while displacing stale air out of the target space.

In another exemplary embodiment of this aspect of the invention, such a system may include at least one conduit member, at least one blanket module, at least one actuator member, and at least one heating member. Such a conduit member is of the type B, the blanket module is of the type B, and the heating member is of the type D. In one example, the system also include at least one sensor member which may monitor humidity in the target space. The actuator member may then be arranged to move air including moisture through the air path and air outlet by electrical energy and to operatively couple with the sensor member, where the moisture may be supplied from an ambient air and/or a storage of water, thereby providing the heated air as well as moisture into the target space while controlling the humidity of the target space at a preset level. In another example, the system may similarly include at least one sensor member which may monitor oxygen concentration in the target space. The actuator member may be arranged to move air including oxygen through the air path and air outlet by electrical energy and to operatively couple with the sensor member, where such oxygen may be supplied from an ambient air and/or a storage of oxygen, thereby providing the heated air and oxygen into the target space while controlling the humidity inside the target space at a preset level.

In another exemplary embodiment of this aspect of the invention, such a system may have at least one conduit member, at least one blanket module, at least one actuator member, and at least one heating member. The conduit member is of the type B which may also include at least one discharge air path fluidly coupling with the target space. The blanket module is of the type B, while the heating member is of the type D. The actuator member may be arranged to transport fresh air through the air path by electrical energy and to take in stale air inside the target space through the discharge air path, thereby supplying the fresh air into the target space while displacing the stale air out of such a target space.

In another exemplary embodiment of this aspect of the invention, such a system may have at least one conduit member, at least one blanket module, at least one actuator member, and at least one heating member. The conduit member is of the type B, while the blanket module is of the type B. The system may also have at least one evaporation member which may be arranged to be fluidly coupled to at least another portion of the air path, to include at least one volatile agent, and to evaporate such an agent into air flowing in such another portion of the path. The heating member may be arranged to operatively couple with yet another portion of the air path, to generate heat with electrical energy, and to transfer the heat to the air flowing in such yet another portion of the air path. The actuator member may be arranged to move the air including therein the agent through the air path with electrical energy, thereby providing the heated air and the agent into the target space.

In another exemplary embodiment of this aspect of the invention, such a system may have at least one conduit member, at least one blanket module, at least one actuator member, and at least one heating member. The conduit member is of the type B, while the blanket module is of the type B. The heating member may be arranged to operatively couple with at least another portion of the air path, to generate heat with electrical energy while emitting electromagnetic waves, and to transfer such heat onto the air flowing in such another portion of the air path. The actuator member may be arranged to transport air including at least one agent therein through the air path and air outlet by electrical energy while emitting such waves and to be disposed away from the blanket module. Whereby, the system may be arranged to provide the heated air along with the agent into the target space while minimizing propagation of the waves toward the target space.

In another aspect of the present invention, an electric blanket system may include at least one blanket module which may be form a target space thereunder while maximizing an efficiency of heat transfer into the target space.

In one exemplary embodiment of this aspect of the invention, a system may have at least one air path, at least one blanket module, at least one actuator member, and at least one heating member. Such a blanket module may be arranged to define at least one top layer and at least one bottom layer, where the top layer may be arranged to include a thermal insulator therealong, while the bottom layer may be arranged to define the target space thereunder and to include only at least a portion of the air path fluidly coupling with the target space. The heating member is of the type D, while the actuator member is of the type B. Whereby, the system may be arranged to transfer the heat into the target space by the heated air while minimizing loss of the heat across the top layer of the blanket module.

In another exemplary embodiment of this aspect of the invention, such a system may include at least one air path, at least one blanket module, at least one actuator member, and at least one heating member. The blanket module is of the type A which may also include only at least a portion of the air path open only to such a surface. The heating member is of the type D, and the actuator member is of the type B. Such a blanket module may be disposed with the opposite surface facing the target space during use, thereby transferring such heat into the target space through the portion of the air path by the heated air while minimizing loss of the heated air through the top surface of the blanket module.

In another exemplary embodiment of this aspect of the invention, such a system may include at least one air path, at least one blanket module, at least one actuator member, and at least one heating member. The blanket module may be arranged to form the target space thereunder and to include only at least a portion of the air path which may be arranged to not be open to an interior of such a blanket module but to be open to the target space. The heating member is of the type D, while the actuator member is of the type B. Whereby the system may be arranged to transfer the heat preferentially into the target space while minimizing the heat transferred to the interior of the blanket module.

In another exemplary embodiment of this aspect of the invention, such a system may include at least one air path, at least one blanket module, at least one actuator member, and at least one heating member. The blanket module may be arranged to form the target space thereunder and to include only at least a portion of the air path fluidly coupling with the target space. The heating member may be of the type D, while the actuator member may be of the type B. Whereby, the system may be arranged to rapidly transfer the heat into the target space during an initial heating operation while minimizing loss of the heat used in heating the blanket module during the initial heating operation.

In another aspect of the present invention, an electric blanket system may include at least one blanket module capable of forming a target space thereunder and controlling temperature in the target space.

In one exemplary embodiment of this aspect of the invention, a system may have at least one conduit member, at least one actuator member, and at least one heating member. The conduit member is of the type A, and the actuator member is of the type A which may also transport air into the target space. The heating member is of the type A which may heat the air flowing in the proximal air path up to a preset temperature which may be low enough not to ignite or scorch) any portion of the system. Whereby, such a system may be arranged to keep a temperature in any portion of the blanket module under the preset temperature regardless of an amount of the heated air supplied thereto.

In another exemplary embodiment of this aspect of the invention, a system may include at least one conduit member, at least one actuator member, and at least one heating member. Such a conduit member is of the type A which may also include at least one distal air path which may be disposed in the blanket module and at least partly deformable. The actuator member may be of the type A, and the heating member may be of the type C. Whereby, such a system may be arranged to provide different amounts of the heated air to different portions of the blanket module depending at least partially upon hydraulic resistances which may in turn be determined by extents of deformation of such portions of the blanket module and to also control temperature of the portions of the blanket module accordingly.

In another aspect of the present invention, an electric blanket system may be provided in order to minimize a weight of a blanket module which defines a target space thereunder.

In one exemplary embodiment of this aspect of the invention, a system may include at least one conduit member, at least one actuator member, and at least one heating member. The conduit member is of the type A, the actuator member is of the type A, and the heating member is of the type A. Such a system may be arranged to incorporate such actuator and heating members away from the blanket module and to incorporate the distal air path into the blanket module, thereby limiting the weight of the blanket module to a minimum value.

In another exemplary embodiment of this aspect of the invention, a system may include at least one conduit member, at least one actuator member, and at least one heating member. Such a conduit member is of the type A which may also include at least one distal air path which may be disposed in the blanket module and to define a hollow structure. The actuator member is of the type A which may also be disposed away from the blanket module, while the heating member is of the type B. Whereby, the blanket module may be arranged to maintain the weight to a minimum value.

In another exemplary embodiment of this aspect of the invention, a system may include at least one conduit member, at least one actuator member, and at least one heating member. Such a conduit member may be arranged to include at least one proximal air path and multiple distal air paths, where the distal air paths may be disposed in the blanket module, where each of the distal air paths may be arranged to fluidly couple with the proximal air path directly or indirectly through at least another of the distal paths, and where at least two of the distal air paths may be arranged to detachably couple with each other. The actuator member is of the type A which may also be disposed away from the blanket module, and the heating member is of the type B. Such a system may be arranged to allow an user to fluidly assemble only a preset number of the distal air paths to define the blanket module of a desired shape and size, thereby maintaining the weight of the blanket module to a minimum value.

In another aspect of the present invention, an electric blanket system may be formed to warm a target space by supplying heated air thereinto and having a blanket module which may be arranged to define the target space thereunder and to include multiple segments at least two of which may be fluidly, mechanically, and detachably coupled to each other.

In one exemplary embodiment of this aspect of the invention, a system may include at least one conduit member, at least one actuator member, and at least one heating member. The conduit member may be arranged to include at least one proximal air path and multiple distal air paths, where the distal paths may be arranged to be fluidly coupled to the proximal air path directly or indirectly and to also be incorporated into at least a substantial number of the segments of the blanket module. The actuator member is of the type A, while the heating member is of the type A. The segments of such a blanket module may be arranged to couple with each other so as to define the blanket module which may be arranged to have a preset shape and size and to define a preset configuration of the distal air paths.

In another exemplary embodiment of this aspect of the invention, a system may include at least one conduit member, at least one actuator member, and at least one heating member. Such a conduit member is of the type C, the actuator member is of the type A, and the heating member is of the type A. Each of the segments of the blanket module may be arranged to include at least one of such distal paths, while at least two of the segments of the blanket module may be arranged to include the distal paths defining different shapes, sizes, and/or coupling modes or arrangements, thereby allowing an user to provide different blanket modules with different shapes, sizes, and coupling arrangements or modes depending upon which of such segments is to be included in the blanket module.

In another exemplary embodiment of this aspect of the invention, a system may include at least one conduit member, at least one actuator member, and at least one heating member. Such a conduit member is of the type C, the actuator member is of the type A, and the heating member is of the type A. At least one of the segments of such a blanket module may be arranged to be detachable from the rest of the segments while allowing the blanket module to maintain a preset configuration of the distal air paths through which the heated air may flow into the target space.

In another exemplary embodiment of this aspect of the invention, a system may include at least one conduit member, at least one actuator member, and at least one heating member. Such a conduit member may be arranged to include at least one proximal air path and multiple distal air paths which may fluidly couple with the proximal air path directly or indirectly and may be incorporated into at least a substantial number of the segments of the blanket module. The actuator member may be of the type A which may also be disposed away from the blanket module, and the heating member is of the type B. Whereby the blanket module may be arranged to be made of any preset number of such segments coupling with each other without affecting operation of the actuator and heating members.

In another aspect of the present invention, an electric blanket may also be provided for heating a target space by heated air.

In one exemplary embodiment of this aspect of the invention, a system may include at least one conduit member, at least one blanket module, at least one actuator member, and at least one heating member. The conduit member may be arranged to include therealong at least one air inlet, at least one proximal air path, at least one distal air path, and at least one air outlet which are arranged to be fluidly coupled to each other sequentially. Such a conduit member is to be referred to as the type D conduit member hereinafter. In this embodiment, its air outlet may be arranged to at least partially fluidly couple with the air inlet. The blanket module may be arranged to define the target space under one surface thereof and to include the distal air path therealong near the surface. Such a blanket module is to be referred to as the type C blanket module hereinafter. The actuator member may be disposed away from the blanket module and arranged to take in air through the air inlet and to transport the air through the proximal air path and distal air path. Such an actuator member is to be referred to as the type D actuator member hereinafter. In this embodiment, the actuator member may also move the air toward the air inlet. The heating member may be arranged to operatively couple with the proximal air path, to generate heat by electrical energy, to transfer the heat to the air flowing in the proximal air path to the distal air path, and to be disposed away from such a blanket module, where such a heating member is to be referred to as the type E heating member hereinafter. Whereby, the system may be arranged to provide the heat to the target space by conduction of the heat of the heated air from the distal air path to the target space.

In another exemplary embodiment of this aspect of the invention, such a system may include at least one conduit member, at least one blanket module, at least one actuator member, and at least one heating member. The conduit member is of the type D, where its air outlet may be arranged to at least partially fluidly couple with the target space. The blanket module is of the type C, the actuator member is of the type D which may further move the air into the target space, and the heating member is of the type E. Whereby the system may be arranged to provide the heat into the target space by convection of the heated air directly into the target space.

In another exemplary embodiment of this aspect of the invention, such a system may include at least one conduit member, at least one blanket module, at least one actuator member, and at least one heating member. The conduit member is of the type C, where its air inlet may be arranged to be fluidly coupled to a storage of moisture, oxygen, pharmaceutical agents, and/or herbal agents and where the air outlet may be arranged to at least partially fluidly couple with the target space. The blanket module is of the type C, the actuator member is of the type D which may also transport such air into the target space, and the heating member is of the type E. Whereby, the system may be arranged to provide the heat to the target space through supplying the heated air directly into the target space along with such moisture, oxygen, pharmaceutical agent, and/or herbal agent.

In another exemplary embodiment of this aspect of the invention, such a system may include at least one conduit member, at least one blanket module, at least one actuator member, and at least one heating member. The conduit member may be arranged to include therein at least one air inlet, at least one proximal air path, multiple distal air paths, and at least one air outlet which may be arranged to be fluidly coupled to each other sequentially. The air outlet may be arranged to be at least partially fluidly coupled to the air inlet or the target space. At least one blanket module may be arranged to define the target space under one surface thereof, to include near the surface such distal air paths, and to form multiple segments each of which may be arranged to include therein at least one of the distal air paths and at least one of which may also be arranged to be attached to and detached from the rest of such segments while defining different configurations of the distal paths along such a blanket module. The actuator member may be disposed away from the blanket module and arranged to take in air through the air inlet and to transport the air through the proximal air path and the distal air paths with electrical energy. Such an actuator member is to be referred to as the type E actuator member hereinafter. The heating member may be arranged to be operatively coupled to the proximal air path, to generate heat by electrical energy, to transfer the heat to the air flowing in the proximal air path toward the distal air paths, and to be disposed away from the blanket module. Such a heating member is to be referred to as the type G heating member hereinafter. Whereby, the system may be arranged to provide the heat to the target space by conduction of the heat from the heated air flowing through the distal air path to the target space and/or by convection of the heated air into the target space while varying the above configurations of such distal air paths along the blanket module depending upon such at least one of the segments attached to and detached from the rest of the segments.

In another exemplary embodiment of this aspect of the invention, such a system may include at least one conduit member, at least one blanket module, at least one actuator member, and at least one heating member. The conduit member is of the type D, where the air outlet may be arranged to at least partially fluidly couple with the air inlet or target space. The blanket module may be arranged to define the target space under one surface thereof, to include near the surface the distal air path, and to form multiple segments each of which may be arranged to include therein at least a portion of the distal air path and at least one of which may be arranged to be folded while at least partially obstructing such a portion of the distal air path included therein. The actuator member is of the type D, while the heating member is of the type E. Whereby, such a system may be arranged to provide the heat to the target space by conduction of the heat from the heated air flowing in the distal air path to the target space and/or by convection of the heated air directly into the target space while changing amounts of such heated air supplied to such at least one of the segments depending upon an extent of folding thereof.

In another exemplary embodiment of this aspect of the invention, such a system may include at least one conduit member, at least one blanket module, at least one actuator member, and at least one heating member. The conduit member is of the type D, where its air outlet may be arranged to at least partially fluidly couple with the air inlet or target space. The blanket module may be arranged to define the target space under one surface thereof and to include near the surface such a distal air path The actuator member is of the type D, while the heating member is of the type E. In one example, such a system may include at least one control member which may be arranged to be operatively coupled to the actuator and/or heating members and to control a flow rate of the heated air through the distal air path and/or an amount of the heat transferred to the air. Whereby, such a system may be arranged to provide the heat to the target space by conduction of the heat from the heated air flowing through the distal air path to the target space and/or by convection of the heated air directly into the target space while adjusting such a flow rate and/or amount of the heat. In another example, the system may have at least one control member which may be arranged to be operatively coupled to different portions of the distal air path and to control flow rates of such heated air supplied to the portions of the distal air path. Whereby, the system may be arranged to provide the heat to the target space by conduction of the heat from the heated air flowing in the distal air path into the target space and/or by convection of the heated air into the target space while adjusting such flow rates of the heated air flowing through the different portions of the distal air path.

In another exemplary embodiment of this aspect of the invention, such a system may include at least one conduit member, at least one blanket module, at least one actuator member, and at least one heating member. The conduit member is of the type D. The blanket module may be arranged to define the target space under one surface thereof and to include at least two of the distal outlets at least one of which may be arranged to be fluidly coupled to the target space and at least another of which may be arranged to not be fluidly coupled to the target space but to be disposed near such a surface. The actuator member is of the type E, and the heating member is of the type G. The system may also have at least one control member which may operatively couple with at least one of such members and to control flow rates of the heated air through the distal air paths and/or amounts of the heat transferred to the air flowing in the distal air paths. Whereby, the system may be arranged to provide the heat to the target space by conduction of the heat from the heated air flowing in such another of the distal air paths to the target space and/or by convection of such heated air supplied into the target space from such one of the distal air paths while adjusting the flow rates and amounts of the heat transferred to the blanket module by the conduction and convection.

In another aspect of the present invention, an electric blanket may be provided to heat a target space by transferring heat from heated air.

In one exemplary embodiment of this aspect of the invention, a system may include at least one conduit member, at least one blanket module, at least one actuator member, and at least one heating member. The conduit member is of the type D, where its air inlet may be arranged to be fluidly coupled to atmosphere, where its air outlet may be arranged to at least partially fluidly couple with the air inlet, and where the distal air path may be arranged to be shaped as a tube including at least one exterior wall and at least one lumen therein. The blanket module is of the type C, the actuator member is of the type D which may further move the air toward the air inlet, while the heating member is of the type E. Whereby, the system may be arranged to provide such heat to the target space by conduction of the heat from the heated air flowing in the distal air path toward the target space.

In another exemplary embodiment of this aspect of the invention, such a system may include at least one conduit member, at least one blanket module, at least one actuator member, and at least one heating member. The conduit member is of the type D, where its air inlet may be arranged to be fluidly coupled to atmosphere, while the air outlet is arranged to be at least partially fluidly coupled to the air inlet. The blanket module may be arranged to define the target space under one surface thereof and to define near the surface at least one porous structure which is arranged to form the distal air path therein. The actuator member is of the type D which may further move the air toward the air inlet. The heating member is of the type E. Whereby, such a system may be arranged to provide the heat to the target space by conduction of the heat from the heated air flowing through the distal air path toward the target space.

In another aspect of the present invention, an electric blanket may be provided to heat a target space by flowing heated air thereinto.

In one exemplary embodiment of this aspect of the invention, a system may include at least one conduit member, at least one blanket module, at least one actuator member, and at least one heating member. The conduit member is of the type D, where its air inlet may be arranged to be fluidly coupled to atmosphere, where the distal air path may be arranged to be shaped as a tube which may define at least one exterior wall and at least one lumen therethrough, and where the air outlet may be arranged to at least partially fluidly couple with the target space. The blanket module is of the type C which may also allow its distal air path to fluidly couple with the target space. The actuator member is of the type D which may also move the air into the target space. The heating member is of the type E. Whereby the system may be arranged to provide such heat to the target space by convection of the heated air directly into the target space.

In another exemplary embodiment of this aspect of the invention, such a system may include at least one conduit member, at least one blanket module, at least one actuator member, and at least one heating member. The conduit member is of the type D, where its air inlet may be arranged to be fluidly coupled to atmosphere, while the air outlet may be arranged to at least partially fluidly couple with the air inlet. The blanket module may be arranged to form the target space under one surface thereof and to define near the surface at least one porous structure which may be arranged to define the distal air path and air outlet therein. The actuator member is of the type D which may further move the air into the target space, while the heating member is of the type E. Whereby the system may be arranged to provide the heat to the target space by convection of the heated air directly into the target space.

Embodiments of the above systems aspects of the present invention may include one or more of the following features.

The conduit member may include any number of such air inlets and/or outlets. The air inlet may be disposed proximal to the actuator and/or heating members, and the air outlet may fluidly couple with one surface of the blanket module in order to fluidly couple with the target space or, alternatively, may fluidly couple with a portion of the proximal air path close to the actuator and/or heating members. The air inlet and/or outlet may be arranged to vary hydraulic resistances in order to manipulate a flow rate of the air and/or heated air therethrough. The air inlet may be arranged to adjust amounts of the fresh air and recycled air taken in to the conduit member by the actuator member. The conduit member may also include at least one filter unit capable of filtering foreign particles out of the air taken thereinto, out of the heated air supplied to the target space, and the like.

The proximal air path may be fluidly coupled to one or more of the air inlets, while the distal air path may fluidly couple with one or more of the air outlets. The distal air path may be made of and/or include at least one material which has a relatively high thermal conductivity. At least a portion of the distal air path may be enclosed or covered with at least one material having a relatively high thermal conductivity in order to enhance conduction therethrough.

Such proximal and distal air paths may define identical, similar or different configurations. The proximal and distal air paths may be made of and/or include identical, similar or different materials. The proximal and distal air paths may be fluidly coupled to each other in series. The conduit member may include any number of the proximal and/or distal air paths. Multiple proximal and/or distal air paths may have identical, similar or different configurations. Multiple proximal and/or distal air paths may also be made of and/or include identical, similar or different materials. Each of the multiple distal air paths may be fluidly coupled to the proximal air path either directly or indirectly through another of such distal air paths.

The distal air path may define an outer or exterior wall and at least one inner or interior lumen, where such a wall may be solid or may define at least one opening (or the air outlet) therethrough. In the alternative, the distal air path may include multiple portions each of which may define the wall and lumen therein and at least two of which may be mechanically coupled to each other while defining at least one gap (or the air outlet) therebetween. In another alternative, the distal air path may define a porous structure defining therethrough multiple pores (or the air outlets).

The conduit member may also include at least one discharge air path fluidly coupling with the target space and at least a portion of the proximal and/or distal air paths. At least one of the air paths may be made of and/or include at least one rigid material, at least one elastic or deformable material, and the like. At least one of the air paths may be made of and/or include multiple rigid portions at least two of which may be movably coupled to each other. The conduit member may include at least one junction in which multiple proximal and/or distal air paths may merge or bifurcate, at least one coupler which may fixedly or releasably couple multiple proximal and/or distal air paths, at least one manifolds which may distribute the air and/or heated air into multiple proximal and/or distal air paths, at least one control valve which may control a flow rate of the air or heated air flowing in the proximal and/or distal air paths, and the like. The blanket module may define at least one upper shell and at least one lower shell, where at least one of the air paths may be defined between the upper and lower shells, where at least one of the air paths may be bound by only one of the upper and lower shells, and so on. The distal path and/or at least a portion of the proximal path distal to the heating member may also be made of and/or include at least one heat-resistant material. The distal air path may be incorporated across or in at least a preset portion of the blanket module in a parallel, horizontal, transverse, and/or a hybrid arrangement. The blanket module may define multiple segments in each of which at least one distal air path may be incorporated and at least one of which may be fluidly coupled to at least another thereof. The distal air path may further include a movable cap which may open and close fluid communication therethrough.

Such a heating member may be any conventional heaters for heating air, gases, fluids, and so on. The system may also include at least one heat exchange member as described in the co-pending Applications and improve an efficiency of heat exchange between the air and heating member. The heating member may also include any conventional heat control mechanisms which may incorporate various materials defining positive or negative temperature coefficients. The heating member may be disposed in the main module. At least a portion of the heating member may be disposed in or close to the blanket module. The heating member may be electrically and/or magnetically shielded as described in the co-pending Applications. At least a portion of the heating member may also be made of and/or include at least one flexible or deformable material capable of generating the heat as electric current flows therein. The heating member may include at least one rigid material capable of generating such heat as electric current flows therein.

The actuator member may be any conventional pumps of transporting air, gases, and/or fluids. The actuator member may be disposed in the main module, disposed proximal or distal to the heating member, and the like. The actuator member may be arranged to move the air through at least one of the above air paths in only one of forward and retrograde directions. The actuator member may also be arranged to move the air through at least one of the air paths in both of the forward and retrograde directions. The system may also include at least one chamber which may be arranged to enclose at least a substantial portion of the actuator member and to absorb acoustic waves or noises generated by the actuator member. Such an actuator member may be electrically and/or magnetically shielded as described in the co-pending Applications.

The actuator and heating members which are major sources of electromagnetic waves may be disposed away from the blanket module such that intensities of the waves measured at a distance from the surface of the blanket module defining the target space may be less than a preset limit. Such a preset limit may be 0.1 mG, 0.2 mG, 0.3 mG, 0.5 mG, 0.7 mG, 1 mG, 2 mG, 3 mG, 4 mG, 5 mG, 7 mG, 10 mG, and the like, while the preset distance may be 0.1 cm, 0.2 cm, 0.5 cm, 1 cm, 2 cm, 3 cm, 5 cm, 7 cm, 10 cm, 15 cm, 20 cm, 25 cm, 30 cm, and the like.

The thermal insulator may be a layer of material with low thermal conductivity, a layer of air, a layer of a gas with low thermal conductivity, a layer of vacuum, and the like. The preset temperature may be about 40° C., 45° C., 50° C., 55° C., 60° C., 65° C., 70° C., and the like. The source may be ambient air, a water storage, an oxygen storage, and the like. The evaporation member may be disposed in at least one of the proximal and distal air paths, disposed proximal or distal to the heating member, and so on. The evaporation member may be provided as a replaceable article, refillable article, disposable article, and the like. The agent may be water, oxygen, pharmaceutical agent, herbal agent, and the like.

The system may include a control member which may control an amount of electrical energy provided to the actuator and/or heating members, a flow rate of the air and/or heated air flowing in the proximal and/or distal air paths, a temperature of the heated air, and the like. The conduit member may include a first set of the distal paths for convection heat transfer and a second set of the distal paths for conduction heat transfer, and may include at least one control member which may manipulate flow rates of the heated air in the first and second sets of the distal paths. The system may also include at least one control valve which may operatively couple with the control member and may be arranged to control configurations of a network of the proximal and/or distal air paths by fluidly coupling and/or by blocking at least one of the proximal and/or distal air paths, to recruit different segments of the blanket module, and the like. At least two of the segments may include the distal air paths which are arranged in different patterns, extending in different lengths, fluidly connected in different patterns, transferring the heat in different mechanisms, and the like. At least one of the segments may also be deformable or bendable therealong. The blanket module may be deformed and/or bent between the segments. At least two of such segments may be disposed vertically (or one over the other) or horizontally (or side by side).

In another aspect of the present invention, a method may also be provided for heating a target space which may be defined under at least a portion of a blanket module of an electric blanket system while minimizing propagation of electromagnetic waves emitted by the system to the target space.

In one exemplary embodiment of this aspect of the invention, a method may include the steps of: taking in and heating air using electrical energy away from the blanket module while emitting such waves; and supplying the heated air directly into the target space through the blanket module, thereby heating the target space by forced convection while minimizing the propagation of the waves toward the target space.

In another exemplary embodiment of such an aspect of the invention, a method may include the steps of: taking in and heating air using electrical energy away from the blanket module while emitting the waves; and circulating the heated air around the blanket module, thereby transferring heat to the target space by conduction while minimizing the propagation of the waves toward the target space.

In another exemplary embodiment of such an aspect of the invention, a method may include the the waves but while minimizing the propagation of the waves toward the target space; supplying the heated air directly into the target space through the blanket module, thereby heating the target space by forced convection; circulating such heated air around the blanket module and transferring heat by conduction onto the target space; and controlling amounts of the air participating in the convection and conduction depending upon at least one of an user setting and an user command.

In another exemplary embodiment of such an aspect of the invention, a method may include the steps of: incorporating a blanket module, an actuator member, and a heating member into the system; taking in air by the actuator member using electrical energy while emitting such waves; heating the air by the heating member using electrical energy while emitting the waves; and supplying the heated air directly into the target space while disposing such members away from the blanket module, thereby minimizing the propagation of the waves to the target space. The above supplying may be replaced by the step of: positioning such members away from the blanket module until intensities of the waves decrease below a preset limit when measured at a preset distance from the blanket module inside the target space while supplying the heated air directly into the target space. The above supplying may also be replaced by the step of: circulating the heated air around the target space while transferring heat of the heated air to the target space and disposing the members away from the blanket module, thereby minimizing the propagation of the waves to the target space. The above supplying may also be replaced by the step of: positioning such members away from the blanket module until intensities of such waves may decrease below a preset limit when measured at a preset distance from the blanket module in the target space while circulating such heated air around the target space and transferring heat of the heated air onto the target space.

In another exemplary embodiment of such an aspect of the invention, a method may include the steps of: incorporating a blanket module, an actuator member, and a heating member into the system; forming at least one air path inside (or on) the blanket module; coupling such members with the blanket module by a coupling member; stretching the coupling member to dispose the members away from the blanket module; taking in air by the actuator member using electrical energy while emitting the waves; heating the air by the heating member using electrical energy while emitting the waves; and supplying the heated air through the air path into the target space while disposing all of the members away from the blanket module, thereby minimizing the propagation of such waves toward the target space. The above supplying may be replaced by the step of: supplying such heated air through the air path of the blanket module and heating the target space by transferring heat from the air path to the target space while minimizing the propagation of the waves toward the target space. The above supplying may be replaced by the step of: positioning the members away from the blanket module until intensities of the waves may be decreased below a preset limit when measured at a preset distance from the blanket module inside the target space while supplying the heated air into the target space.

In another aspect of the present invention, a method may also be provided for heating a target space which is defined under at least a portion of a blanket module of an electric blanket system by forced convection.

In one exemplary embodiment of this aspect of the invention, a method may include the steps of: taking in air using electrical energy; generating heat using electrical energy; transferring such heat onto the air, thereby generating heated air; and supplying the heated air into the target space, thereby heating the target space not directly by the heat but by the heated air.

In another exemplary embodiment of such an aspect of the invention, a method may include the steps of: defining the target space under only one surface of the blanket module; forming at least one air path inside (or on) the surface of the blanket module; taking in and heating air by electrical energy; and supplying the heated air directly into the target space through the air path, thereby heating such a target space.

In another exemplary embodiment of such an aspect of the invention, a method may include the steps of: forming at least one air path inside (or on) the blanket module; taking in and heating air using electrical energy away from the blanket module; and supplying the heated air directly into the target space through the air path, thereby heating the target space without having to performing the heating in the blanket module.

In another exemplary embodiment of such an aspect of the invention, such a method may have the steps of: taking in and heating-air using electrical energy to generate heated air, supplying a preset amount of the heated air into such a target space, thereby heating the target space by the convection; and controlling the amount of the heated air supplied into the target space depending upon at least one of an user setting and an user command.

In another exemplary embodiment of such an aspect of the invention, a method may include the steps of: taking in air by electrical energy while emitting electromagnetic waves; generating heat using electrical energy while emitting such waves; and supplying the heated air into the target space while performing the taking and generating away from the blanket module, thereby heating the target space by the heated air while minimizing propagation of the waves toward the target space.

In another exemplary embodiment of such an aspect of the invention, a method may include the steps of taking in air containing moisture and/or oxygen with electrical energy; heating the air with the moisture and/or oxygen using electrical energy, thereby generating the heated air; and supplying such heated air directly into the target space and then heating the target space thereby while supplying the moisture and/or oxygen along therewith.

In another exemplary embodiment of such an aspect of the invention, a method may include the steps of: taking in and heating air containing moisture and/or oxygen therein in a first concentration by electrical energy; supplying the heated air directly into the target space and heating the target space thereby while supplying such moisture and/or oxygen along with such heated air; monitoring a second concentration of such moisture and/or oxygen in the target space; and taking in and supplying another air containing such moisture and oxygen in a third concentration with electrical energy when it may be necessary to keep the second concentration at a preset level.

In another exemplary embodiment of such an aspect of the invention, a method may include the steps of: taking in air with electrical energy; heating the air with electrical energy; evaporating at least one agent into the air before, during, and/or after the heating; and supplying the heated air directly into the target space and heating the target space thereby while supplying the agent therewith.

In another exemplary embodiment of such an aspect of the invention, a method may include the steps of: taking in and heating air using electrical energy; providing multiple openings through only one surface of the blanket module; and supplying the heated air directly into the target space through such openings of the surface of the blanket module while preventing such heated air from flowing through another surface of the blanket module, thereby heating the target space with the heated air at a higher efficiency.

In another aspect of the present invention, a method may also be provided for heating a target space defined under at least a portion of a blanket module of an electric blanket system by convection and convection.

In one exemplary embodiment of this aspect of the invention, a method may include the steps of: taking in and heating air using electrical energy, thereby generating heated air; supplying at least a first portion of the heated air into such a target space for the convection; supplying at least a second portion of the heated air around but not into the target space for the conduction; and then controlling amounts of the heated air for such convection and conduction according to an user setting, an user command, and the like.

In another exemplary embodiment of such an aspect of the invention, a method may include the steps of: taking in and heating air using electrical energy, thereby generating heated air; supplying at least a substantial portion of the above heated air directly into the target space during an initial heating operation; and then supplying at least a portion of such heated air around but not into the target space thereafter.

In another exemplary embodiment of such an aspect of the invention, a method may include the steps of: defining the target space under only one surface of the blanket module; taking in and heating air using electrical energy and generating heated air; supplying a first portion of the heated air through a first air path into the target space; circulating a second portion of such heated air around but not into the target space through a second air path which may be disposed closer to (or farther away from) the first air path; and controlling amounts of the air flowing in the first and second air paths depending on an user setting, an user command, and the like.

In another exemplary embodiment of such an aspect of the invention, a method may include the steps of: defining the target space under only one surface of the blanket module; forming at least one first air path at a first preset distance from such a surface; forming at least one second air path at a second preset distance from the surface, where the second distance is greater (or smaller) than the first distance; fluidly coupling the first but not the second air path with the target space; supplying at least a first portion of the heated air through the first air path and then into the target space; circulating at least a second portion of the heated air through the second air path around but not into the target space; and controlling amounts of the air flowing in the first and second air paths depending upon an user setting, an user command, and the like, thereby controlling amounts of the heated air recruited in the convection and conduction accordingly.

In another exemplary embodiment of such an aspect of the invention, a method may include the steps of: taking in and heating air using electrical energy, thereby generating first heated air heated to a first temperature and second air heated to a higher (or lower) second temperature; supplying such first heated air into the target space; circulating such second heated air around but not into the target space; and controlling amounts of the first and second heated air depending upon an user setting, an user command, and the like.

In another exemplary embodiment of such an aspect of the invention, a method may include the steps of: taking in and heating air away from the blanket module using electrical energy while emitting electromagnetic waves; supplying a first portion of such heated air into the target space; circulating a second portion of the heated air around or but not into the target space, whereby the system may be capable of heating the target space by such portions of the heated air while minimizing propagation of the waves toward the target space.

In another aspect of the present invention, a method may also be provided for heating a target space which may be defined under at least a portion of a blanket module of an electric blanket system while preventing overheating of the blanket module.

In one exemplary embodiment of this aspect of the invention, a method may include the steps of: taking in air using electrical energy; generating heat using electrical energy away from the blanket module; heating the air by the heat away from the blanket module; and supplying the heated air to the blanket module, thereby heating the target space by convection of the heated air into the target space and/or conduction from such heated air to the target space while preventing the blanket module from being overheated due to the generating.

In another exemplary embodiment of such an aspect of the invention, a method may include the steps of: taking in and heating air by electrical energy, thereby generating heated air; providing at least one air path from a member for the heating to the blanket module; and supplying such a blanket module with the heated air through the air path, thereby heating the target space by convection of the heated air into the target space and/or conduction from the heated air to the target space while protecting the blanket module from any damages of the member.

In another exemplary embodiment of such an aspect of the invention, a method may include the steps of: taking in and heating air with electrical energy and generating heated air; disposing members for such taking in and heating away from the blanket module; and then supplying the heated air to the blanket module, thereby heating the target space by convection of the heated air into the target space and/or conduction from such heated air to the target space while preventing the blanket module from being overheated due to an overflow of the electrical energy.

In another exemplary embodiment of such an aspect of the invention, a method may include the steps of: taking in air using electrical energy; heating the air with electrical energy, thereby generating heated air which may be heated only up to a preset temperature which does not ignite or scorch any portion of the blanket module; and supplying such heated air to the blanket module, thereby heating the target space by at least one of convection of the heated air into the target space and conduction from the heated air to the target space while preventing the overheating of the blanket module.

In another exemplary embodiment of such an aspect of the invention, a method may include the steps of: taking in and heating air using electrical energy, thereby generating heated air; supplying the heated air to the blanket module; monitoring a temperature of the heated air in a preset location of the blanket module; and supplying the heated air to the blanket module, thereby heating the target space by convection of the heated air into the target space and/or conduction by the heated air to the target space while preventing the overheating of the blanket module.

In another exemplary embodiment of such an aspect of the invention, a method may include the steps of: forming at least one air path inside (or on) the blanket module; taking in and heating the air by electrical energy away from the blanket module, thereby generating heated air away from the blanket module; supplying the heated air to the blanket module; and heating the target space by convection of the heated air into the target space and/or conduction by such heated air to the target space, thereby preventing the overheating of the blanket module even when at least a portion of the blanket module is folded at any angle.

In another exemplary embodiment of such an aspect of the invention, a method may include the steps of: forming at least one deformable air path in or on the blanket module; taking in and heating air using electrical energy away from the blanket module, thereby generating heated air away from such a blanket module; supplying the heated air to the blanket module, thereby heating the target space by convection of the heated air into the target space and/or conduction from the heated air to the target space; and folding the blanket module while obstructing the supplying the heated air thereto according to an extent of the folding, thereby preventing the overheating of the blanket module.

In another aspect of the present invention, a method may also be provided for heating a target space which may be defined under at least a portion of a blanket module of an electric blanket system while controlling conditions in the target space.

In one exemplary embodiment of this aspect of the invention, a method may include the steps of: taking in ambient air using electrical energy; heating the air by electrical energy, thereby generating heated air; and supplying such heated air directly into the target space while providing moisture and/or oxygen contained in the ambient air to the target space.

In another exemplary embodiment of such an aspect of the invention, a method may include the steps of: taking in air using electrical energy; heating the air with electrical energy, thereby generating heated air; evaporating moisture into the air and/or heated air; and supplying the heated air with such moisture directly into the target space, thereby controlling humidity inside the target space at a preset level. The above evaporating and supplying may be replaced by the steps of: adding oxygen into the air and/or heated air; and supplying the heated air including the oxygen directly into the target space, thereby controlling a concentration of oxygen in the target space at a preset level as well. The above evaporating and supplying may be replaced by the steps of: evaporating at least one agent into the air and/or heated air, and supplying such heated air with the agent directly into the target space, thereby maintaining a concentration of the agent inside the target space at a preset level.

In another exemplary embodiment of such an aspect of the invention, a method may include the steps of: taking in air using electrical energy; heating the air with electrical energy, thereby generating heated air; and supplying the heated air directly into the target space while displacing stale air which may be accumulated in the target space.

In another exemplary embodiment of such an aspect of the invention, a method may include the steps of: providing multiple air paths in (or along) such a blanket module; taking in and heating air using electrical energy, thereby generating heated air; and supplying such heated air into the target space through one of the air paths while sucking in stale air accumulated in the target space through another of the air paths.

In another aspect of the present invention, a method may further be provided for improving an efficiency of heat transfer in heating a target space which may be defined under at least a portion of a blanket module of an electric blanket system.

In one exemplary embodiment of this aspect of the invention, a method may include the steps of: defining the target space under one surface of the blanket module; insulating at least a portion of another surface of such a module; taking in and heating air with electrical energy, thereby generating heated air; supplying the heated air to the target space; and heating the target space by convection of the heated air into the target space and/or conduction from the heated air to such a target space while minimizing heat transfer through such another surface of the blanket module, thereby increasing the efficiency of the heat transfer.

In another exemplary embodiment of such an aspect of the invention, a method may include the steps of: defining the target space under one surface of the blanket module; taking in and heating air using electrical energy, thereby generating heated air; supplying such heated air to the surface of the blanket module while minimizing a flow of the heated air to another surface of the blanket module; and heating the target space through convection of the heated air into the target space and/or conduction by the heated air to the target space while maximizing the efficiency of the heat transfer.

In another exemplary embodiment of such an aspect of the invention, a method may include the steps of: defining the target space under one surface of the blanket module; taking in and heating air using electrical energy, thereby generating heated air; supplying the heated air toward the surface of the blanket module; and heating the target space through convection of such heated air into the target space and/or conduction from the heated air to the surface of the blanket module, thereby minimizing a loss of heat for heating another surface of the blanket module.

In another exemplary embodiment of such an aspect of the invention, a method may include the steps of taking in and heating ambient air using electrical energy and generating heated air; supplying such heated air directly into the target space, thereby heating the target space by forced convection; taking in and heating another air in the target space with electrical energy, thereby generating another heated air while recouping heat contained in such another air; and supplying such another heated air into the target space, thereby increasing the efficiency of the heat transfer.

In another aspect of the present invention, a method may also be provided for heating a target space which may be defined under at least a portion of a blanket module of an electric blanket system while controlling a temperature of the blanket module.

In one exemplary embodiment of this aspect of the invention, a method may have the steps of: taking in and heating air up to a preset temperature using electrical energy, thereby generating heated air; and supplying the heated air to the blanket module, thereby heating the target space by convection of the heated air into the target space and/or conduction from the heated air to the target space while keeping a temperature of the target space below the preset temperature of the heated air.

In another exemplary embodiment of such an aspect of the invention, a method may include the steps of: taking in and heating air using electrical energy, thereby generating heated air; monitoring a temperature of a preset location of the blanket module; and then supplying the heated air to the blanket module only when such a temperature remains below a preset temperature, thereby heating the target space only up to such a temperature through convection of the heated air into the target space and/or conduction by the heated air to the target space.

In another exemplary embodiment of such an aspect of the invention, a method may include the steps of: taking in and heating air using electrical energy, thereby generating heated air; arranging at least a portion of the blanket module to be deformable and to define a hydraulic resistance depending upon an extent of deformation; supplying such heated air to the blanket module, thereby heating the target space by convection of the heated air into the target space and/or conduction by the heated air to the target space; and deforming the portion of the blanket module while controlling the resistance, a flow rate of the heated air, and a temperature of the portion of the blanket module during the supplying as well as the heating according to the extent of deformation.

In another exemplary embodiment of such an aspect of the invention, a method may include the steps of: taking in and heating air using electrical energy, thereby generating heated air; supplying the heated air to the blanket module, thereby heating the target space by convection of the heated air into the target space and/or conduction by the heated air to the target space; and controlling a temperature in the target space by manipulating at least one of the taking in and heating.

In another exemplary embodiment of such an aspect of the invention, a method may include the steps of: forming multiple air paths which have different configurations; taking in and heating air using electrical energy, thereby generating heated air; supplying the heated air to the blanket module through the air paths, thereby heating the target space by convection of such heated air into the target space and/or conduction by the heated air to the target space; and then varying flow rates of the heated air through the air paths, thereby controlling a temperature in the target space.

In another exemplary embodiment of such an aspect of the invention, a method may include the steps of: forming multiple air paths which have different configurations; taking in and heating air using electrical energy, thereby generating heated air; supplying the heated air to the blanket module through the air paths, thereby heating the target space by convection of such heated air into the target space through at least one of the air paths and/or conduction from the heated air to the target space through at least another of the air paths; and varying flow rates of the heated air through the above air paths, thereby controlling a temperature in the target space.

In another aspect of the present invention, a method may be provided for minimizing a weight (and/or size) of a blanket module of an electric blanket system for heating a target space which may be defined under at least a portion of the blanket module.

In one exemplary embodiment of this aspect of the invention, a method may include the steps of: taking in and heating air with electrical energy, thereby generating heated air; supplying the heated air to the blanket module, thereby heating the target space through convection of such heated air into the target space and/or conduction from such heated air to the target space; and disposing members capable of the taking in and the heating away from the blanket module, thereby minimizing the weight of the blanket module.

In another exemplary embodiment of such an aspect of the invention, a method may include the steps of: taking in and heating air with electrical energy and generating heated air; disposing members for the taking in and heating away from the blanket module; forming at least one air path for the heated air in the blanket module, thereby minimizing the weight of the blanket module; and then supplying such heated air to the blanket module, thereby heating the target space by convection of the heated air into the target space and/or conduction from the heated air to the target space.

In another exemplary embodiment of such an aspect of the invention, a method may include the steps of: forming multiple air paths which may fluidly couple to each other across the blanket module; arranging at least one of the air paths to be detachable from the rest thereof; taking in and heating air using electrical energy and generating heated air; detaching the detachable air path, thereby forming the blanket module with a desired shape and a minimized weight; and supplying the heated air to the blanket module, thereby heating the target space by convection of the heated air into the target space and/or conduction from the heated air to the target space.

In another aspect of the present invention, a method may be provided for manipulating a shape and/or size of a blanket module of an electric blanket system for heating a target space which may be defined under at least a portion of the blanket module.

In one exemplary embodiment of this aspect of the invention, a method may include the steps of: providing multiple segments each having at least one air path; forming the blanket module by fluidly coupling the segments into the shape and size; taking in and heating air with electrical energy, thereby generating heated air; and supplying such heated air to such segments of the blanket module, thereby heating the target space by convection of the heated air into the target space and/or conduction from the heated air to the target space.

In another exemplary embodiment of such an aspect of the invention, a method may include the steps of: forming multiple air paths in the blanket module; defining in such a blanket module at least one detachable segment including therein at least one of the air paths; detaching the detachable segment from the blanket module when desirable, thereby varying the shape and/or size of the blanket module; and supplying the heated air to the blanket module, thereby heating the target space by convection of the heated air into the target space and/or conduction from the heated air to the target space.

In another exemplary embodiment of such an aspect of the invention, a method may include the steps of: providing multiple segments each including at least one air path; assembling at least two of the segments, thereby forming the blanket module defining the shape and size; taking in and heating air using electrical energy, thereby generating heated air; and supplying the heated air to such at least two of the segments of the blanket module, thereby heating such a target space through convection of the heated air into the target space and/or conduction from the heated air to the target space.

In another exemplary embodiment of such an aspect of the invention, a method may include the steps of: providing multiple segments each including at least one air path; assembling at least two of the segments, thereby forming the blanket module defining the shape and size; detaching one of such at least two of the segments, thereby varying the shape and size of the blanket module; taking in and heating air using electrical energy, thereby generating heated air; and supplying such heated air to the blanket module, thereby heating the target space by convection of the heated air into the target space and/or conduction from the heated air to the target space. The detaching may be replaced by the step of: attaching one of the segments onto such at least two of the segments, thereby varying the shape and size of the blanket module;

In another aspect of the present invention, a method may be provided for fabricating a blanket module of an electric blanket system.

In one exemplary embodiment of this aspect of the invention, a method may include the steps of: forming at least one air path with an outer wall and a lumen in (or on) the blanket module; taking in and heating air using electrical energy, thereby generating heated air; and supplying the heated air to the blanket module through the air path while heating the target space by conduction from the heated air to the target space.

In another exemplary embodiment of such an aspect of the invention, a method may include the steps of: forming at least one air path which may define at least one porous structure and at least one pore therethrough in or on the blanket module; disposing at least one barrier between the target space and the porous structure; taking in and heating air by electrical energy, thereby generating heated air; and supplying the heated air to the blanket module through the air path while heating the target space by conduction from the heated air to the target space.

In another exemplary embodiment of such an aspect of the invention, a method may include the steps of: forming at least one air path defining an outer wall and a lumen in (or on) the blanket module; fluidly coupling the lumen with the target space; taking in and heating air by electrical energy, thereby generating heated air; and supplying the heated air directly into the target space through the lumen of the air path and through the blanket module, thereby heating the target space by convection.

In another exemplary embodiment of such an aspect of the invention, a method may include the steps of: forming at least one air path which may define at least one porous structure and at least one pore therethrough in (or on) the blanket module; fluidly coupling the pore with the target space; taking in and heating air using electrical energy, thereby generating heated air; and supplying such heated air directly into the target space through the pore of the air path and through the blanket module, thereby heating the target space by convection.

Embodiments of the above methods aspects of the present invention may include one or more of the following features.

The taking may include the step of: taking in ambient air while filtering out particles therefrom. The heating may include the steps of: heating different air streams up to different temperatures; and supplying the air streams to the blanket module, thereby heating different portions of the target space to such temperatures and/or heating the target space to the temperatures based on a preset temporal sequence. The heating may also include the steps of: providing heat to an at least partially enclosed chamber; and transferring at least a portion of the heat to the air. The heating may include the step of: performing the heating the air before, during, and/or after the taking. The generating may include at least one of the steps of: heating the temperature to a preset temperature; flowing one of the air and heated air at a preset flow rate, and the like.

The supplying may include at least one of the steps of: moving the air through an inner lumen of at least one air path while at least substantially preventing the air from penetrating an outer wall of the air path; forming at least one opening along the air path, thereby allowing the air to move along the lumen as well as through the opening; forming a porous structure which may define at least one pore, thereby allowing the air to move through the pore, and the like. The supplying may include at least one of the steps of: supplying such heated air to the blanket module in different flow rates, flowing multiple streams of the heated air heated up to different temperatures, providing the heated air to different air paths, and the like. The supplying may include the steps of: taking in at least a portion of such heated air from the target space; moving such taken heated air to the actuator and/or heating members; and combining such taken heated air with the air taken in by the actuator member, thereby improving an efficiency of heat transfer. The supplying may include one of the steps of: moving the air through the air path only along one direction; and moving the air through the air path in both directions.

The minimizing may include the step of: diminishing intensities of the waves impinging on such a target space by increasing a distance between the target space and a source of the waves. The minimizing may also include at least one of the steps of: disposing along the conduit member at least one magnetic shield capable of at least partially shielding magnetic waves of such electromagnetic waves; and disposing along the conduit member at least one electric shield capable of at least partially shielding electric waves of the electromagnetic waves.

The circulating may include the step of: allowing the heated air to flow through such a blanket module for at least a preset length, thereby improving an efficiency of heat transfer. The transferring may include the step of: moving such heated air through at least one air path defining a relatively high thermal conductivity, thereby facilitating the conduction from the heated air to the target space. Such controlling may be replaced by one of the steps of: controlling temperatures of the air participating in the convection and conduction based upon the user setting and/or command; varying a configuration of the air path depending upon the user setting and/or command, and the like.

The incorporating may include at least one of the steps of: detachably coupling at least one of the members to at least another of the members; fixedly coupling such one of the members to such another of the members, detachably coupling each of at least two of the members to at least another of the rest of the members one at a time, and the like. The incorporating may include one of the steps of: disposing the heating member close to the actuator member; enclosing at least substantial portions of the actuator and heating members in a chamber, and so on. The positioning may include one of the steps of disposing only a portion of the actuator and/or heating members in an interior and/or an edge of the blanket module; disposing at least a portion of at least one of the members by a preset distance while maintaining a mechanical coupling and/or a fluid coupling between the blanket module and such at least one of the members.

The forming may include at least one of the steps of: defining an inner lumen and a solid outer wall in the air path; defining the inner lumen and a porous outer wall which may fluidly couple with the target space; providing a porous structure defining multiple pores while defining the air path along the pores; defining at least a portion of the air path by an inner surface of the blanket module, and the like. The forming may include the steps of: defining multiple air paths; and fluidly bifurcating at least two of the air paths. The forming may include at least one of the steps of: including at least one deformable material along the air path; incorporating at least one flexible material therealong; including at least one rigid material therealong, arranging at least a portion of the air path to bend, and the like. The forming may also include at least one of the steps of: disposing multiple air paths at least partially horizontally, vertically, at a preset angle, and/or transversely; disposing multiple air paths in different depths from the surface of the blanket module; vertically stacking at least one of the air paths over at least another thereof, and so on. The forming may include one of the steps of: forming at least one air path through which the air may flow only in a forward direction; forming at least one air path through which the air may flow only in a retrograde direction; and forming at least one air path through which the air may flow in both of the directions.

The supplying the agent may include at least one of the steps of: evaporating the agent into the air and/or heated air; injecting the agent thereinto; flowing the air and/or heated air through a porous bed including (or impregnated with) the agent, and the like. The evaporating may include the steps of: storing the agent; and adding the agent into such air and/or heated air as a vapor, a spray, a particle, and the like. The providing the air path may include the step of: providing multiple air paths at least two of which may have different lengths while allowing an user to select one of such air paths defining a desired length; and arranging the air path to change a length thereof.

Such monitoring may include at least one of the steps of: measuring the temperature of the air distal to the heating; and measuring the temperature of the heating. The monitoring such temperature may also be replaced by the step of: monitoring a temperature of the target space, such one surface of the blanket module, a surface of the blanket module, an interior of the blanket module, and the like. The sucking may include the steps of: taking in the stale air in the target space through at least one air path; and discharging the stale air out of the target space. The insulating may include at least one of the steps of: disposing at least one thermal insulator over at least a portion of such another surface; forming vacuum in the portion of such another surface; disposing air bubbles in the portion of such another surface, and the like. The deforming may include the steps of: forming at least one indentation along the portion of the blanket module; and folding (or bending) the portion along the indentation. The varying may include at least one of the steps of: manipulating a driving pressure gradient for the flow rate at a proximal portion of the air path; varying hydraulic resistance of a distal portion of the air path, and the like.

In another aspect of the present invention, an electric blanket system may also be provided for minimizing emission of electromagnetic waves toward a target space.

In one exemplary embodiment of this aspect of the present invention, a system may be made by a process including the steps of: providing at least one air path; incorporating only at least a portion of the air path along at least one blanket module; defining the target space under one surface of such a blanket module; providing at least one actuator member capable of moving air along the air path with electrical energy while irradiating the waves; providing at least one coupling module having a preset length; fluidly coupling the actuator member with such a portion of the air path by the coupling module; providing at least one heating member capable of generating heat with electrical energy while emitting the waves; operatively coupling the heating member with at least another portion of the air path which may be closer to the actuator member than the blanket module, thereby transferring the heat onto the air flowing in the another portion of the air path; arranging at least substantial portions of the actuator and heating members to be disposed away from such a blanket module during heating operation by a preset distance not exceeding the preset length of the coupling module, thereby decreasing intensities of the waves below a preset limit when measured in a preset distance from the surface in the target space.

In another exemplary embodiment of such an aspect of the present invention, a system may be made by a process including the steps of: providing at least one air path; incorporating only at least a portion of the air path along at least one blanket module; defining the target space under one surface of the blanket module; providing at least one actuator member capable of moving air along the air path using electrical energy while irradiating the waves; providing at least one heating member capable of generating heat using electrical energy while irradiating the waves; operatively coupling the heating member with at least another portion of the air path, thereby transferring the heat onto the air flowing in the another portion of the air path; disposing at least substantial portions of the actuator and heating members away from the blanket module; and providing the heat onto the target space by the heated air while minimizing the emission of the waves to the target space. Such providing may be replaced by the step of: supplying the heated air directly into the target space while minimizing the emission of the waves to the target space.

In another exemplary embodiment of such an aspect of the present invention, a system may be made by a process including the steps of: providing at least one conduit member including at least one proximal air path and at least one distal air path; fluidly coupling the distal air path with the proximal air path; including not the proximal air path but the distal air path into at least one blanket module; defining the target space under one surface of the blanket module; disposing at least a portion of the distal air path near the surface of the blanket module; providing at least one actuator member which is capable of moving air from the proximal air path to the distal air path using electrical energy while emitting the waves; providing at least one heating member capable of generating heat with electrical energy while irradiating such waves; operatively coupling the heating member with the proximal air path, thereby transferring the heat onto the air flowing in the proximal air path; and providing such heat to the target space by conduction of such heat from the distal air path to the target space, thereby minimizing the emission of the waves toward the target space.

In another exemplary embodiment of such an aspect of the present invention, a system may be made by a process including the steps of: providing at least one conduit member including at least one proximal air path and at least one distal air path; fluidly coupling the distal air path with the proximal air path; including not the proximal air path but the distal air path into at least one blanket module; forming in the distal air path multiple openings fluidly coupling with the target space; defining the target space under the blanket module; providing at least one actuator member capable of transporting air from the proximal air path to the distal air path and through the openings using electrical energy while emitting the waves; providing at least one heating member capable of generating heat using electrical energy while emitting the waves; operatively coupling the heating member with the proximal air path, thereby transferring the heat onto the air flowing in the proximal air path; and providing such heat to the target space by convection of the heated air flowing thereinto while minimizing the emission of the waves to the target space.

In another aspect of the present invention, a convective electric blanket system may also be provided for providing heated air into a target space.

In one exemplary embodiment of this aspect of the present invention, a system may be made by a process including the steps of: providing at least one conduit member with at least one proximal air path and distal air path; fluidly coupling the distal air path to the proximal air path; including not the proximal air path but the distal air path into at least one blanket module; defining the target space under the blanket module; fluidly coupling the distal air path with such a target space; providing at least one actuator member capable of transporting air from the proximal air path to the distal air path and into the target space using electrical energy while emitting the waves; providing at least one heating member capable of generating heat using electrical energy; operatively coupling the heating member with the proximal air path, thereby transferring the heat onto the air flowing in the proximal air path; and then providing the heat into the target space by directly supplying the heated air thereinto.

In another exemplary embodiment of such an aspect of the present invention, a system may be made by a process including the steps of: providing at least one air path; providing at least one blanket module with a top layer and a bottom layer; disposing at least one thermal insulator in such a top layer; forming the target space under the bottom layer; incorporating only at least a portion of the air path in the bottom layer; providing at least one actuator member capable of moving air from the air path to the target space using electrical energy; providing at least one heating member capable of generating heat using electrical energy; operatively coupling the heating member with at least another portion of the air path, thereby transferring the heat to the air flowing in the another portion of the air path; disposing at least substantial portions of such actuator and heating members away from the blanket module; and providing the heat to the target space by supplying the heated air thereinto while minimizing loss of the heat across the top layer of the blanket module.

In another exemplary embodiment of such an aspect of the present invention, a system may be made by a process including the steps of: providing at least one conduit member including at least one air inlet, at least one air path, and at least one air outlet fluidly coupling with each other sequentially; incorporating only at least a portion of the air path and the air outlet into the blanket module; defining the target space under the blanket module; fluidly coupling the air outlet to the target space; providing at least one actuator member capable of transporting air from the air path into the target space using electrical energy; providing at least one heating member capable of generating heat using electrical energy; operatively coupling the heating member with at least another portion of the air path, thereby transferring the heat onto the air flowing in such another portion of the air path; and providing the heat to the target space by supplying the heated air into the target space without having to heat the blanket module beforehand.

In another exemplary embodiment of such an aspect of the present invention, a system may be made by a process including the steps of: providing at least one air path; incorporating only at least a portion of the air path along at least one blanket module; forming the target space under the bottom layer; fluidly coupling the portion of the air path with the target space; providing at least one actuator member capable of moving air from the air path to the target space using electrical energy; providing at least one heating member capable of generating heat using electrical energy; operatively coupling the heating member with at least another portion of the air path, thereby transferring the heat onto the air flowing through such another portion of the air path; disposing at least substantial portions of the actuator and heating members away from the blanket module; and providing such heat to the target space by supplying the heated air thereinto while minimizing propagation of electromagnetic waves irradiated by the actuator and heating members toward the target space.

In another exemplary embodiment of such an aspect of the present invention, a system may be made by a process including the steps of: providing at least one conduit member including at least one air inlet, at least one air path, and at least one air outlet fluidly coupling with each other sequentially; fluidly coupling the air outlet with a source of moisture and/or oxygen; including only at least a portion of the air path and air outlet in the blanket module; forming the target space under the blanket module; fluidly coupling the air outlet with the target space; providing at least one actuator member capable of moving air including the moisture and/or oxygen from the air inlet through the air path to the air outlet and then into the target space using electrical energy; providing at least one heating member capable of generating heat using electrical energy; operatively coupling the heating member to at least another portion of the air path, thereby transferring the heat onto the air flowing in such another portion of the air path; and providing the heated air to the target space along with the moisture and/or oxygen.

In another exemplary embodiment of such an aspect of the present invention, a system may be made by a process including the steps of: providing at least one conduit member including at least one air inlet, at least one air path, and at least one air outlet fluidly coupling with each other sequentially; incorporating only at least a portion of the air path and the air outlet in the blanket module; forming the target space under the blanket module; fluidly coupling the air outlet with the target space; providing at least one heating member capable of generating heat using electrical energy; operatively coupling the heating member with at least another portion of the air path, thereby transferring the heat onto the air flowing in such another portion of the air path; and providing at least one actuator member capable of moving air from the air inlet through the air path to the air outlet using electrical energy while recycling at least a portion of the air flowing out of the air outlet into the air which receives the heat from the heating member, thereby improving an efficiency of generating the heated air.

More product-by-process claims may be constructed by modifying the foregoing preambles of the apparatus or system claims and by appending thereto the foregoing bodies of the method claims and/or modified bodies of the apparatus or system claims. In addition, the process claims may include one or more of the above features of the systems and/or methods aspects of the present invention.

As used herein, the term “target” refers to any person, living organism or object which is to be protected from various EM waves as will be defined in detail below. In one example, the “target” may be an user of an air heating system or, a.k.a., electric blanket system. In another example, the “target” may be a subject who may be sitting or standing within a preset distance from or around the system. In any of these examples, the “target” is subject to magnetic and electric waves irradiated by various wave sources of the system.

As used herein, the term “extrinsic electromagnetic waves” refer to those waves propagating in space toward a target space, while the term “device electromagnetic waves” denote those waves which are generated by an electric device and propagate toward the above target. Therefore, when a target is an user or a person draped under a blanket module and disposed in a target space defined under one surface of the blanket module, such “extrinsic EM waves” refer to those waves originating from a source away from an electric blanket system of this invention and propagating toward such a target and target space as well as those waves generated by such an electric blanket system itself. In contrary and in the above situation, such “device EM waves” refer to those waves originating from one or multiple wave sources of the electric blanket system, where examples of such sources may be its actuator member, heating member, and other wiring of the system.

The terms “magnetic fields” and “magnetic waves” within the scope of this invention refer to those which are associated with various electromagnetic waves. Therefore, such “magnetic fields” are accompanied by matching electric fields, while such “magnetic waves” are also accompanied by matching electric waves. Only exceptions are the static magnetic fields which are not accompanied by the electric fields, where examples of such static magnetic fields are those generated by the Earth, permanent magnet of the magnet member, and the like. It is appreciated for simplicity of illustration that the “magnetic waves” or “MWs” may collectively include the “magnetic fields” or “MFs” therein and that the “electric waves” or “EWs” may collectively include the “electric fields” or “EFs” therein within the scope of the present invention.

Contrary to most such co-pending Applications, the term “couple” refers to “physically couple” within the scope of this invention and, thus, is to be differentiated from magnetically and/or electrically couple multiple articles. Therefore, the terms “fixedly or movably couple” or similarly “couple” multiple articles refer to “fixedly or movably” and mechanically couple multiple articles with each other while changing alignments of longitudinal axes of such articles, changing distances therebetween, and the like.

The terms “proximal” and “distal” are typically employed to refer to relative locations of various members and units of a system with respect to an air inlet and an air outlet of an air path and/or with respect to a blanket module of such a system. For example, “proximal” generally means closer to the air inlet and/or away from the blanket module, while “distal” means closer to the air outlet and/or closer to, in or on the blanket module.

As used herein, the term “distance” is to be differentiated from the term “length” in the sense that the “distance” between two points of an object is to be measured along a straight path regardless of a detailed configuration of the object, whereas the “length” or “curvilinear length” is to be measured along an actual curvilinear configuration of such an object. Accordingly, the “distance” between two points disposed on opposing ends of an equator of a spherical object is a diameter of such a sphere, whereas the “length” between the points corresponds to one half of the equator of the same sphere. Similarly, the “distance” between an inlet and an outlet of an U-shaped air path is considerably smaller or less than the “length” of the air path from the inlet to the outlet. Such terms “distance” and “length” are also applicable to refer to a dimension between two different objects.

It is appreciated that a heating member of a system generate heat and that only a portion of the heat is transferred to air taken in by an actuator member of the system. Similarly, it is appreciated that the heat contained in the air heated by the heating member is transported to a blanket module of such a system and that only a portion of the heat contained in the heated air is transferred to a target space by either convection or conduction or by both convection and conduction. For simplicity of illustration, however, the “heat” generated by the heating member is deemed to be transferred to the air and such “heat” contained in the heated air is then deemed to be transferred to the target space, although only portions of such “heat” may be transferred in reality.

Unless otherwise defined in the following specification, all technical and scientific terms used herein have the same meaning as commonly understood by one of ordinary skill in the art to which the present invention belongs. Although the methods or materials equivalent or similar to those described herein can be used in the practice or in the testing of the present invention, the suitable methods and materials are described below. All publications, patent applications, patents, and/or other references mentioned herein are incorporated by reference in their entirety. In case of any conflict, the present specification, including definitions, will control. In addition, the materials, methods, and examples are illustrative only and not intended to be limiting.

Other features and advantages of the present invention will be apparent from the following detailed description, and from the claims.

### BRIEF DESCRIPTION OF THE DRAWING

FIG. 1A is a top (or bottom) view of an exemplary electric blanket system for transferring heat into a target space by convection according to the present invention;

FIG. 1B is a cross-sectional view of the electric blanket system shown in FIG. 1A according to the present invention;

FIG. 1C is a top (or bottom) view of an exemplary electric blanket system for transferring heat to a target space by conduction according to the present invention;

FIG. 1D is a cross-sectional view of the electric blanket system shown in FIG. 1C according to the present invention;

FIG. 1E is a top (or bottom) view of another exemplary electric blanket system for transferring heat into a target space by convection according to the present invention;

FIG. 1F is a cross-sectional view of the electric blanket system shown in FIG. 1E according to the present invention;

FIGS. 2A to 2X are schematic top (or bottom) views of exemplary blanket modules with one or more air paths disposed thereacross in various patterns according to the present invention;

FIGS. 3A to 3L are schematic top (or bottom) views of exemplary blanket modules with multiple segments defined in various patterns according to the present invention; and

FIGS. 4A to 4L are schematic cross-sectional views of exemplary blanket modules with active and passive air paths disposed in various patterns according to the present invention.

### DETAILED DESCRIPTION OF THE PREFERRED EMBODIMENTS

The present invention relates to various electric blanket systems capable of providing heat into a target space by convection and/or conduction of heated air. More particularly, the present invention relates to various electric blanket systems each including a blanket module, one or multiple air paths, an actuator member, and an heating member. The heating member generates heat and transfers such heat to air, while the actuator member takes in air, transports the air through the heating member, and moves heated air through the air paths. The blanket module incorporates such air paths and receives the heated air through the air paths in order to heat a target space defined under one surface thereof by thermal conduction from such heated air and/or by forced convection of the heated air. In general, such actuator and heating members are disposed away from the blanket module and the target space, thereby minimizing or substantially reducing intensities of electromagnetic waves which are irradiated by such members and propagate toward the target space. The convection and/or conduction electric blanket systems of this invention may be arranged to supply moisture, oxygen, and/or others such as medical, pharmaceutical, and/or herbal agents along with the heated air in order to create and maintain physiologically favorable conditions in the target space. The blanket modules of such electric blanket systems may include multiple segments which may have different configurations and/or heat transfer characteristics. Such electric blanket systems may also be arranged to supply ambient air or cooled air into the target space, thereby lowering and/or keeping temperature inside the target space below a body temperature.

The present invention also relates to various methods of reducing (or minimizing) intensities of electromagnetic waves which are generated by actuator and heating members of an electric blanket system and which propagate toward a target space formed under one surface of a blanket module of such a system by disposing the members as far away from the blanket module. The present invention also relates to various methods of transferring heat generated by the heating member onto or into the target space through conduction or convection of heated air through the blanket module respectively, various methods of preventing overheating of the blanket module by regulating a temperature of such heated air below a preset level, and various methods of improving a heat transfer efficiency of such a blanket module by supplying the heated air directly into the target space. The present invention also relates to various methods of not disposing the heating member in the blanket module to prevent arcing or fire in the blanket module caused by short circuit, various methods of disposing various air paths in the blanket module but none or only a minimum amount of the heating element and/or metal conductors therein so as to minimize a weight of the blanket module, and various methods of maintaining a normal operation of the blanket module despite mechanical damages inflicted thereon. The present invention also relates to various methods of providing moisture and/or oxygen into the target space along with the heated air, various methods of maintaining a relative humidity and/or an oxygen concentration in the target space, and various methods of delivering medical, pharmaceutical, and/or herbal agents into the target space along with the heated air.

The present invention further relates to processes for forming various electric blanket systems capable of providing the heat into a target space through convection and/or conduction of heated air. More particularly, the present invention relates to processes for providing an electric blanket system with a blanket module, one or multiple air paths, an actuator member, and an heating member, where the heating member generates heat and transfers such heat to air, while the actuator member takes in air, transports the air through the heating member, and moves heated air through the air paths. Such a blanket module incorporates the air paths and receives the heated air through the air paths in order to heat a target space defined under one surface thereof by conduction and/or convection from such heated air. The present invention further relates to processes for providing an electric blanket system including the blanket module disposed away from the actuator and/or heating members to minimize or at least substantially reduce intensities of electromagnetic emitted by such members and propagating toward the target space. The present invention further relates to processes for providing convection and/or conduction electric blanket systems capable of supplying moisture, oxygen, and/or others such as medical, pharmaceutical, and/or herbal agents along with the heated air so as to form and maintain physiologically favorable conditions inside the target space, various processes for forming an blanket module with multiple segments which may have different configurations, heat transfer characteristics, and so on. The present invention further relates to processes for providing an electric blanket system capable of supplying ambient air or cooled air into the target space and lowering temperature in such a target space below a body temperature.

Various aspects and/or embodiments of various systems, methods, and/or processes of this invention will now be described more particularly with reference to the accompanying drawings and text, where such aspects and/or embodiments thereof only represent different forms. Such systems, methods, and/or processes of this invention, however, may also be embodied in many other different forms and, accordingly, should not be limited to such aspects and/or embodiments which are set forth herein. Rather, various exemplary aspects and/or embodiments described herein are provided so that this disclosure will be thorough and complete, and fully convey the scope of the present invention to one of ordinary skill in the relevant art.

Unless otherwise specified, it is to be understood that various members, units, elements, and parts of various systems of the present invention are not typically drawn to scales and/or proportions for ease of illustration. It is also to be understood that such members, units, elements, and/or parts of various systems of this invention designated by the same numerals may typically represent the same, similar, and/or functionally equivalent members, units, elements, and/or parts thereof, respectively.

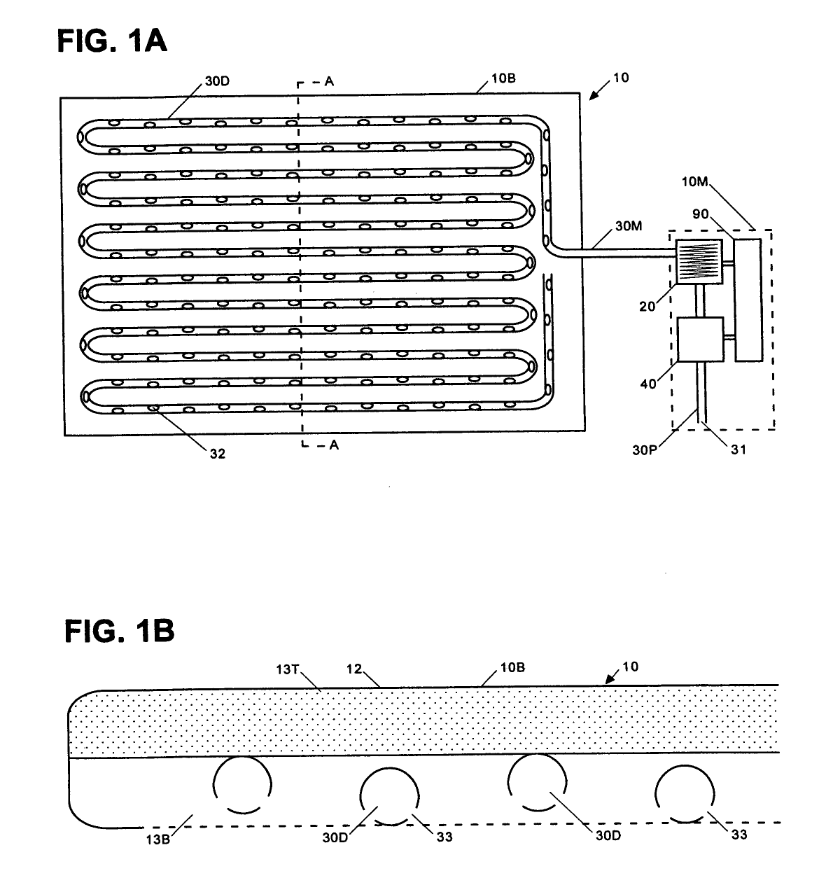

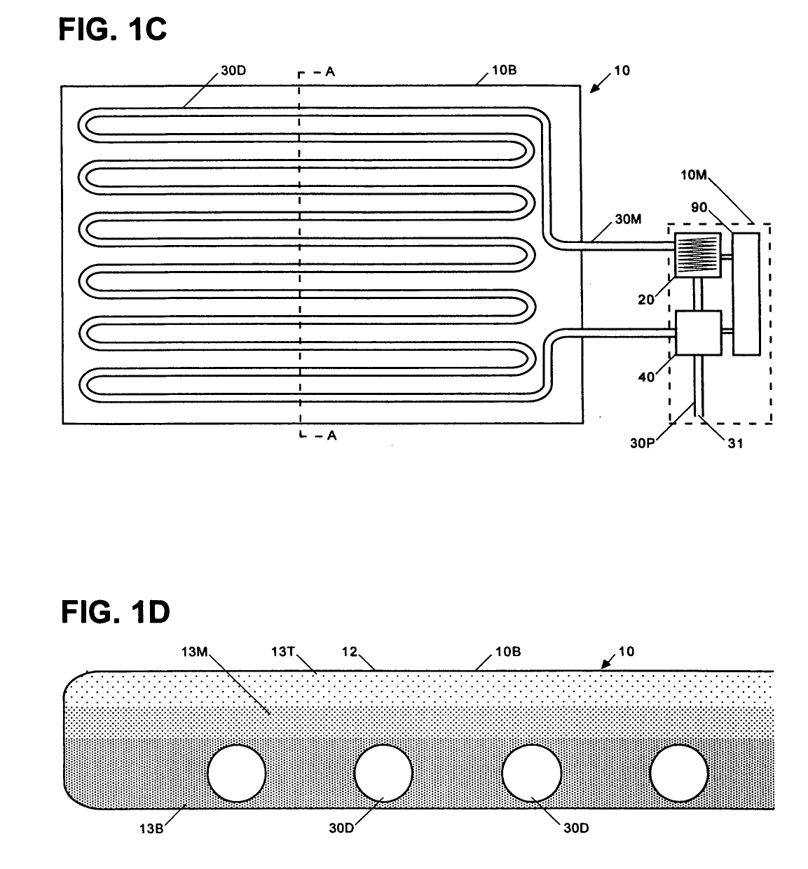

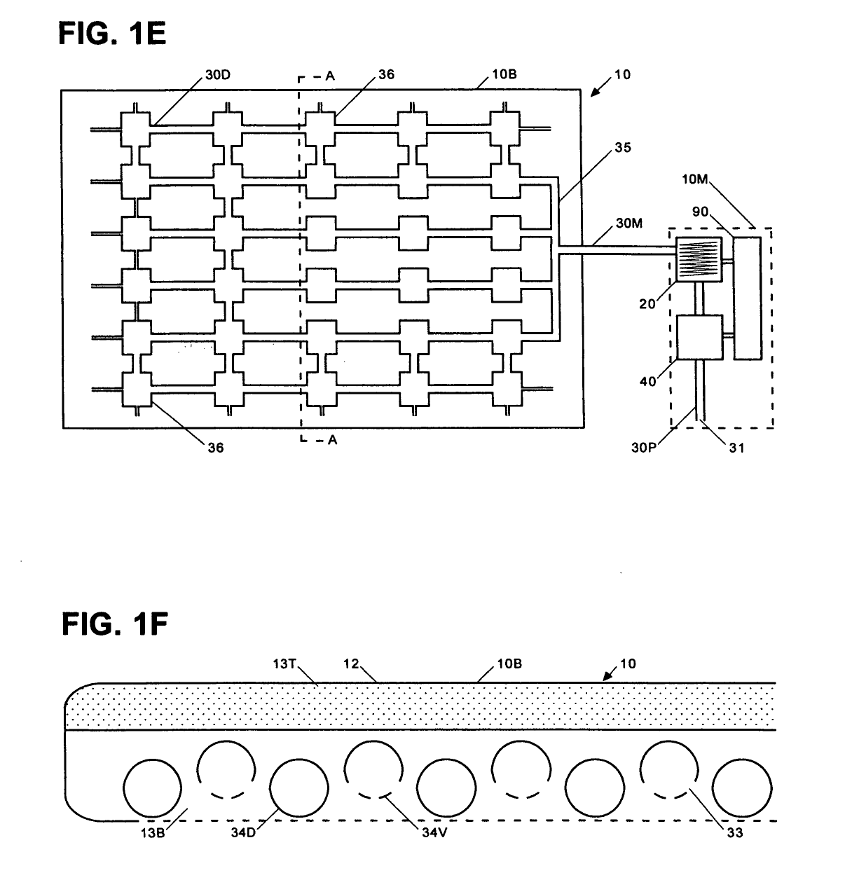

In one aspect of the present invention, an electric blanket system may be arranged to transfer heat into a target space by forced convection of heated air thereinto. FIG. 1A shows a bottom view of an exemplary electric blanket system for transferring heat into a target space by convection, while FIG. 1B is a cross-sectional view of the electric blanket system along a line A-A of FIG. 1A according to the present invention. Such an electric blanket system 10 generally consists of a main module 10M, a coupling module, and a blanket module 10B. Such a system 10 also includes a heating member 20, a conduit member 30, an actuator member 40, and a control member 90.

The blanket module 10B is generally similar to a conventional blanket and arranged to drape an user thereunder or therearound, while the main module 10M is disposed apart from the blanket module 10B and includes various electric and electronic members as will be described in greater detail below. The blanket and main modules 10B, 10M are mechanically and/or fluidly coupled to each other by the coupling module. The blanket module 10B defines a top surface and a bottom surface, where only the bottom surface is designated to form a target space thereunder.

The conduit member 30 includes at least one air inlet 31, at least proximal air path 30P, at least one middle air path 30M, at least one distal air path 30D, and at least one air outlet 32, all of which are fluidly coupling with each other in this sequence. The air inlet 31 is generally open to an atmosphere, while the proximal air path 30P is fluidly coupled with the air inlet 31 in one end and with the middle air path 30M in its opposite end. In addition, the distal air path 30D is fluidly coupled to the middle air path 30M in one end and terminates in an interior of the blanket module 10B in its opposite end. In addition, the distal air path 30D forms multiple air outlets 32 therealong to provide fluid communication between internal lumen of the distal air path 30D and the interior of the blanket module 10B. In general, only the distal air path 30D of the conduit member 30 is disposed inside and/or along the blanket module 10B in a tortuous pattern so that a total length of the distal air path 30D is substantially greater than a length and a width of the blanket module 10B. It is appreciated that various portions of the distal air path 30D are not shown to scale so that each portion may have different shapes and sizes and, therefore, may define different hydraulic resistances along the distal path 30D. In addition, the hydraulic resistances along the distal air path 30D may be arranged to match a cross-sectional area of the air outlet 32 and to match a distribution pattern of the air outlet 32 according to a desired ratio of hydraulic resistances along the distal path 30D to those through the air outlet 32. It is also appreciated that various air paths 30P, 30M, 30P of the conduit member 30 may be detachably coupled to each other, thereby defining a modularized conduit member 30 in which each air path module may be attached to and detached from the rest of the air path modules.

The actuator member 40 generally includes at least one electric motor and at least one impeller and is arranged to transport air from one to an opposite end of its impeller. The actuator member 40 is generally arranged to take in ambient air through the air inlet 31 and to move such air through various paths 30P, 30M, 30D of the conduit member 30 and out of the air outlet 32 thereof. To this end, such an actuator member 40 is disposed closer to the air outlet 31, along the proximal air path 30P or along the middle air path 30M, as long as the actuator member 40 is disposed away from the blanket module 10B by at least a preset distance. The actuator member 40 may be disposed along a portion of such a proximal or middle air path 30P, 30M so that its impeller and motor are disposed parallel to the portion.

In the alternative, the impeller of the actuator member 40 may be disposed along such a portion of the proximal or middle air path 30P, 30M, while its motor is not disposed along such an air path 30P, 30D.

The heating member 20 generally includes at least one heating element which generates heat when electric current flows therein and which is also arranged to transfer at least a portion of such heat (or simply “heat” for simplicity of illustration) onto the air. Accordingly, the heating member 20 is disposed distal to the air inlet and arranged to contact and heat the air, thereby generating heated air. As long as the heating member 20 properly heats the air, such a member 20 may be disposed proximal or distal to the actuator member 40, although distal disposition is preferred in order not to compromise operation of the actuator member 40 by heating the actuator member 40 by such heated air during its heating operation. To this end, the heating member 20 is disposed closer to the air outlet 31, along the proximal air path 30P or along the middle air path 30M, as long as the heating member 20 is disposed away from the blanket module 1B by at least a preset distance.

Such a heating member 20 may be arranged to heat the air only up to a preset temperature as selected by an user input or by a factory setting in order to ensure that the temperature of the heated air may not exceed such a temperature either, where examples of such preset temperatures may be any temperature which may scorch, burn, ignite, and/or otherwise overheat any portion of the blanket module 10B, including fabric, synthetic or other covers for the blanket module 10B. Accordingly, such an embodiment may guarantee that the blanket module 10B receiving such heated air heated only up to such a temperature may not and cannot catch fire under any circumstances. In addition, all or at least a substantial portion of the heating member 20 is not to be disposed in the blanket module 90B. Thus, this embodiment guarantees that such a blanket module 10B may not and cannot catch fire regardless of whatever electric malfunction occurs in the heating element 20.

The control member 90 generally includes various electric components and/or algorithms so as to control various operating features of such heating, conduit, and/or actuator members. For example, the control member 90 may regulate an amplitude of electric current flowing in its heating element 20, may manipulate speed of rotation of the motor of the actuator member 40 and a flow rate of air and/or heated air, may control temporal pattern of the electric current supplied to the heating and/or actuator members 20, 40, and the like. When desirable, the control member 90 may be arranged to manipulate the electric current supplied to the heating member 20 according to the rate of air flow generated by the actuator member 40 or vice versa in order to control a temperature of the heated air at or near a preset value. The control member 90 may also incorporate various control algorithms of various prior art controllers as described above and incorporated herein. As described in FIG. 1A, such a control member 90 may be incorporated into the main module 10M in which at least portions of the heating and actuator members 20, 40 are disposed as well. Alternatively, the control member 90 may be formed as an independent module which is separate from the main module 90. It is appreciated that, similar to the heating and actuator members 20, 40, the control member 90 may also be disposed away from the blanket module 10M by at least a preset distance.

Referring to FIG. 1B, the blanket module 10M is bound by a shell 12 and includes multiple layers each of which serves a different function. For example, the blanket module 90M may have a top layer 13T and a bottom later 13B, where the top layer 13T is made of and/or includes at least one thermally insulative material or insulator in order to suppress a loss of heat therethrough, while the bottom layer 13B includes the distal air path 30D arranged in a preset pattern. More particularly, the distal path 30D of FIG. 1B forms multiple openings 33 therealong serving as the air outlet 32 and forming fluid coupling with the target space when the blanket module 10M is disposed over the user with its bottom surface facing down. When desirable, different portions of the distal air path 30B may also be incorporated in different elevations from the bottom surface of the blanket module 10M. A gap defined between the distal air path 30D and bottom surface of the blanket module 10M may be left empty, may be filled with suitable materials with a preset thermal conductivity, and the like.

Still referring to FIGS. 1A and 1B, the exemplary blanket system 10 of this embodiment features several characteristics which are not found in its conventional counterparts. First of all, major wave sources of the system 10 such as, e.g., the heating and actuator members 20, 40 and a portion of the control member 90, are generally modularized and designed to be disposed away from such a blanket module 10B. Therefore, the electric blanket system 10 may be able to substantially reduce intensities of electromagnetic waves (to be referred to as “EM waves hereinafter) emitted by the sources when measured at or near the bottom surface of the blanket module 10B spaced away therefrom and/or in the target space formed away therefrom. As a result, such a blanket system 10 may protect the user from the EM waves without using conventional electric and/or magnetic shields and without having to convert or rectify an AC power into a DC or a quasi-DC power. In addition, the blanket system 10 may heat the target space by directly supplying the heated air into the target space without having to heat such a blanket module 10B first, thereby improving an efficiency of heat transfer. The electric blanket system 10 may be able to heat the target space rapidly during an initial phase of the heating operation as well. By disposing all or at least substantial portions of electric parts of the electric blanket system 10 away therefrom, the blanket module 10B may also be bent or deformed at will without mechanically damaging delicate heating elements, thereby rendering the blanket module 10B practically free of short circuit, overheating, and fire. In addition, the blanket module 10B may be provided as a light and cheap article which may be replaced by a new module when worn and torn after use.

In operation, the distal air path 30D is first incorporated into the blanket module 10B in a preset pattern, while disposing its air outlets 32 and/or openings 33 facing toward the bottom surface of the blanket module 10B which also forms multiple openings therethrough. Thereby, an interior of the distal air path 30D is fluidly coupled to the target space defined under the bottom surface of such a module 10B. When the blanket module 10B is to be disposed inside a blanket cover (not shown in the figure), a surface of such a cover covering the bottom surface of the blanket module 10B is also arranged to provide fluid communication therethrough, thereby allowing the heated air supplied through the distal air path 30D to seep through the bottom surface of the blanket module 10B, through the surface of the cover, and into the target space. Once assembled, the blanket module 10B is coupled to the coupling module while maintaining fluid coupling and/or communication between the middle air path 30M of the coupling module and the distal air path 30D of the blanket module 10B. The coupling module may then fluidly couple with the main module 10M while maintaining fluid coupling between the proximal air path 30P of the main module 10M and the middle air path 30M of the coupling module. Such a main module is also disposed in order to position the air inlet 31 to take in ambient air.

The assembled electric blanket system 10 is plugged to an AC power source, and an on-off switch (not shown in the figure) is turned on, thereby supplying the electric current in the heating and actuator members 20, 40. Based upon settings selected by the user, the actuator member 40 takes in the ambient air at a preset flow rate, while the heating member 20 generates heat and transfers such heat to the air, thereby generating heated air. A pressure gradient developed by the actuator member 40 transports or moves the heated air through the proximal and middle air paths 30P, 30M of the main and/or coupling modules and into the distal air path 30D of the blanket module 10B.

As the heated air enters the distal air path 30D of the blanket module 10B, some heated air may flow out of the distal air path 30D through its air outlets 32 or openings 33, while the rest may continue to advance therealong. Although not depicted in the figure, different portions of the distal air path 30D may define different shapes and/or sizes, while the air outlets 32 may similarly have different shapes and/or sizes. In addition, such air outlets 32 may be distributed uniformly along the distal air path 30D or, in the alternative, may be distributed according to a preset nonuniform pattern. For example, such portions of the distal air path 30D may be shaped and/or sized to facilitate the heated air to flow to a distal end of the distal air path 30D while continually seeping through the air outlets 32 thereof. In one example, a proximal portion of such a distal air path 30D may define a greater dimension and its cross-sectional area may be larger than a total cross-sectional area of multiple air outlets 32 per unit length of the distal air path 30D, thereby allowing a major portion of the heated air to flow along a forward or anterograde direction through the distal air path 30D while allowing only a minor portion of the heated air to seep out from the distal air path 30D through the air outlets 32 and to eventually reach the target space. Thus, as the heated air flows through an entire length of the distal air path 30D, the heated air may flow out of a substantial portion of the blanket module 10B while convectively transferring such heat contained therein into the target space.

As described herein, such air outlets 32 of the distal air path 30D are preferentially oriented to face the bottom layer 13B of the blanket module 10B, whereas the top layer of the blanket module 10B includes the thermal insulator and minimizes the heat loss therethrough. In addition, an exterior wall of the distal air path 30D may be thermally insulated to minimize heat transfer across the exterior wall as well, thereby allowing the heated air to retain most of the heat retained therein until the heated air may flow out through the air outlets 32. Therefore, such a convective blanket module 10B may have a high heat transfer efficiency, for the heat may neither flow across the top layer of the blanket module 10B nor be wasted to heat up such a module 10B itself.

In another aspect of the present invention, an electric blanket system may instead be arranged to transfer heat onto a target space through thermal conduction. FIG. 1C shows a bottom view of an exemplary electric blanket system for transferring heat to a target space by conduction, while FIG. 1D shows a cross-sectional view of the electric blanket system along a line A-A of FIG. 1C according to the present invention. Such an electric blanket system 10 similarly consists of a main module 10M, a coupling module, and a blanket module 10B, and includes a heating member 20, a conduit member 30, an actuator member 40, and a control member 90.

The main module 10M, coupling module, and blanket module 10B of this embodiment are similar to those of FIGS. 1A and 1B, and the heating member 20, actuator member 40, and control member 90 of this embodiment are also similar to those of FIGS. 1A and 1B. The conduit member 30 also includes an air inlet 31, a proximal air path 30P, a middle air path 30M, and a distal air path 30D, all of which may be similar to those of FIGS. 1A and 1B. It is appreciated, however, that the blanket module 10B of this embodiment is preferably designed to transfer such heat carried by the heated air to the target space not by convection but by conduction. Accordingly, the distal air path 30D may not need to include any air outlets or openings therealong but rather be disposed closer to the bottom layer 13B of the blanket module 10B in order to reduce a length of a conduction path. In addition, because no convective heat transfer occurs along any portion of such a distal air path 30D, the heated air supplied by the actuator member 40 travels through the distal air path 30D and is returned to the actuator member 40 such that the air still retaining some of the heat applied by the heating member 20 may be recycled and reused in the next cycle of heating operation, thereby improving an efficiency of heat transfer.

Several provisions may be incorporated into such a blanket module 10B in order to facilitate the conductive heat transfer. As described above and depicted in FIG. 1D, the distal air path 30D may be disposed in the bottom layer 13B and closer to the bottom surface of the blanket module 10B, thereby reducing the length of conduction and minimizing loss of heat by conduction through the bottom layer 13B of such a module 10B. In addition, the blanket module 10B may define more layers to minimize the loss of heat through layers other than the bottom layer 13B. For example and as described in FIG. 1D, such a blanket module 10B may form the top layer 13T, bottom layer 13B, and at least one middle layer 13M interposed between the top and bottom layers 13T, 13B. Such a top layer 13T may be made of and/or include the thermal insulator as described above in order to suppress conductive heat transfer therethrough, and the bottom layer 13B may be made of and/or include at least one thermal conductor so as to facilitate the conductive heat transfer therethrough. The middle layer 13M may be employed for various reasons. For example, the middle layer 13M may be used to provide mechanical integrity and/or sturdiness or, alternatively, flexibility and/or deformability to the blanket module 10B regardless of its thermal conductivity. In another example, the middle layer 13M may have a thermal conductivity which may be higher than that of the top layer 13T but lower than the bottom layer 13B. Such a layer 13M may be incorporated to maintain a desirable conductivity pattern of the blanket module 10B while providing desirable mechanical properties to the blanket module 10B. In another embodiment, the distal air path 30D may be arranged to maximize the conductive heat transfer toward the bottom layer 13B but to minimize such transfer toward the top layer 13T. For example, a top portion of the distal air path 30D may be made of and/or include the thermal insulator, while a bottom portion of the distal air path 30D may be made of and/or include the thermal conductor. In a related embodiment, the top portion of the distal air path 30D may be covered by the thermal insulator as well.

It is appreciated that the distal air path 30D of FIGS. 1C and 1D may not include any air outlets or openings therealong and, therefore, cannot supply the heated air directly into the target space by convection. In addition, such a conductive distal air path 30D may not supply the moisture or oxygen into the target space. However, the conductive distal air path 30D may carry the air heated beyond the temperature which a body of the user may endure. That is, because the convective distal air path of FIGS. 1A and 1B is to supply the heated air directly into the target space, the air may be heated only up to a certain temperature such as, e.g., 40° C., 45° C., 50° C. but usually no higher therebeyond. To the contrary, such heated air flowing in the conductive distal air path 30D of FIGS. 1C and 1D is not to be directly supplied into the target space and may be heated to a higher temperature such as, e.g., 55° C., 60° C., 65° C., 70° C., 75° C., 80° C., and the like. Therefore, when the blanket module 10B includes ceramic or other composite materials, such hotter heated air may be applied to heat such materials to a higher temperature, thereby facilitating the materials to emit infrared rays and/or far-infrared rays toward the target space. When desirable, the ceramic or composite materials may be incorporated over or inside the distal air path 30D as well. Other configurational and/or operational characteristics of the electric blanket system of FIGS. 1C and 1D are similar or identical to those of FIGS. 1A and 1B.

In another aspect of the present invention, an electric blanket system may further be arranged to transfer heat into and onto a target space by convection and conduction of heated air, respectively. FIG. 1E is a bottom view of another exemplary electric blanket system capable of transferring heat into a target space through convection and FIG. 1F is a cross-sectional view of the electric blanket system along a line A-A of FIG. 1E according to the present invention. The electric blanket system 10 similarly consists of a main module 10M, a coupling module, and a blanket module 10B, and includes a heating member 20, a conduit member 30, an actuator member 40, and a control member 90. The main module 10M, coupling module, and blanket module 10B of such an embodiment are similar to those of FIGS. 1A to 1D, and the heating member 20, actuator member 40, and control member 90 of this embodiment are also similar to those of FIGS. 1A to 1D. The conduit member 30 includes an air inlet 31, a proximal air path 30P, a middle air path 30M, and a distal air path 30D, where all except the distal air path 30D are similar to those of FIGS. 1A and 1B.

The distal air path 30D of this embodiment is different from those of FIGS. 1A to 1D in several aspects. First of all, the single middle air path 30M fluidly couples with multiple distal air paths 30D in a parallel pattern either directly or through a manifold 35. Secondly, at least two of such multiple distal air paths 30D may define different lengths, may be distributed in different arrangements, and the like. Depending upon an input resistance of each distal air path 30D, such heated air is distributed to each distal air path 30D accordingly, where each input resistance may be determined by a dimension and an area of a cross-section of each distal air path 30D, a length and a curvature of each distal air path 30D, flexibility thereof, and the like. Thirdly, at least one of the distal air paths 30D may include at least one subchamber 36 therealong, where such a subchamber 36 may be made of and/or include at least one rigid, elastic, and/or deformable material and may define a preset volume. In addition, at least two of such multiple distal air paths 30D may be fluidly coupled to each other either directly or through their subchambers 36 such that the heated air may be supplied to each of such multiple distal air paths 30D along multiple parallel routes. Therefore, even when a portion of a distal air path 30D may be bent and may block such heated air from flowing therethrough, other portions of such a distal air path 30D may be supplied with the heated air through other parallel routes. Moreover, different portions of different distal air paths 30D may define air outlets of different shapes and sizes, thereby manipulating the flow of the heated air. All of the above provisions are generally made for supplying such heated air evenly throughout the blanket module 10B or, in the alternative, for supplying the heated air to preset portions of the blanket module 10B, where such preset portions may correspond to those portions draping the body of the user.

As described above, the conduit member 30 may also include multiple sets of distal air paths, where at least one of such sets may be used for convective heat transfer, while at least another of such sets may be utilized for conductive heat transfer. As depicted in FIG. 1F, a first set of the distal air paths 34V may define multiple air outlets 32 or openings 33 therealong so as to supply the heated air directly into the target space through the bottom layer 13B and surface of the blanket module 10B. In addition, a second set of the distal air paths 34D may also be arranged without any air outlets 32 or openings 33 in order to transfer the heat of the heated air onto the target space through conduction, where the second set of the distal air paths 34V is not included in FIG. 1E for simplicity of explanation. The conductive distal air paths 34D of the second set are generally disposed side by side or laterally with the convective distal air paths 34V of the first set. However, the conductive paths 34D may be disposed closer to the bottom surface of the blanket module 10B than the convective paths 34V are in order to minimize the conduction path of heat and to facilitate conduction onto the target space. Other configurational and/or operational characteristics of the electric blanket system of FIGS. 1E and 1F are similar or identical to those of FIGS. 1A to 1D.

Configurational and/or operational variations and/or modifications of the above embodiments of the exemplary systems and various modules thereof described in FIGS. 1A through 1F also fall within the scope of this invention.

Any conventional air, gas, and/or fluid heating devices may be used as the heating member of the electric blanket system of this invention, where any conventional heat exchange mechanisms may be incorporated thereinto and where any conventional heat control algorithms may also be employed. The heating member may be disposed in a proximal end of the conduit member, along the proximal air path, and so on. In addition, the heating member may be disposed proximal to the main module, inside the main module, between the main module and blanket module, and the like, where the efficiency of heat transfer may be enhanced as the heating member is disposed closer to the main module. When desirable, a portion of the heating member may also be disposed in one portion of the blanket module while being preferably localized therein. When the heating member is properly shield by at least one electric and/or magnetic shield, such a heating member may then be disposed in almost any portion of the blanket member as far as such disposition may not interfere the flow of the heated air through the blanket module.

In general, such a heating member may be disposed away from the blanket module by a preset distance in order to reduce the intensities of the EM waves emitted thereby under a preset limit when measured at a preset distance from the bottom surface of the blanket module and/or inside the target space, where such a preset limit may be 0.1 mG, 0.2 mG, 0.3 mG, 0.5 mG, 0.7 mG, 1 mG, 2 mG, 3 mG, 4 mG, 5 mG, 7 mG, 10 mG, and the like, while the preset distance may be 0.1 cm, 0.2 cm, 0.5 cm, 1 cm, 2 cm, 3 cm, 5 cm, 7 cm, 10 cm, 15 cm, 20 cm, 25 cm, 30 cm, and the like. The heating member may be arranged to heat the air up to a preset temperature such as, e.g., about 40° C., 45° C., 50° C., 55° C., 60° C., 65° C., 70° C., and the like, where the temperature of the heated air may be measured at a distal end of the heating member, along the middle air path 30M, in a proximal end of the distal air path, in a preset landmark of the distal air path and/or blanket module, and the like.

The heating member may be used in conjunction with at least one heat exchange member for facilitating heat transfer from the heating element to the air flowing therethrough. Because the heating member is disposed away from the blanket module, such a heating member may not have to be made foldable or bendable. When desirable, at least a portion of the heating member may be enclosed by at least one magnetic and/or electric shield which have been described in the co-pending Applications. In addition, other features of the co-pending Applications may also be applied to the heating member of the electric blanket system of this invention.

Any conventional air, gas, and/or fluid pumping devices may be used as the actuator member of the electric blanket system of this invention, where any conventional flow regulating mechanisms may be incorporated thereinto and where any conventional flow control algorithms may be employed as well. Because the electric blanket system is expected to be used at night, it is important that such an actuator member may preferably be able to transport the air with the least noise. To this end, such an actuator member may be installed in a chamber which is capable of absorbing the noise generated by the actuator member. Alternatively, conventional sound cancellation devices may also be used so as to cancel and minimize the noise generated by the actuator member. The actuator member may not have to transport a large amount of air during the heating operation of the electric blanket system. For example, such an actuator member may be arranged to pump the air (when measured at the standard temperature and pressure) at a rate of, e.g., about 0.5 L/min, 1.0 L/min, 5 L/min, 10 L/min, 15 L/min, 20 L/min, 25 L/min, 30 L/min, 35 L/min, 40 L/min, 45 L/min, 50 L/min, 55 L/min, 60 L/min, 70 L/min, 80 L/min, 90 L/min, 100 L/min, and the like, where the maximum rate may be selected during the initial phase of the heating operation, while the lower rates may be used once the target space is warmed up. What really counts, however, is an amount of the thermal energy transferred into or onto the target space by the heated air. Accordingly, a desired air flow rate may be also determined by the temperature of the heated air.

The actuator member may be disposed in the proximal end of the conduit member or along the proximal air path. Such an actuator member may be incorporated proximal to the main module, inside the main module, between the main and blanket modules or any other locations of the electric blanket system as long as such a member may readily take in air from atmosphere and/or other air storages through the air inlet. The actuator member may be disposed proximal or distal to the heating member, although it is preferred that the actuator member be disposed proximal to the heating member so that the actuator member may not be compromised by the heat carried by the heated air. When desirable, at least a portion of the actuator member may be enclosed by at least one magnetic and/or electric shield which have been described in the co-pending Applications. In addition, other features of such co-pending Applications may also be applied to the actuator member of the electric blanket system of this invention.

The evaporation member may be arranged to fluidly couple with the proximal and/or middle air paths and to introduce at least one agent into the stream of air and/or heated air. When desirable, the evaporation member may be incorporated only in a preset location of the blanket module when it may not be desirable to circulate such an agent across an entire portion of the distal air path of the blanket module. By the same token, the evaporation member may be disposed in the main module or coupling module as well.

As described above, any material may be used as the agent when addition or introduction of such a material into the target space may be beneficial to the user and examples of such agents may include, but not be limited to, water, oxygen, medicinal or pharmaceutical substances, pharmaceutical substances, herbal substances, and the like. Such agents may be evaporated into the air or heated air by spraying such into the air or heated air, evaporating such into the air or heated air by heating or by applying ultrasound waves, evaporating such thereinto using a wick, a foam, a bubble chamber, and the like. When applicable, such agents may be provided in power and added directly into the air or heated air.

Because the evaporation member is to add various agents along the air paths, such a member may preferably be disposed distal to the heating and actuator members in order to prevent corrosion or other degradation of the heating and actuator members by such agents. When the agents may be essentially inert, the evaporation member may then be disposed in any portion of the conduit member. The evaporation member may include at least one storage unit in which such agents may be stored as gas or vapor, liquid, and/or solid, where such a storage unit may preferably be rechargeable, refillable or disposable. In the alternative, such an evaporation member may be arranged to receive a refillable or disposable cartridge unit charged with such agents. When desirable, the evaporation member may include at least one control valve with which the user may turn on and off the supply of the agent into the air or heated air either manually or through the control member. The evaporation member may also include multiple storage and/or cartridge units and the user may select one or more of such manually or by the control member. To these ends, at least one sensor may be incorporated along the air path, monitor concentration of the agent in such air or heated air, and turn on or off the supply of a specific agent. In addition, the evaporation member may include a see-through window or a sensor capable of displaying an amount of the agent remaining in the storage or cartridge unit and optionally warning the user for refilling the agent or replacing the cartridge or storage unit. When desirable, the evaporation member may include at least one filter and remove undesirable particles therefrom, thereby preventing entry of such particles into the stream of air or heated air.

The control member may be arranged to control operations of various members of the electric blanket system. First of all, the control member may regulate supply of electric current to the heating member in order to control various features of the heating operation. For example, the control member may control an amount of heat generated by the heating member per unit time, a temporal pattern or a time course of the heating pattern, a temperature at the heating member, and the like. It is appreciated that the temperature of the heated air depends not only upon the amount of heat transferred to the air but also upon the flow rate of the air. Accordingly, such a control member may be arranged to control such variables and/or parameters based upon the air flow rate selected by the user and/or calculated thereby. Secondly, the control member may regulate supply of electric current to the actuator member in order to control various features of the pumping operation. For example, the control member may control a rotation speed of the motor of the actuator member such as its rpm, a temporal pattern of the rpm, and the like. When the control member is designed to control the amount of heat transferred to the air and/or temperature of the heated air, the control member may control the above features of the actuator member based upon the above features of the heating member.

When the electric blanket system incorporates one or more control valves, the control member may be operatively coupled to the control valves and manipulate flow patterns of the air or heated air through various air paths. For example, the control member may control amounts of the air or heated air flowing through multiple proximal, middle, and/or distal air paths, thereby providing various heating patterns across the blanket module. When the control valve is disposed in the distal end of the distal air path, the control member may manipulate the control valve and control an amount of the heated air recycled to the next round of heating operation. When the electric blanket system transfers the heat to the target space through both of convection and conduction, the control valves may be installed in the convective and/or conductive distal air paths and the control member may manipulate the air flow rates to such air paths, thereby manipulating the amounts of heat transferred to the target space by the convection and conduction. In addition, when the heating member may generate multiple streams of air heated to different temperatures, the control member may control the flow rates of heated air with different temperatures in one or more distal air paths, the flow patterns of each heated air with different temperatures, and the like. The control member may also be arranged to turn on and off the supply of various agents into the air or heated air, to control the amount of such agents added to the air or heated air, to select one or more of multiple agents to be added to the air or heated air, and the like. Such a control member may be disposed in various locations such as, e.g., in the main module, in the coupling module or as an additional module separate from the main and coupling modules. When desirable, at least a portion of the control member may be disposed in the blanket module. In addition, a remote control unit may be provided in addition to the main control member such that the remote unit may communicate with the main control member which may then perform the above control functions. The remote control unit may instead communicate directly with other members of the electric blanket system as well.

The electric blanket system may also include a sensor member which may in turn incorporate one or more sensors capable of monitoring various variables and/or parameters of the heating and/or pumping operations, evaporating operations, flow distributing operations, and the like. For example, at least temperature sensor may be installed in the heating member and send a signal representing such temperature to the control member, at least another temperature sensor may be installed along the air path and send another signal representing such temperature to the control member, at least another sensor installed in the blanket module or inside the target space and send another signal representing such temperature to the control member, and the like. At least one humidity sensor may be installed in or on the target space or air inlet and send a signal representing a humidity inside the target space or of the air taken into the conduit member to the control member, at least one sensor for oxygen or other agents may be installed along the air path and send a signal representing concentration of the oxygen or other agents to the control member, and the like. In addition, at least one pressure sensor may also be incorporated along the conductive distal air path and send a signal representing pressure along or in the distal air path to the control member, thereby monitoring any leak along such a distal air path.

The electric blanket system may also include at least one magnetic shield (to be abbreviated as “MS” hereinafter) and/or at least one electric shield (to be referred to as “ES” hereinafter) which have been described in greater detail in the co-pending Applications. For example, the system may include the MS and/or ES disposed on, over, around, in, and/or into at least a portion of the conduit, actuator, and/or heating members and/or may include the MS and/or ES disposed on, over, around, and/or into at least a portion of the main, coupling, and/or blanket modules. Depending on needs, such a system may include only one of the MS or ES. In addition, the MS may include at least one path member but may not include any magnet member, may include at least one path member and at least one magnet member, and so on, where both the path and magnet members have been disclosed in the co-pending Applications in greater detail. The ES may generally shield the user from the EWs through one or more of various mechanisms described in the co-pending Applications and, when desirable, may further be grounded. Similarly, the MS may shield the user from such MWs through one or more of mechanisms described in the co-pending Applications.

As described herein, the intensity of the MWs and EWs decreases inversely proportional to a square of the distance from the wave sources. Thus, one way of attenuating the intensity of such waves is to allow the user to vary the distance between the blanket module and the main module or, in the alternative, the distance between the target space defined under the blanket module and at least one of the sources which irradiate the EM waves such as, e.g., the heating and actuator members by, e.g., positioning such main module and/or wave sources away from the blanket module at least by a preset distance while maintaining fluid communication between the distal and proximal air paths. For example, a length of the coupling module may be selected to ensure that the intensity of the magnetic fields measured in the target space or measured at a preset distance from the bottom surface of the blanket module is less than a preset limit. Examples of such a preset limit may be set as an absolute value such as 0.1 mG, 0.2 mG, 0.3 mG, 0.5 mG, 0.7 mG, 1 mG, 2 mG, 3 mG, 4 mG, 5 mG, 7 mG, 10 mG, and so on, while the examples of such a preset distance may be 0.1 cm, 0.2 cm, 0.5 cm, 1 cm, 2 cm, 3 cm, 5 cm, 7 cm, 10 cm, 15 cm, 20 cm, 25 cm, 30 cm, and so on. In the alternative, the length of such a coupling module may be selected to ensure that the intensity of the magnetic fields may be attenuated by a preset ratio when compared with a situation in which the main module or wave sources may be disposed over or on the blanket module, where examples of the preset ratio may be a relative value which may be about, e.g., 0.95, 0.9, 0.85, 0.8, 0.75, 0.7, 0.65, 0.6, 0.55, 0.5, 0.45, 0.4, 0.35, 0.3, 0.25, 0.2, 0.15, 0.1, 0.05, and the like

As described above, the electric blanket system may include at least one ceramic or composite material capable of emitting the infrared rays or far-infrared rays when heated to certain temperature.

Such a material may preferably be incorporated into the blanket module so that a majority of such rays may propagate toward the target space and eventually irradiate the user which is draped thereunder or therein. In one example, such a material may be disposed in any location near the distal air path so that the material may be heated by the heated air through convection or conduction and then irradiate such rays. In another example, such a material may be coated over or in the distal air path, heated by the heated air through convection or conduction, and then irradiate such rays. When desirable, such a material may be disposed inside the distal air path or may form at least a portion of the distal air path as well. It is appreciated that irradiation of such rays may increase in proportion to the power of four of the temperature of the material. Accordingly, when the blanket module includes the conductive air path, such a material may be disposed adjacent to, over, and/or inside such an air path and heated to a higher temperature, thereby emitting more of such rays than disposed closer to the convective air paths. In addition, the electric blanket system may include at least one conventional device capable of generating positively or negatively charged ions. Further details of such ray emitting materials and ion generating devices are provided in the above prior arts described above and also incorporated herein in their entireties by reference.

The conduit member of the blanket module is by far one of the most distinctive features of the electric blanket system of this invention. As described hereinabove, the conduit member may typically include at least one air inlet, at least one proximal air path, at least one optional middle air path, at least one distal air path, at least one air outlet or opening, and at least one optional discharge air path.

The air inlet is generally disposed proximal to the heating and actuator members and arranged to be in fluid communication with ambient air and/or at least one air storage unit. When desirable, the air inlet may be fluidly coupled with the heated air which has circulated the distal air path and which has been recycled back for the next round of circulation. When the actuator member is designed to take in air from multiple sources, the conduit member may include multiple air inlets each of which may fluidly couple with each of such multiple air sources. The air inlet may be formed as a mere opening fluidly open to the source, as a tube defining a lumen therein or as a control valve which may adjust a cross-sectional area of its lumen and manipulate the flow rate of air therethrough.

The proximal air path is defined distal to the air inlet and may be operatively coupled to at least one of the heating and/or actuator members. When the heating member is disposed along the proximal air path, the heating member may invasively define at least a portion of the proximal air path and heat the air flowing therethrough or, in the alternative, may enclose at least a portion of such a proximal air path and heat the air flowing through the proximal air path through the wall of such a path. When the actuator member is disposed along the proximal air path, the actuator member may invasively define at least a portion of the proximal air path and generate the flow of air or heated air therethrough or, in the alternative, may be disposed on the wall of the deformable proximal air path and squeeze such a path and generate the flow of air or heated air through the lumen of the proximal air path.

The conduit member may also include one or multiple proximal air paths depending on a desired configuration of a network of various air paths. For example, one proximal air path may fluidly couple with one air inlet, multiple proximal air paths may fluidly couple with one air inlet, one proximal air path may fluidly couple with multiple air inlets, or multiple proximal air paths may fluidly couple with multiple air inlets, where at least two of such multiple air inlets may fluidly couple with different sources of air. When the electric blanket system is to transfer heat to the target space through convection as well as conduction, such a conduit member may provide at least one proximal air path solely dedicated to the convective heat transfer and at least another proximal air path solely dedicated to the conductive heat transfer. When desirable, the proximal air path may be fluidly coupled with the heated air which has circulated the distal air path and been recycled back for the next round of circulation.

As described above, the proximal air path is primarily used to move the air or heated air from the air inlet to the blanket module. When the actuator member may be arranged to discharge stale air from the target space and/or to recycle the heated air, the proximal air path may also be used as an anterograde path for moving the air or heated air to the blanket module as well as a retrograde path for moving the stale and/or recycled air back to the actuator member or out to an exhaust.

In general, the proximal air path may be made of and/or include any material resilient enough to endure the driving pressure generated by the actuator member. At least a portion of the proximal air path may be made of and/or include at least one deformable or elastic material so as to allow the user to bend, to twist or to otherwise deform such a portion of the proximal air path for disposing and/or handling purposes. The proximal air path may include the thermal insulator to reduce the loss of heat therethrough and may include heat-resistant material to perform normal function against the heated air flowing therethrough.

The optional middle air path is defined distal to the proximal air path and may operatively couple with at least one of the heating and/or actuator members when desirable. When the heating member is disposed along the middle air path, the heating member may invasively define at least a portion of the middle air path and heat the air flowing therethrough or, in the alternative, may enclose at least a portion of the middle air path and heat the air flowing in the middle air path through its wall. When the actuator member is disposed along the middle air path, the actuator member may invasively define at least a portion of the middle air path and generate the flow of air or heated air therethrough or, in the alternative, may be disposed on the wall of the deformable middle air path and squeeze such a path and generate the flow of air or heated air through the lumen of the middle air path.

The conduit member may also include one or multiple middle air paths depending on a desired configuration of a network of various air paths. Such middle air paths may also fluidly couple with the proximal air path in various patterns similar to those between multiple proximal air paths and air inlets. In addition, the conduit member may have at least one middle air path dedicated to the convective heat transfer and at least another proximal air path for the conductive heat transfer. Such a middle air path may be fluidly coupled with the heated air which has circulated the distal air path and which has been recycled back for the next round of circulation. Such a middle air path may also fluidly couple with the stale and/or recycled air and may be used as one or both of the anterograde and retrograde paths. In addition, the middle air path may be made of and/or include the materials for the proximal air path. It is appreciated that such a middle air path is typically defined between the main and blanket modules and, accordingly, may not be necessary when the main module may be disposed substantially close to the blanket module and/or when the distal air path of the blanket module may be extended beyond an edge of the blanket module.

The distal air path is defined distal to the middle air path or distal to the proximal air path when the conduit member may not have any middle air path therebetween. In general, such a distal air path is disposed in the blanket module and, therefore, may not preferably include any of the heating and/or actuator members. When at least portions of the heating and actuator members are properly shielded from the MWs and EWs, such portions may be disposed along the distal air path and, therefore, inside the blanket module in various arrangements similar to those members disposed along the proximal and middle air paths.

The conduit member may also include one or multiple distal air paths depending upon a desired configuration of the network of various air paths. For example, one distal air path may fluidly couple with one middle (or proximal) air path, multiple distal air paths may be fluidly coupled to one middle (or proximal) air path, one distal air path may be fluidly coupled to multiple middle (or proximal) air path, or multiple distal air paths may fluidly couple with multiple middle (or proximal) air path. As exemplified in FIG. 1F, when the electric blanket system is to transfer heat to the target space through convection as well as conduction, such a conduit member may provide at least one distal air path solely dedicated to the convective heat transfer (thus, defining at least one air outlet or opening therealong) and at least one distal air path solely dedicated to the conductive heat transfer (thus, not including any air outlet or opening).

Multiple distal air paths may be fluidly coupled to each other by various patterns. For example, the blanket module may include at least one junction in which at least two distal air paths may merge into each other or a single distal air path may bifurcate into multiple distal air paths. When desirable, the junction may include a manifold through which one (or multiple) distal air path may bifurcate into (or may be merged into) multiple (or single) distal air paths. At least two of such distal air paths may also be detachably coupled to each other through a conventional coupling structure and/or a conventional coupler. The distal air path may also include at least one-way valve in order to ensure that the heated air may flow only along the anterograde direction but not along the retrograde direction. The distal air path may further include at least one control valve which may be arranged to open and close a preset portion of the distal air path, to change the hydraulic resistance therethrough, and/or to manipulate the direction of the flow of the heated air thereby. All of these provisions may be employed to manipulate the heated air to flow along a desired direction across the blanket module, where detailed examples of such will be described in greater detail below. It is appreciated that similar arrangements may also be provided to a single distal air path which may include multiple distinct portions.

In general, the distal air path may extend any desirable length, may define any desirable cross-section, and may also be distributed in any arrangement along the blanket module. When the conduit member includes multiple distal air paths, such distal air paths may be arranged to define an identical shape and size or, in the alternative, at least two of such distal air paths may define different shapes and/or sizes. In addition, such distal air paths may be distributed over the blanket module in an uniform spacing or in different distances. Regardless of the number of the distal air paths, such may also be arranged symmetrically with respect to a point inside the blanket module and/or a line segment thereof or, in the alternative, may be arranged asymmetrically.

As described above, the distal air path is primarily designed to receive the heated air from the middle (or proximal) air path and then to circulate such heated air along various portions of the blanket module. When the actuator member is arranged to discharge stale air from the target space and/or to recycle the heated air, the distal air path may also be used as an anterograde path for transporting the heated air to the blanket module as well as a retrograde path for moving the stale and/or recycled air back to the actuator member or out to the exhaust.

In general, the distal air path may also be made of and/or include any material resilient enough to endure the driving pressure generated by the actuator member. At least a portion of the distal air path may be preferably made of and/or include at least one deformable and/or elastic material so as to allow the user to bend, to twist or to otherwise deform such a portion of the distal air path as well as a corresponding portion of the blanket module for disposing and/or handling purposes. The distal air path may include the thermal insulator in one portion thereof to reduce the loss of heat therethrough and may include heat-resistant material to perform normal function against the heated air.

Such distal air paths may be constructed by various arrangements. In one example, the distal air path may be arranged to be formed as a tube which may have at least one exterior wall and lumen defined inside the wall, where the convective distal air path may define multiple air outlets or openings oriented toward the bottom surface of the blanket module, whereas the conductive distal air path may not include any air outlet or opening therealong. Such a distal air path will be referred to as an “active distal path” or as the distal air path having an “active configuration” hereinafter. In another example, at least a portion of the blanket module may form a porous structure defining at least one matrix through which multiple pores may be defined while forming at least partial fluid communication therebetween. Such a distal air path will be referred to as a “passive distal path” or as the distal air path defining a “passive configuration” hereinafter. In yet another example, at least a portion of the top and/or bottom surfaces of the blanket module may be arranged to form at least a portion of the active and/or passive distal air path.

As described above, a single distal air path may serve as a convective air path, a conductive air path or a combination path for both convection and conduction. The prerequisite of the convective distal air path is to define multiple air outlets and/or openings therealong, whereas the prerequisite of the conductive air path is to not preferably define such air outlets and/or openings therealong. Thus, the convective distal air path may be provided by, e.g., providing the air outlets or openings along the active air path, defining gaps serving as such air outlets or openings between multiple portions of the active and/or passive air paths, providing such a convective distal air path from the passive air path without enclosing at least a portion of the passive air path and/or by enclosing only a portion of the passive air path, forming the air outlets or openings on a portion of the bottom surface of the blanket module which also forms at least a portion of the above active and/or passive air paths, and the like. In contrary, the conductive distal air path may be formed by, e.g., providing the active air path without any air outlets or openings, providing the passive air path in a lumen of a tube without any air outlets or openings, and the like.

Various provisions may also be made to facilitate the convective and conductive heat transfer. For example, the air outlets or openings of the convective distal air path may be oriented to face the bottom surface of the blanket module. Such air outlets or openings may also be disposed as close to such a bottom surface as possible to reduce a length of the convection path. Accordingly, such air outlets or openings may fluidly couple with matching openings of the bottom surface or, alternatively, such air outlets or openings may be arranged to be directly open to the target space through such a bottom surface. In another example, the conductive distal air path may be similarly disposed as close to the bottom surface of the blanket module and reduce a length of the conduction path. In addition, at least one thermal conductor and/or distributor may be incorporated on or near the conductive distal air path in order to better transfer the heat from the distal air path.

When the blanket module may include the above multiple distal air paths which define different configurations, one distal air path with one configuration may be dedicated as the convective distal air path, while another distal air path with another configuration may be used as the conductive distal air path. In addition, at least one distal air path may be arranged to be attached to and/or detached from the rest of such distal air paths. Similarly, the entire distal air path may be arranged to be attached to and/or detached from the middle (or proximal) air path as well.

The convective and conductive distal air paths may also be distributed over the blanket module in various patterns. In one example, the convective and conductive distal air paths may extend along an identical length, a similar lengths or different lengths over the blanket module. In another example, the convective and conductive distal air paths may be disposed at an identical depth, a similar depth or different depths from the bottom surface of the blanket module. In another example, the convective and conductive distal air paths may be disposed one over the other or vertically at an identical depth or different depths or, in the alternative, disposed side by side or laterally. In a related example, the convective and conductive distal air paths may be interwoven or interlocked without forming any fluid communication therebetween. In another example, at least a portion of the distal air path may be used as both the convective and conductive distal air paths. In all of these examples, such convective (or conductive) air paths may be disposed symmetric with respect to a point of the blanket module and/or a line segment of the blanket module or, alternatively, may be disposed asymmetrically.

The distal air path may also include other features. For example, the distal air path may divide the blanket module into multiple segments at least two of which may include at least one distal air path therein. Such distal air paths may be detachably or fixedly coupled to each other in order to define the preset network for such air paths, where such segments may define therebetween at least one zone along which the blanket module may be folded and/or bent. When the distal air path may be made of and/or include at least one deformable material, the hydraulic resistance of such a path may also vary depending upon an extent of deformation and/or bending. Therefore, such a blanket module may not be overheated, for the actuator member may be able to supply a greatly reduced amount of the heated air to such a portion of the distal air path folded or bent by the user, thereby automatically limiting such supply of the heated air thereto. The blanket module may also include at least one separate discharge air path through which the stale air inside the target space and/or heated air discharged by the distal air path may be recycled to a preset location of the proximal and/or middle air paths. When desirable, at least one end of the distal air path may be obstructed by a matching cap, thereby preventing foreign particles from entering the lumen of the distal air path. Such an embodiment may be beneficial when it is desirable to wash the blanket module while ensuring that no water gets into the lumen of such air paths.

The air outlet is generally disposed distal to the heating and actuator members and arranged to be in fluid communication with the target space in order to supply the heated air thereinto when used for convection. Alternatively, the air outlet is arranged to be in fluid communication with the proximal and/or middle air path in order to recycle at least a portion of the heated air back to the actuator and/or heating members or with the exhaust when used for conduction. When used for conduction, the air outlets may be defined along at least a portion of the distal air path at an uniform interval or at another nonuniform pattern. The air outlets may have identical or similar shapes and/or sizes but may also be arranged to have different shapes and/or sizes in order to allow the air outlets which are distributed along different locations of the distal air path to supply at least substantially identical or similar amount of the heated air into the target space. When a preset portion of the blanket module is desired to get more (or less) heated air, the air outlets corresponding to such a portion of the blanket module may be arranged to be larger (or smaller) and define less (or greater) hydraulic resistance, thereby supplying more (or less) heated air than other air outlets. The air outlet may be formed as a mere opening fluidly open to the target space, as a tube defining a lumen therein or as a control valve which may adjust a cross-sectional area of its lumen and manipulate the flow rate of air therethrough, and the like.

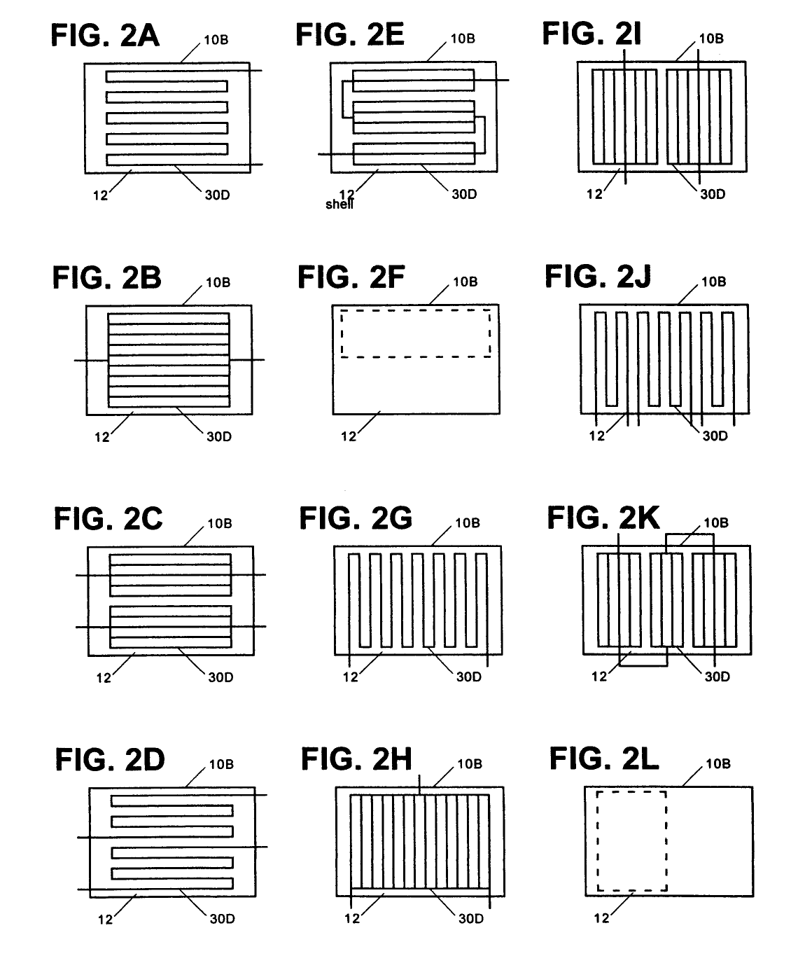

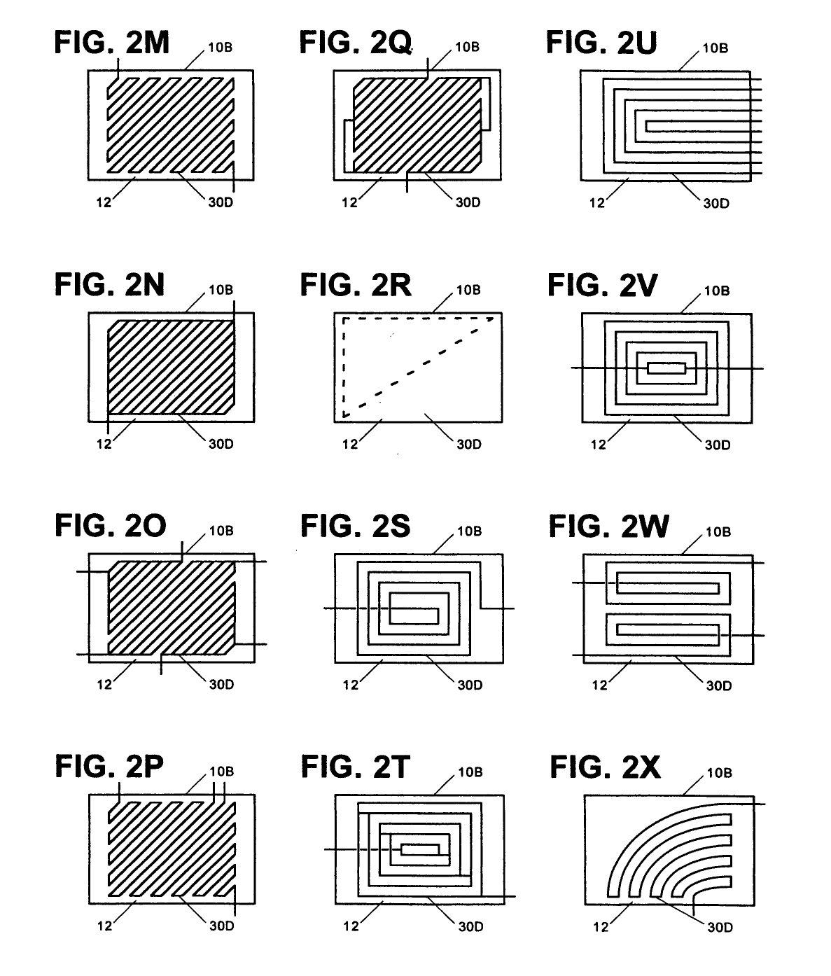

In another aspect of the present invention, various distal air paths may be incorporated into the blanket module in parallel, series, and/or hybrid patterns. FIGS. 2A to 2X are schematic top (or bottom) views of exemplary blanket modules including one or more air paths disposed thereacross in various patterns according to the present invention. It is appreciated that such blanket modules of FIGS. 2A to 2X are generally not drawn to scale and, therefore, that actual configuration of such modules may be slightly different from the simplified versions of such figures.

In one exemplary embodiment of such an aspect of this invention, an exemplary blanket module may include one or multiple horizontally arranged distal air paths as depicted in FIGS. 2A to 2F. In one example of FIG. 2A, a blanket module 10B includes a single distal air path 30D extending in a horizontal direction and disposed along a serpentine pattern. In the alternative, such a distal air path 30D may be viewed as multiple horizontal paths which are disposed in rows and fluidly coupled to each other in a series pattern while having a single inlet end and a single outlet end in their opposing ends. In another example of FIG. 2B, a blanket module 10B may include a single distal air path 30D consisting of multiple horizontal paths which are disposed in rows and are fluidly coupled to each other in a parallel pattern while defining a single inlet end and a single outlet end in their opposing ends. In another example of FIG. 2C, a blanket module 10B includes a pair of distal air paths 30D each of which in turn consists of multiple horizontal paths which are disposed in rows and are fluidly coupled to each other in a parallel pattern, while defining a single inlet end and a single outlet end in their opposing ends. Therefore, the blanket module 10B has two inlet ends and two outlet ends, and its two distal air paths 30D operates independently. It is appreciated that the distal paths 30D of FIG. 2C may be viewed as a pair of distal air paths of FIG. 2B which are disposed laterally or side by side but not fluidly coupled to each other. In another example of FIG. 2D, a blanket module 10B has a pair of distal air paths 30D each of which consists of multiple paths which are disposed in rows and fluidly couple with each other in a series pattern, while defining a single inlet end and a single outlet end. Accordingly, the blanket module 10B defines two inlet ends and two outlet ends, while its two distal air paths 30D operate independently. In another example of FIG. 2E, a blanket module 10B includes a single distal air path 30D having three sets of paths which are disposed in rows and are fluidly coupled to each other in a series pattern. Each set of paths has multiple paths which are disposed in rows and fluidly coupled to each other in a parallel pattern, and such sets are fluidly coupled in a series pattern, thereby defining a single inlet end and a single outlet end. It is appreciated that such distal paths 30D of FIG. 2E may be viewed as multiple distal air paths 30D of FIGS. 2B and 2C which are disposed laterally or side by side and fluidly coupled to each other in a series pattern. The blanket module 10B may include any of these distal air paths of FIGS. 2A to 2E thereon. Alternatively, one of these distal air paths may be disposed in only a portion of the blanket module 10B, while other distal air paths defining different shapes, sizes, and/or arrangements may be disposed in the rest of the blanket module 10B. An example depicted in FIG. 2F illustrates an exemplary blanket module 10B which includes any of the distal paths of FIGS. 2A to 2E (or others in the following figures) in its one half, and the other half may include any other distal paths.

In another exemplary embodiment of this aspect of the invention, an exemplary blanket module may include one or multiple vertically arranged distal air paths as described in FIGS. 2G to 2L. In one example of FIG. 2G, a blanket module 10B includes a single distal air path 30D extending in a vertical direction and disposed along a serpentine pattern. In the alternative, such a distal air path 30D may be viewed as multiple vertical paths which are disposed in columns and fluidly coupled to each other in a series pattern while having a single inlet end and a single outlet end in their opposing ends. In another example of FIG. 2H, a blanket module 10B may include a single distal air path 30D consisting of multiple vertical paths which are disposed in columns and are fluidly coupled to each other in a parallel pattern while defining a single inlet (or outlet) end and a pair of outlet (or inlet) ends in their opposing ends. In another example of FIG. 2I, a blanket module 10B includes a pair of distal air paths 30D each of which consists of multiple vertical paths which are disposed in columns and fluidly coupled to each other in a parallel pattern while having a single inlet end and a single outlet end in their opposing ends. Thus, the blanket module 10B has two inlet ends and two outlet ends, and its two distal air paths 30D operates independently. It is appreciated that such distal paths 30D of FIG. 2I may be viewed as a pair of distal air paths of FIG. 2H which are disposed laterally or side by side but not fluidly coupled to each other. In another example of FIG. 2J, a blanket module 10B includes three distal air paths 30D each of which consists of multiple paths which are disposed in columns and fluidly coupled to each other in a series pattern, while defining a single inlet end and a single outlet end. Accordingly, the blanket module 10B has three inlet ends and three outlet ends, while its distal air paths 30D may operate independently. In another example of FIG. 2K, a blanket module 10B includes a single distal air path 30D including three sets of paths which are disposed in columns and are fluidly coupled to each other in a series pattern. Each set of paths has multiple paths which are disposed in columns and fluidly coupled to each other in a parallel pattern, and such sets are fluidly coupled in a series pattern, thereby defining a single inlet end and a single outlet end. It is appreciated that such distal paths 30D of FIG. 2K may be viewed as multiple distal air paths 30D of FIGS. 2H and 2I which are disposed laterally or side by side and fluidly coupled to each other in a series pattern. The blanket module 10B may include any of these distal air paths of FIGS. 2G to 2K thereon. Alternatively, one of these distal air paths may be disposed in only a portion of the blanket module 10B, while other distal air paths defining different shapes, sizes, and/or arrangements may be disposed in the rest of the blanket module 10B. An example depicted in FIG. 2L illustrates an exemplary blanket module 10B which includes any of the distal paths of FIGS. 2G to 2K (or others in the following figures) in its one half, and the other half may include any other distal paths.

In another exemplary embodiment of this aspect of the invention, an exemplary blanket module may have one or multiple transversely arranged distal air paths as described in FIGS. 2M to 2R. In one example of FIG. 2M, a blanket module 10B has a single distal air path 30D extending in a transverse direction and disposed along a serpentine pattern. In the alternative, such a distal air path 30D may be viewed as multiple transverse paths which are disposed at angles and fluidly couple with each other in a series pattern while defining a single inlet end and a single outlet end in their opposing ends. In another example of FIG. 2N, a blanket module 10B may have a single distal air path 30D consisting of multiple transverse paths which are disposed at angles and fluidly coupled to each other in a parallel pattern while having a single inlet end as well as a single outlet end in their opposing ends. In another example of FIG. 20, a blanket module 10B includes three distal air paths 30D each of which consists of multiple transverse paths which are disposed at angles and are fluidly coupled to each other in a parallel pattern while defining multiple inlet ends and multiple outlet ends in their opposing ends. Thus, the blanket module 10B includes two inlet ends and two outlet ends, and its two distal air paths 30D operates independently. It is appreciated that such distal paths 30D of FIG. 20 may be viewed as a pair of distal air paths of FIG. 2N which are disposed laterally or side by side but not fluidly coupled to each other. In another example of FIG. 2P, a blanket module 10B has two distal air paths 30D each of which consists of multiple paths which are disposed at angles and fluidly coupled to each other in a series pattern, while defining a single inlet end and a single outlet end. Therefore, the blanket module 10B has two inlet ends and two outlet ends, while its distal air paths 30D may operate independently. In another example of FIG. 2Q, a blanket module 10B has a single distal air path 30D including three sets of paths which are disposed at angles and are fluidly coupled to each other in a series pattern. Each set of paths has multiple paths which are disposed at angles and fluidly coupled to each other in a parallel pattern, and such sets are fluidly coupled in a series pattern, thereby defining a single inlet end and a single outlet end. It is appreciated that such distal paths 30D of FIG. 2Q may be viewed as multiple distal air paths 30D of FIGS. 2N and 20 which are disposed laterally or side by side and fluidly coupled to each other in a series pattern. The blanket module 10B may include any of these distal air paths of FIGS. 2M to 2Q thereon. Alternatively, one of these distal air paths may be disposed in only a portion of the blanket module 10B, while other distal air paths defining different shapes, sizes, and/or arrangements may be disposed in the rest of the blanket module 10B. An example depicted in FIG. 2R illustrates an exemplary blanket module 10B which may include any of the distal paths of FIGS. 2M to 2Q (or others in the following figures) in its one half, while the other half may include any other distal paths.

In another exemplary embodiment of this aspect of the invention, an exemplary blanket module may include one or multiple concentrically arranged distal air paths as described in FIGS. 2S to 2X. In one example of FIG. 2S, a blanket module 10B has a single distal air path 30D extending concentrically in a serpentine pattern. Alternatively, such a distal air path 30D may be viewed as multiple horizontal and vertical paths which are disposed concentrically and are fluidly coupled to each other in a series pattern while having a single inlet end as well as a single outlet end in their opposing ends. In another example of FIG. 2T, a blanket module 10B may include a single distal air path 30D consisting of multiple horizontal and vertical paths which are disposed concentrically and fluidly coupled to each other in a hybrid pattern while defining a single inlet end as well as a single outlet end in their opposing ends. In another example of FIG. 2U, a blanket module 10B includes multiple distal air paths 30D each of which consists of a single U-shaped path and which are disposed concentrically and are not fluidly coupled to each other. Accordingly, the blanket module 10B defines multiple inlet ends and multiple outlet ends, and its distal air paths 30D generally operate independently. In another example of FIG. 2V, a blanket module 10B has a single distal air path 30D which consists of multiple paths which are concentrically disposed and fluidly couple with each other in a hybrid pattern, while defining a single inlet end and a single outlet end. In another example of FIG. 2W, a blanket module 10B may include a pair of distal air paths 30D each of which includes multiple paths which are disposed concentrically and fluidly couple with each other in a series pattern. It is appreciated that each distal path 30D of FIG. 2W may also be viewed as the distal air path 30D of FIG. 2S and that two of the distal paths 30D are disposed laterally or side by side but not fluidly coupled to each other. The concentric distal air path may be comprised not only of linear paths but also of curved paths. For example and as described in FIG. 2X, a blanket module 10B includes a single distal air path 30D which consists of multiple arcuate paths which may be disposed concentrically and fluidly coupled to each other in a series pattern. In this regard, such a distal air path 30D of FIG. 2X may be viewed as a curved counterpart of that of FIG. 2A. Although not shown in the figures, the blanket module 10B may include any of these distal air paths of FIGS. 2S to 2W in only a portion thereof, while other distal air paths which define different shapes, sizes, and/or arrangements may be disposed in the rest of the blanket module 10B.

Configurational and/or operational variations and/or modifications of the above embodiments of the exemplary systems and various modules thereof described in FIGS. 2A through 2X also fall within the scope of this invention.

The blanket module of the electric blanket system of this invention may include any number of such distal air paths which may define any configuration and may be disposed in any arrangements, as far as the distal air paths may transfer heat contained in the heated air to the target space through convection and/or conduction. As described above, such distal air paths may have various shapes, sizes, and arrangements, and may be disposed evenly or unevenly across the blanket module. Some distal air paths may define air outlets or openings therealong and be used for convective heat transfer by supplying the heated air to the target space therethrough. The air outlets or openings may also be distributed evenly or unevenly along the distal air paths along a longitudinal direction or radial direction and may further define even or uneven configurations. Other distal air paths may define no air outlets or opening therealong and be used for conductive heat transfer.

As described above, the distal air path may consist of multiple sets of paths, where each set may include a preset number of paths of preset dimensions arranged in a preset pattern. At least two of such sets may include different number of paths, paths with different dimensions, paths arranged in different patterns, paths transferring heat by different mechanisms, paths receiving the air heated to different temperatures, paths controlled by different control valves, and the like. As long as such a distal air path may heat the blanket module and/or target space in a desirable pattern, detailed features of such a distal air path and its sets may not be material to the scope of the present invention.

It is appreciated that the heated air may flow along any direction through various paths of the above figures. Accordingly, one end of the above distal air path may be used as the inlet or outlet end for the air path depending upon the direction of the heated air flow. In addition, a given distal air path may define one or multiple air inlets or multiple or one air outlets depending upon the direction of such heated air flow. When the blanket module includes multiple distal air paths and/or when a single distal air path includes multiple paths, the heated air may flow along the same or opposite directions as long as the heated air may flow into and out of the blanket module.

The inlet ends may be disposed in various strategic locations of the blanket module in order to efficiently transfer the heat to the target space. It is to be understood that detailed configuration of the distal air path and/or allocation of the inlet ends may have to be determined according to the hydraulic resistances of the distal air path and desired temperature distribution inside the target space. Thus, it may be desirable that the heated air may be directly supplied from the middle (or proximal) air path to multiple inlet ends defined in various locations of the blanket module. In the alternative, the heated air supplied by the middle (or proximal) air path may be received by a large manifold formed in the blanket module, and the heated air may then be directly supplied from the manifold to various locations of the blanket module. Thereafter, the heated air may be distributed locally around such locations. Either of these embodiments guarantee that the heated air may be supplied as evenly to a larger portion of the blanket module as possible, without necessarily losing the driving pressure for the heated air, without wasting the heat in heating the long distal air path, and without concentrating the heated air in some portions of the blanket module.

Various distal air paths and their paths may be arranged to terminate on edges of the blanket module or, in the alternative, to terminate close to the edges but away therefrom at a preset distance. Such configurations may be determined by various factors such as, e.g., desired temperature profile across the blanket module, selected mechanism of heat transfer (i.e., conduction or convection), and the like.

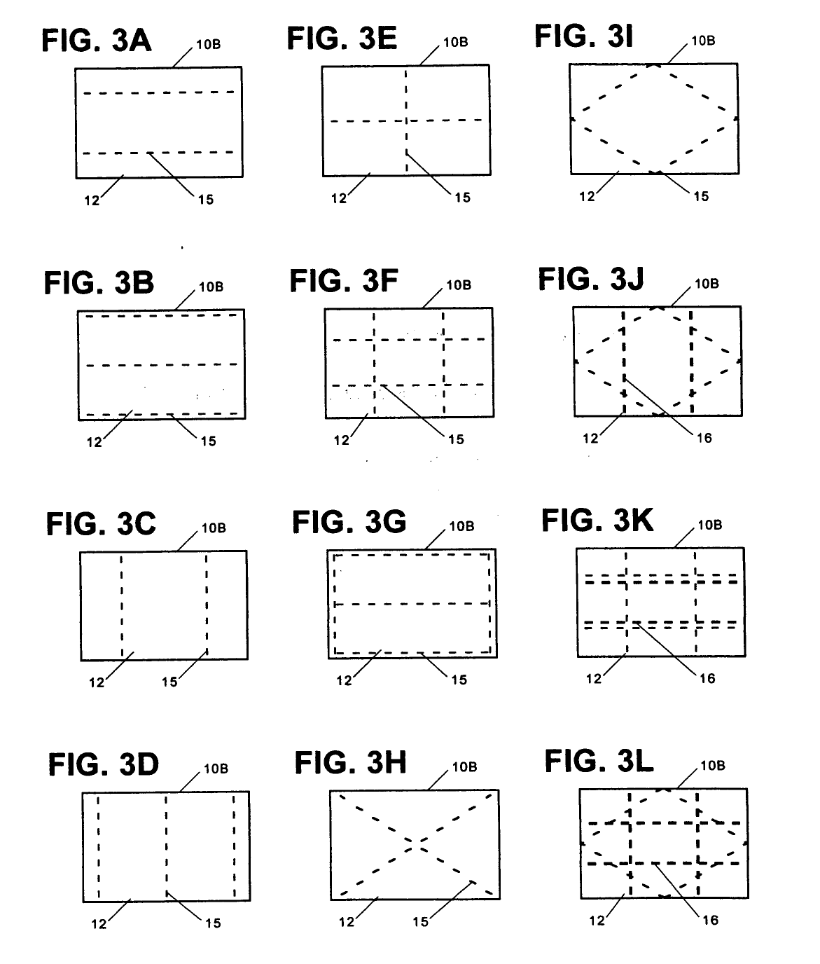

In another aspect of the present invention, blanket modules of the electric blanket systems may define multiple segments thereacross so as to supply heated air to various portions of such modules according to a preset pattern. FIGS. 3A to 3L describe schematic top (or bottom) views of exemplary blanket modules with multiple segments defined in various patterns according to the present invention. It is appreciated that such segmentation of the blanket module aims to define multiple segments of the above distal air paths across the blanket module and that each segment heats a portion of the target space formed thereunder according to the preset pattern, thereby achieving the desired temperature profile across an entire target space. In general, the blanket module is divided into multiple segment by one or more segment lines which may be formed on an exterior of such a module or, in the alternative, inside the module and therefore not visible from outside. Such segment lines may separate the distal air paths incorporated into different segments or, alternatively, the distal paths of different segments may be arranged to fluidly couple with each other through the segment lines. In these aspects, such segment lines may be physical borders between adjoining segments or may correspond to functional borders therebetween.

In one class of examples of FIGS. 3A and 3B, a blanket module 10B may be divided into multiple segments by multiple horizontal segment lines 15, thereby defining multiple horizontal segments each having different widths. In another class of examples of FIGS. 3C and 3D, a blanket module 10B may be divided into multiple segments by multiple vertical segment lines 15, thereby defining multiple vertical segments each defining different heights. In another class of examples of FIGS. 3E to 3G, a blanket module 10B may be divided into multiple segments by horizontal and vertical segment lines 15, thereby defining multiple rectangular segments each defining a width and/or a height which may be less than those of the blanket module 10B. In another class of examples of FIGS. 3H and 31, a blanket module 10B may be divided into multiple segments by multiple transverse segment lines 15, thereby defining multiple triangular segments.

A blanket module 10B may also be provided with one or multiple preformed folding lines along which such a module 10B may be folded for storage purposes. By forming such folding lines in the blanket module 10B, the distal air paths may be distributed across the blanket module 10B accordingly in such a way that such paths may be damaged when the blanket 10B is folded and stored for a long period of time. Such folding lines may be arranged to coincide with the segment lines such that, when folded, a majority of the distal air paths may not have to be folded. Alternatively, the folding lines may not coincide with the segment lines such that at least some of the distal air paths may be folded when the blanket module 10B is folded. In one example of FIG. 3J, a blanket module 10B may be divided into multiple segments similar to that of FIG. 31, while multiple folding lines 16 are preformed vertically along a height of such a module 10B. In another example of FIG. 3K, a blanket module 10B may be divided into multiple segments similar to that of FIG. 3F, while multiple horizontal folding lines 16 are preformed horizontally along a length of such a module 10B. In another example of FIG. 3L, a blanket module 10B may also be divided into multiple segments similar to that of FIG. 31, and multiple horizontal and vertical folding lines 16 are provided similar to the segment lines of FIG. 3F, thereby allowing the user to fold the blanket module 10B vertically and then horizontally or vice versa.

Configurational and/or operational variations and/or modifications of the above embodiments of the exemplary systems and various modules thereof described in FIGS. 3A through 3L also fall within the scope of this invention.

At least two of such segments of the blanket module may be fluidly coupled to each other so that the heated air may flow form one to the other of such segments. In the alternative, at least two of such segments may be provided independently and receive the heated air directly from the middle (or proximal) air path. Although not shown in the above figures, at least two segments may be arranged to vertically overlap at least portions thereof while optionally forming fluid coupling therebetween. In addition, the blanket module may define multiple layers in each of which different segments may also be defined in at least portions thereof. At least two of such layers may define the segments defining the same shapes and/or sizes and arranged in the same pattern. Alternatively, at least two of such layers may define the segments with different shapes and/or sizes and arranged in different patterns. When desirable, one of such layers may preferentially used for conduction, while the other of such layers may be used for convection. When desirable, at least one segment of one of such layers may be fluidly or only mechanically coupled to at least one segment of another of such layers.

At least two of such segments of the blanket module may be arranged to define their own inlet ends and/or outlet ends or, in the alternative, at least two of such segments may be arranged to share at least one inlet end and/or outlet end. The inlet and/or outlet ends may be defined along edges of the segment or in interior portions thereof. At least one of such segments may also include multiple distal air path defining different shapes, sizes, and/or arrangements and may transfer the heat only through convection or conduction or, alternatively, by both convection and conduction as well. At least one of the segments may include multiple distal air paths which may be disposed side by side or one over the other. When desirable, such distal air paths may be fused onto each other while not forming any fluid coupling therebetween or thereby being fluidly coupled to each other.

As described hereinabove, the segment and/or folding lines may be formed along the surface of (and optionally into) the blanket module so that such lines may be visible by the user. Alternatively, such segment and/or folding lines may be formed inside the blanket module so that such lines may not be visible. Such folding lines may be formed between the segments and/or across such segments. In addition, such folding lines may allow the user to fold the blanket therealong upwardly, downwardly or both.

The blanket module may include at least one thermal insulator as described above. When such a blanket module defines multiple segments, identical or different thermal insulators may be disposed in some or all of such segments. Such thermal insulators may be incorporated into only those segments for conduction or convection. Similarly, the blanket module may include at least one thermal conductor in some or all of such segment or, alternatively, in only those segments for conduction or convection.

As described hereinabove, multiple segments may be fluidly coupled in series and the heated air may flow from one to the next of such segments. Alternatively, such segments may fluidly couple with each other in a parallel or hybrid pattern such that the heated may flow through such segments accordingly. When desirable, at least one control valve may be incorporated between such segments so that the flow rate of the heated air into such segments may be controlled manually or by the control member.

At least one of such segments may also be provided as a detachable unit so that the user may attach or detach the detachable segment to or from the rest of the segments of the blanket module. In addition, the detachable segment may optionally be arranged to fluidly couple with adjacent segments or with the middle (or proximal) air path and to receive the heated air therefrom. Accordingly, the user may be able to provide multiple segments and mechanically and/or fluidly couple such segments into a desirable shape and/or size, thereby customizing his or her own blanket module defining a network of the distal air paths having a desirable shape, size, and/or arrangement and heating the target space in such an arrangement.

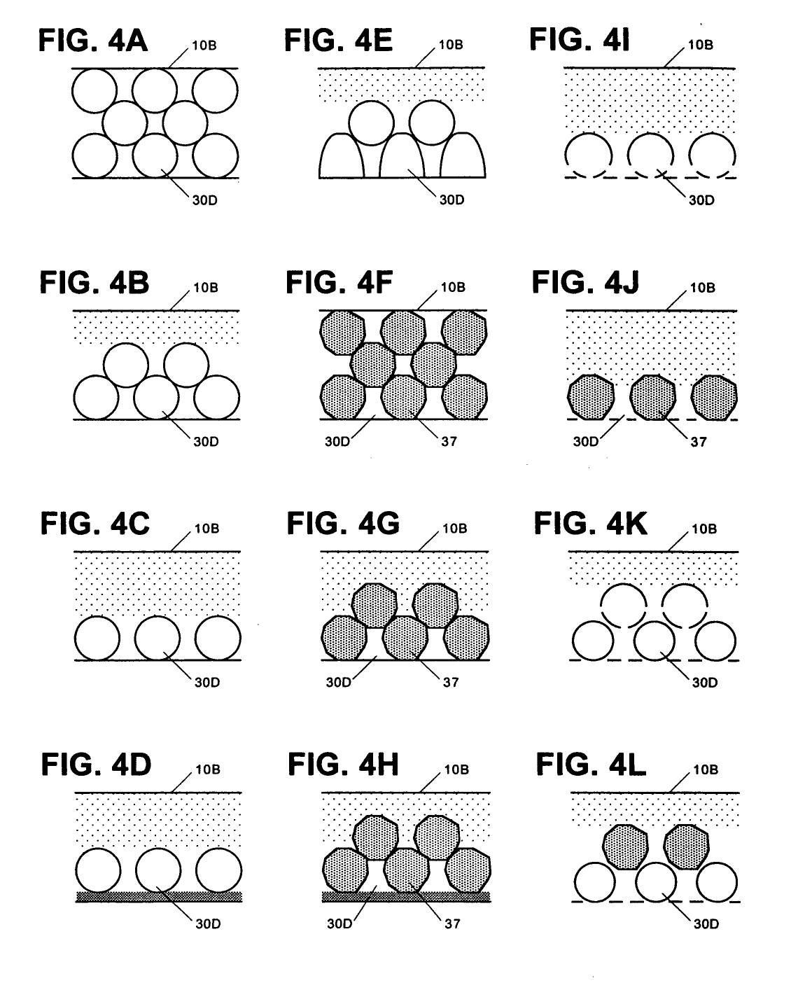

In another aspect of the present invention, various distal air paths may be formed in a blanket module in various arrangements. As described above, such distal air paths may be formed into one of the active and passive configurations, where at least portions of the top and/or bottom surfaces may be arranged to form at least portions of the wall of such distal air paths. FIGS. 4A to 4L are schematic cross-sectional views of exemplary blanket modules including active and passive air paths disposed in various patterns according to the present invention.

In one exemplary embodiment of such an aspect of the present invention, distal air paths may have the aforementioned active configuration and may be provided to transfer heat of heated air to a target space by conduction. As described above, such distal air paths may not define any air outlets or openings therealong.

In one example of FIG. 4A, a blanket module 10B includes multiple rows and columns of distal air paths 30D which extend from a top to a bottom of such a module 10B. In particular, such distal air paths 30D are disposed one over the other in a staggering pattern while defining gaps therebetween, where detailed shapes and/or sizes of such gaps may generally depend upon shapes and/or sizes of cross-sections of the distal air paths 30D. Both of a top surface and a bottom surface of the blanket module 30D may not define any visible openings.

In operation, multiple distal air paths 30D are arranged in the blanket module 10B or between its top and bottom in a preset pattern and are fluidly coupled to the middle or proximal air path (both not shown in the figure). The actuator member takes in air and supplies such air to the heating element in which the air is heated only up to a preset temperature. The heated air is further transported distally by the pressure gradient developed along the conduit member by the actuator member. As the heated air reaches and flows though the distal air paths 30D, the heat of the air begins to be transferred onto surrounding medium and eventually to the target space. It is easily apprehended that this arrangement that at least a portion of the heat released by the heated air may conduct upward and be wasted.

In other examples of FIGS. 4B and 4C, a blanket module 10B similarly includes multiple distal air paths 30D which, however, extend from a middle to a bottom of such a module 10B. In particular, the top portion of the blanket module 10B includes the aforementioned thermal insulator such that a major portion of the heat released by the heated air is transferred downwardly, while conduction of such heat along the upward direction is suppressed by the thermal insulator. Other configurational and/or operational characteristics of the blanket modules of FIGS. 4B and 4C are generally similar or identical to those of the blanket module of FIG. 4A.

In another example of FIG. 4D, a blanket module 10B is similar to that of FIG. 4C but includes at least one conductive layer which is disposed between the distal air paths 30F and the bottom surface of the blanket module in order to facilitate distribution of the heat released by the heated air flowing in the distal air paths 30. Other configurational and/or operational characteristics of the blanket module of FIG. 4D are generally similar or identical to those of the blanket module of FIGS. 4A to 4C.

In another example of FIG. 4E, a blanket module 10B is similar to that of FIG. 4B but some of its distal air paths 30D are bordered by the bottom surface of the blanket module 10B. Although such air paths may require more processing during their manufacture, such air paths may be more efficient in transferring the heat of air to the target space therethrough. Other configurational and/or operational characteristics of the blanket module of FIG. 4E are generally similar or identical to those of the blanket module of FIGS. 4A to 4D.

In another exemplary embodiment of this aspect of the present invention, distal air paths may have the aforementioned passive configuration and may be provided to transfer heat of heated air to a target space through conduction. As described above, such distal air paths may not define any air outlets or openings therealong. In one example of FIG. 4F, a blanket module 10B may include a porous structure between its top and bottom, where such a structure includes a matrix 37 and multiple pores therein and where such pores define at least one interconnecting passive distal air path 30D through which the heated air may flow. In general, the blanket module 10B of this embodiment may be viewed as a passive counterpart of the module of FIG. 4A. In another example of FIG. 4G, a blanket module 10B similarly includes a porous structure defining the similar matrix 30 and distal air path 30D. Such a blanket module 10B, however, includes a top layer of the thermal insulator and may, accordingly, be viewed as a passive counterpart of the module of FIG. 4B. In another example of FIG. 4H, a blanket module 10B also includes a porous structure with the similar matrix 30 and distal air path 30D, where the blanket module 10B includes a bottom layer of the thermal conductor. Accordingly, such a blanket module 10B corresponds to the passive counterpart of the module of FIG. 4D. Other configurational and/or operational characteristics of the blanket module of FIGS. 4F through 4H are generally similar or identical to those of the blanket module of FIGS. 4A to 4E.

In another exemplary embodiment of this aspect of the present invention, distal air paths may have the aforementioned active or passive configuration and be provided to transfer heat of heated air into a target space by convection. Accordingly, such distal air paths may define any air outlets or openings therealong. In one example of FIG. 4I, a blanket module 10B is generally similar to that of FIG. 4C, except that the distal air paths 30D define multiple openings therealong and that the blanket module 10B includes a porous bottom surface. Accordingly, the heated air seeping out of the active distal air paths 30B may move out of the blanket module 10B into the target space through the porous bottom surface. In another example of FIG. 4J, a blanket module 10B is similar to that of FIG. 4G, except that the blanket module 10B includes porous bottom surface. Accordingly, the heated air flowing through the pores of the passive distal air paths 30D may move out of the blanket module 10B into the target space through the porous bottom surface. Other configurational and/or operational characteristics of the blanket module of FIGS. 4I and 4J are generally similar or identical to those of the blanket module of FIGS. 4A to 4H.

In another exemplary embodiment of this aspect of the present invention, distal air paths may have the aforementioned active or passive configuration and be provided to transfer heat of heated air to a target space by both the convection and conduction. Accordingly, some of the distal air paths may define any air outlets or openings therealong for convective heat transfer, while others of such distal air paths may not need such air outlets or openings therealong for conductive heat transfer. In one example of FIG. 4K, a blanket module 10B is generally similar to that of FIG. 4B, except that some distal air paths 30B (top row in this embodiment) define multiple openings. Accordingly, the heated air flowing through the distal air paths 30D of the top row may seep out of such paths 30D and flow into the target space through such pores formed between the distal air paths 30B and through the porous bottom surface of the blanket module 10B. In addition, the heated air flowing in the distal air paths of the bottom row transfers the heat of air through its wall which may then be transferred to the target space by conduction. In another example of FIG. 4L, a blanket module 10B is generally similar to that of FIG. 4K, except that the active distal air paths of the top row of FIG. 4K are replaced by the passive distal air paths. Accordingly, the heated air flowing through the pores of such passive distal air paths 30D of the top row may flow into the target space through such pores formed between the matrix 37 of the passive distal air paths and the active distal air paths 30B and then through the porous bottom surface of the blanket module 10B. In addition, the heated air flowing in the active distal air paths 30B of the bottom row may transfer the heat of air through its wall which may then be transferred to the target space by conduction. Other configurational and/or operational characteristics of the blanket module of FIGS. 4K and 4L are generally similar or identical to those of the blanket module of FIGS. 4A to 4J.

Unless otherwise specified, various features of one embodiment of one aspect of the present invention may apply interchangeably to other embodiments of the same aspect of this invention and/or embodiments of one or more of other aspects of the present invention. Therefore, any distal air paths exemplified in FIGS. 2A to 2X and variations thereof may be utilized either for conductive heat transfer or for convective heat transfer, and may also be included in any segments exemplified in FIGS. 3A to 3L and variations thereof. In addition, any distal air paths exemplified in FIGS. 4A to 4L may be used for any blanket modules of FIGS. 2A to 2X and variations thereof, and may further be incorporated into any segment exemplified in FIGS. 3A to 3L and variations thereof.

As described hereinabove, various systems, methods, and/or processes of this invention may be applied to various heating devices. For example, such air heating systems may be constructed into overblankets (or simply blankets) or underblankets (or mats) such that the heated air may be supplied to the target space by convection or conduction from up above or from down below. The air heating systems may also be formed as heating pads which may be utilized as the foregoing overblankets or underblankets but provided in smaller dimensions. Such air heating systems may be incorporated into various beds including conventional spring beds, foam beds, air beds, and water beds and supply the heated air so as to transfer heat by convection and/or conduction. The air heating systems may also be incorporated into sleeping bags, medical or clinical enclosing devices, and the like.

In addition, the air heating systems of the present invention may be modified and used for other applications as well. In one example, such air heating systems may be used to supply ambient air into the target space, thereby keeping the temperature inside the target space near the room temperature, while dispensing the body heat out of the target space. Any of the above air heating systems may be used to this end by simply not turning on the heating members thereof. Alternatively, a novel system may be constructed without any heating member and primarily used as a cooling system. In another example, the air heating systems may incorporate conventional cooling devices therein and be used to supply cooled air of a temperature lower than the room temperature, thereby keeping the temperature inside the target space substantially lower than the body temperature. In this embodiment, the system of this invention may be used either as an air heating system or an air cooling system. Alternatively, the heating member of the air heating system may be replaced by such a cooling device so that such a system may be mainly used as the air cooling system.

When desirable, the air heating system or the electric blanket system of this invention may also incorporate at least one conventional AC or DC heating element inside the blanket module so that such a heating element may generate heat and transfer such heat onto the target space by conduction or radiation. It is preferred, however, that such an AC heating element be turned on only during a preset period of time such as, e.g., the initial phase of the heating operation. The DC heating element may be turned and kept on for a longer period of time, although the system with the DC heating element may need any of the conventional rectifier circuit. Examples of such heating elements and rectifiers may easily be referred to in the aforementioned prior arts which are incorporated herein in their entireties by reference. When desirable, at least one material with high heat capacity may be incorporated into the blanket module in order to retain the heat released by the heated air and/or heating element for an extended period of time.

It is to be understood that, while various aspects and embodiments of the present invention have been described in conjunction with the detailed description thereof, the foregoing description is intended to illustrate and not to limit the scope of the invention, which is defined by the scope of the appended claims. Other embodiments, aspects, advantages, and modifications are within the scope of the following claims.

What is claimed is:

1. An electric blanket system capable of minimizing emission of electromagnetic waves toward a target space comprising:
at least one air path;
at least one blanket module which is configured to define said target space under one surface thereof and to include only at least a portion of said air path therealong;
at least one actuator member which is configured to take in air and to move said air along said air path by electrical energy while emitting said waves;
at least one coupling module which is configured to fluidly couple said actuator member to said portion of said air path and to define a preset length; and
at least one heating member which is configured to be operatively coupled to at least another portion of said air path disposed away from said blanket module, to generate heat by electrical energy while emitting said waves, and to transfer said heat to said air flowing in said another portion of said air path,
whereby at least substantial portions of said actuator and heating members are configured to be disposed away from said blanket module during use by a preset distance which is configured to not exceed said preset length of said coupling module, thereby decreasing intensities of said waves below a preset limit when measured in a preset distance from said surface in said target space.

2. The system of claim 1, wherein said portion of said air path is configured to be disposed over at least a portion of said target space and to transfer said heat onto said target space by conduction of said heat from said heated air to said target space through said portion of said air path.

3. The system of claim 1, wherein said portion of said air path is configured to be disposed over at least a portion of said target space, to define at least one air outlet therealong which is configured to fluidly couple with said target space, and to transfer said heat onto said target space by convection of said heat air into said target space through said air outlet of said portion of said air path.

4. The system of claim 1, wherein said coupling module is configured to dispose said heating and actuator members away from said blanket by a preset distance enough to reduce an intensity of said waves to a preset level.

5. The system of claim 4, wherein said waves includes electric waves and magnetic waves and wherein said distance is selected to reduce said intensity of said magnetic waves to at most about 2 mG when measured in said target space.

6. The system of claim 1, wherein said air contains at least one of moist and oxygen therein and wherein said actuator member is configured to take in said air with said at least one of said moist and oxygen, to move said air with said at least one of said moist and oxygen along said air path, and then to supply said heated air with said at least one of said moist and oxygen into said target space.

7. The system of claim 1 further comprising at least one evaporation member which is disposed along said air path and configured to be fluidly coupled to said air path, to include therein at least one agent, and to evaporate said agent into said air flowing through said path.

8. The system of claim 1, wherein said portion of said air path is configured to be deformable and to vary hydraulic resistance therethrough.

9. The system of claim 1, wherein said air path is configured to define an outer wall and an inner solid lumen and wherein said heated air is configured to flow through said lumen.

10. The system of claim 1, wherein said air path is configured to define a porous structure having a plurality of pores and wherein said heated air is configured to flow through said pores.

11. The system of claim 1, wherein said blanket module is configured to not include any portion of said heating member, thereby preventing said blanket module from catching fire due to overheating of said heating member.

12. The system of claim 1, wherein said heating member is configured to heat said air only up to a preset temperature which is lower than an ignition temperature of any portion of said system, thereby preventing said blanket module from reaching a temperature higher than said ignition temperature.

13. An electric blanket system for generating heated air and transferring heat of said heated air to a target space through conduction and convection by said heated air comprising:
at least one conduit member which is configured to include at least one proximal air path and a plurality of distal air paths fluidly coupling with said proximal air path one of directly and indirectly;
at least one blanket module which is configured to form said target space thereunder, to have at least one first of said distal air paths which is fluidly coupled to said target space, and to include at least one second of said distal air paths which is not fluidly coupled to said target space;
at least one actuator member which is configured to transport air from said proximal air path to at least one of said first and second of said distal air paths using electrical energy; and
at least one heating member which is configured to be operatively coupled to said proximal air path, to generate heat using electrical energy, and then to transfer said heat to said air flowing in said proximal air path,
whereby said system is configured to provide said heat to said target space by at least one of convection through said first of said distal air paths and conduction through said second of said distal air paths.

14. The system of claim 13, wherein at least a substantial portion of each of said actuator member and said heating member are configured to be disposed away from said blanket module by at least a preset distance, thereby minimizing intensities of electromagnetic waves irradiated by said actuator member and said heating member toward said target space.

15. The system of claim 13, wherein said blanket module has a surface defining said target space thereunder wherein said first and second of said distal air paths are configured to be disposed along different depths across said blanket module from said surface thereof.

16. The system of claim 15 further comprising at least one thermal insulator which is configured to be disposed over said surface and to minimize loss of said heat thereacross.

17. A method of heating a target space defined under at least a portion of a blanket module of an electric blanket system while minimizing propagation of electromagnetic waves emitted by said system toward said target space comprising the steps of:
taking in and heating air using electrical energy away from said blanket module while emitting said waves; and
supplying said heated air directly into said target space through said blanket module, thereby heating said target space by forced convection while minimizing said propagation of said waves to said target space.

18. The method of claim 17 further comprising the step of:
circulating said heated air around said blanket module and transferring heat by conduction onto said target space.

19. The method of claim 18 further comprising the step of:
controlling amounts of said air participating in said convection and conduction depending upon at least one of an user setting and an user command.

20. The method of claim 17 further comprising the steps of:
emitting electromagnetic waves during said taking and heating; and
performing said taking and said heating by a preset distance away from said blanket module, thereby minimizing intensities of said waves propagating toward said target space
